(19) United States
(12) Patent Application Publication
(10) Pub. No.: US 2024/0295998 A1
(43) Pub. Date: Sep. 5, 2024

(54) REFILLING IMAGE-FORMING APPARATUS WITH CONSUMABLE MATERIAL

(71) Applicant: CANON KABUSHIKI KAISHA, Tokyo (JP)

(72) Inventors: Masaki Tani, Kanagawa (JP); Marehiko Hirajima, Kanagawa (JP); Yusuke Sakamoto, Tokyo (JP); Kosuke Ogawa, Kanagawa (JP)

(21) Appl. No.: 18/664,833

(22) Filed: May 15, 2024

Related U.S. Application Data
(63) Continuation of application No. PCT/JP2022/037407, filed on Oct. 6, 2022.

(30) Foreign Application Priority Data
Nov. 26, 2021 (JP) 2021-192466
Dec. 10, 2021 (JP) 2021-201172
Dec. 20, 2021 (JP) 2021-206272

(51) Int. Cl. G06F 3/12; G03G 15/00; G03G 15/08; G06K 15/00

(52) U.S. Cl. CPC G06F 3/1239; G03G 15/0865; G03G 15/5079; G03G 15/556; G06F 3/121; G06F 3/1235; G06F 3/1238; G06F 3/1288; G06K 15/4075

(57) ABSTRACT

An information processing apparatus manages a remaining number of sheets on which image forming is permitted, in an image-forming apparatus that forms images on sheets by using a consumable material, obtains first determination information for determining whether a holding device holding the consumable material is a first holding device or a second holding device, and determines, in a case where refilling the image-forming apparatus with the consumable material from the holding device is performed, whether the holding device used for the refilling is the first holding device, based on the first determination information of the holding device, and determines a refill amount of the consumable material with which the image-forming apparatus has been refilled.

### CROSS-REFERENCE TO RELATED APPLICATIONS

This application is a Continuation of International Patent Application No. PCT/JP2022/037407, filed Oct. 6, 2022, which claims the benefit of Japanese Patent Application No. 2021-201172, filed Dec. 10, 2021, Japanese Patent Application No. 2021-192466, filed Nov. 26, 2021, and Japanese Patent Application No. 2021-206272, filed Dec. 20, 2021, all of which are hereby incorporated by reference herein in their entirety.

### BACKGROUND OF THE INVENTION

### Field of the Invention

The present disclosure relates to an information processing apparatus, a program, a printing management system, a printing control method, an image-forming apparatus, a server apparatus, and a refilling management system for refilling the image-forming apparatus with a consumable material.

### Background Art

An image-forming apparatus such as a photocopier, a printer, or a facsimile receiver forms an image on a sheet by consuming a consumable material such as toner, ink, or the like. When the consumable material is depleted, the user replaces the used cartridge that held the consumable material with a new cartridge, or refills a tank of the image-forming apparatus with the consumable material from a holding device that holds the consumable material. Compared with the removable cartridge-type systems broadly used at present, a refilling system, in which a holding device such as a refill pack is connected to the image-forming apparatus and the apparatus is refilled with the consumable material (e.g., through injection) only during refills, has the advantages of low cost and low environmental impact. For example, PTL 1 proposes a system for connecting a cylindrical holding device that holds toner to a printer and refilling the printer with toner from the holding device.

In recent years, subscription services have begun to spread in the field of image-forming apparatuses. A “subscription service” is a service in which a user pays a predetermined fee to a service provider (referred to as a “business” hereinafter), whereupon an image-forming apparatus under contract can print up to a specified number of sheets, such as that described in PTL 2, for example. The image-forming apparatus under contract is installed in a user environment such as the user's office or the like. In the subscription service, the business monitors the amount of the consumable material remaining in the image-forming apparatus under contract, and delivers a cartridge or a refill pack to the user environment so that the consumable material is not depleted, according to a subscription contract, for example. In the subscription service, the business also manages the remaining number of sheets that can be printed by the image-forming apparatus under contract.

### CITATION LIST

### Patent Literature

PTL 1: International Publication No. 2020/046338
PTL 2: Japanese Patent Laid-Open No. 2018-156224

When an image-forming apparatus under contract uses a refill system, the user basically refills the image-forming apparatus with the consumable material using a refill pack delivered by the business according to the subscription contract (“in-contract refill pack” hereinafter. However, there are cases where a user purchases or obtains a refill pack regardless of the subscription contract (“out-of-contract refill pack”, hereinafter). In such a case, the user may want to use the out-of-contract refill pack to refill the image-forming apparatus with the consumable material. A case where the user urgently wishes to print a greater number of sheets than the number of sheets that can be printed under the contract can be given as an example of such a case. A case where the delivery of refill packs is delayed due to a natural disaster such as a typhoon can be given as another example of such a case.

If the user uses an out-of-contract refill pack to refill the image-forming apparatus under contract with the consumable material and then prints images, the remaining number of sheets in the subscription contract can no longer be managed correctly. This can be prevented by prohibiting the use of out-of-contract refill packs to refill the image-forming apparatus under contract with the consumable material, but doing so is inconvenient for the user.

The present disclosure provides a technique which makes it possible to use a holding device which is different from a holding device supplied under a subscription contract.

### SUMMARY OF THE INVENTION

According to one aspect of the present disclosure, an information processing apparatus includes: a memory; and at least one processor connected to the memory and configured to: manage a remaining number of sheets on which image forming is permitted, in an image-forming apparatus that forms images on sheets by using a consumable material; obtain first determination information for determining whether a holding device holding the consumable material is a first holding device or a second holding device; and determine, in a case where refilling the image-forming apparatus with the consumable material from the holding device is performed, whether the holding device used for the refilling is the first holding device, based on the first determination information of the holding device, and determine a refill amount of the consumable material with which the image-forming apparatus has been refilled, wherein in a case where the at least one processor determines that the holding device used for the refilling is the first holding device, the at least one processor does not change the remaining number of sheets, and in a case where the at least one processor determines that the holding device used for the refilling is the second holding device, the at least one processor increases the remaining number of sheets by a number corresponding to the refill amount.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a schematic perspective view illustrating an example of the external appearance of an image-forming apparatus according to one embodiment.

FIG. 1B is a schematic perspective view illustrating an example of the external appearance of an image-forming apparatus according to one embodiment.

FIG. 2 is a schematic cross-sectional view illustrating an example of the physical configuration of the interior of an image-forming apparatus according to one embodiment.

FIG. 3 is a schematic perspective view illustrating an example of the configuration of a consumable material refill path according to one embodiment.

FIG. 4 is a schematic cross-sectional view illustrating an example of the configuration of a preserving container and the periphery thereof according to one embodiment.

FIG. 5A is a schematic perspective view illustrating an example of the overall configuration of a refill pack according to one embodiment.

FIG. 5B is a schematic perspective view illustrating an example of the overall configuration of a refill pack according to one embodiment.

FIG. 6A is an explanatory diagram illustrating the opening and closing of a discharge tray according to one embodiment.

FIG. 6B is an explanatory diagram illustrating the opening and closing of a discharge tray according to one embodiment.

FIG. 7 is an explanatory diagram illustrating a state in which a refill pack is connected to a toner receiving unit.

FIG. 8A is an explanatory diagram illustrating an example of a locking mechanism for locking the action of an opening and closing mechanism.

FIG. 8B is an explanatory diagram illustrating an example of a locking mechanism for locking the action of an opening and closing mechanism.

FIG. 9 is a schematic diagram illustrating an example of the configuration of a printing management system management according to one embodiment.

FIG. 10 is a block diagram illustrating an example of the configuration of a management server according to one embodiment.

FIG. 11 is a block diagram illustrating an example of the configuration of a user terminal according to one embodiment.

FIG. 12 is a block diagram illustrating an example of the functional configuration of an image-forming apparatus according to one embodiment.

FIG. 13 is a sequence chart illustrating toner refilling processing according to one embodiment.

FIG. 14A is a diagram illustrating an example of an apparatus registration table.

FIG. 14B is a diagram illustrating an example of an apparatus registration table.

FIG. 15 is a sequence chart illustrating printing processing according to one embodiment.

FIG. 16A is a diagram illustrating an example of an apparatus registration table.

FIG. 16B is a diagram illustrating an example of an apparatus registration table.

FIG. 16C is a diagram illustrating an example of an apparatus registration table.

FIG. 17 is a flowchart illustrating printing processing according to one embodiment.

FIG. 18 is a block diagram illustrating an example of the configuration of a management server according to one embodiment.

FIG. 19A is a diagram illustrating an example of a sent pack table.

FIG. 19B is a diagram illustrating an example of a sent pack table.

FIG. 19C is a diagram illustrating an example of a sent pack table.

FIG. 20A is a diagram illustrating an example of a used pack management table.

FIG. 20B is a diagram illustrating an example of a used pack management table.

FIG. 20C is a diagram illustrating an example of a used pack management table.

FIG. 20D is a diagram illustrating an example of a used pack management table.

FIG. 21A is a diagram illustrating an example of a used pack management table.

FIG. 21B is a diagram illustrating an example of a used pack management table.

FIG. 21C is a diagram illustrating an example of a used pack management table.

FIG. 22A is a diagram illustrating an example of an apparatus registration table.

FIG. 22B is a diagram illustrating an example of an apparatus registration table.

FIG. 22C is a diagram illustrating an example of an apparatus registration table.

FIG. 23 is a flowchart illustrating printing processing according to one embodiment.

FIG. 24 is a sequence chart illustrating printing processing according to one embodiment.

FIG. 25 is a sequence chart illustrating printing processing according to one embodiment.

FIG. 26 is an explanatory diagram illustrating an example of updating a database when registering an apparatus.

FIG. 27 is an explanatory diagram illustrating an example of updating a database when delivering a pack.

FIG. 28 is a sequence chart illustrating an example of the overall flow of processing related to apparatus registration.

FIG. 29 is a sequence chart illustrating some examples of the overall flow of processing related to providing a refill pack to a user.

FIG. 30 is a sequence chart illustrating an example of the overall flow of processing according to a first example when refilling a consumable material.

FIG. 31A is a flowchart illustrating an example of the flow of authentication processing executed by a management server.

FIG. 31B is a flowchart illustrating an example of the flow of authentication processing executed by a management server.

FIG. 32 is a flowchart illustrating an example of the flow of lock control processing executed by an image-forming apparatus.

FIG. 33 is a sequence chart illustrating an example of the overall flow of processing according to a second example when refilling a consumable material.

FIG. 34 is a schematic diagram illustrating an example of the configuration of a printing management system according to a sixth embodiment.

FIG. 35 is a schematic diagram illustrating a connection between a refill pack and an image-forming apparatus according to the sixth embodiment.

FIG. 36 is a block diagram illustrating an example of the configuration of the image-forming apparatus according to the sixth embodiment.

FIG. 37 is a sequence chart illustrating an example of the overall flow of processing when refilling a consumable material in the sixth embodiment.

FIG. 38 is a diagram illustrating an example of a GUI that communicates a delivery history.

FIG. 39 is a diagram illustrating an example of an email communicating an authentication result.

FIG. 40 is a diagram illustrating an example of a table held in a management database.

FIG. 41 is a sequence chart illustrating an example of refill processing according to a first embodiment.

FIG. 42 is a diagram illustrating a contract type switching screen.

FIG. 43 is a sequence chart illustrating an example of refill processing according to an eighth embodiment.

FIG. 44 is a flowchart illustrating an example of authentication processing executed by a management server.

FIG. 45 is a flowchart illustrating an example of contract type switching processing executed by a management server.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

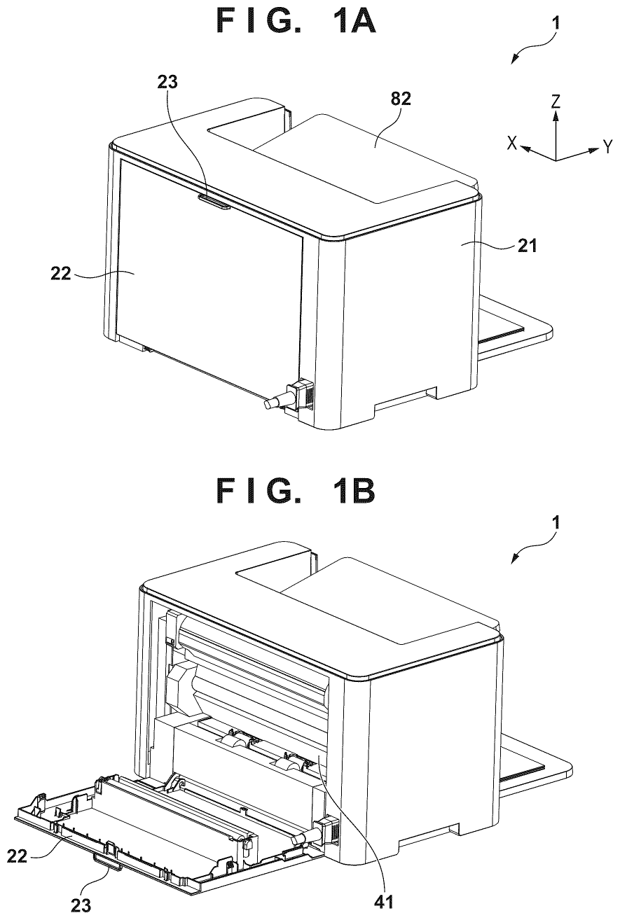

The basic configuration of a refill-type image-forming apparatus common to each of embodiments will be described hereinafter with reference to FIGS. 1A to 8B. The following will describe the configuration of an image-forming apparatus 1 that is a black-and-white laser printer. However, the technique according to the present disclosure can be applied in other types of printers, such as color laser printers and ink jet printers, for example. In general, the technique according to the present disclosure can be broadly applied in typical image-forming apparatuses such as photocopiers, printers, facsimile receivers, and multifunction peripherals.

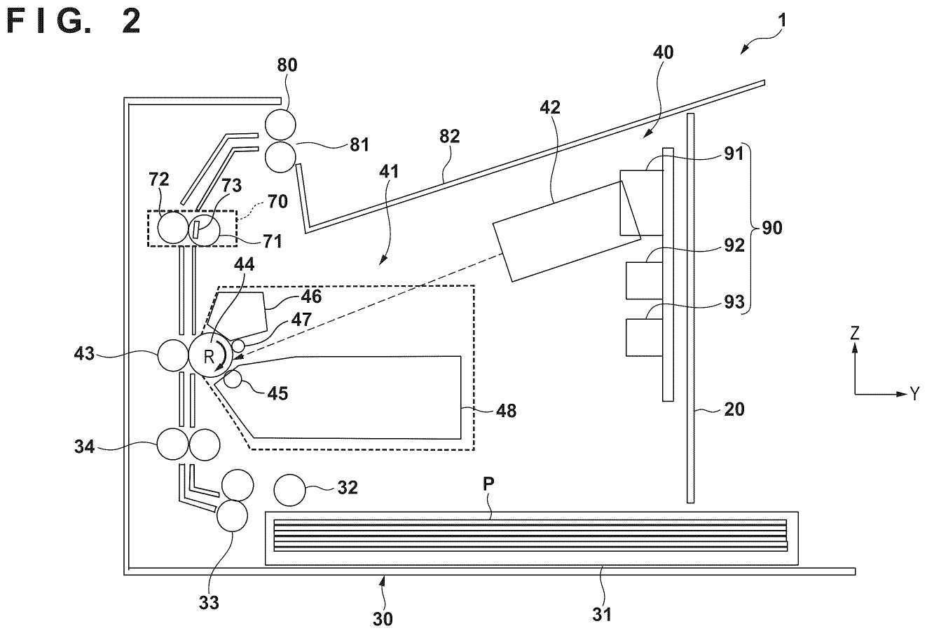

FIGS. 1A and 1B are schematic perspective views illustrating an example of the external appearance of the image-forming apparatus 1 according to one embodiment. FIG. 2 is a schematic cross-sectional view illustrating an example of the physical configuration of the interior of the image-forming apparatus 1. The image-forming apparatus 1 is a black-and-white laser printer that forms an image on a sheet based on input image data. Here, the sheet can include a variety of recording media of different materials, such as paper, plastic film, envelopes, and cloth.

In the following descriptions, a height direction of the image-forming apparatus 1 when the image-forming apparatus 1 is installed on a horizontal surface is defined as a Z direction. A direction that is orthogonal to the Z direction and parallel to a rotational axis direction of a photosensitive drum 44 (a main scanning direction), which will be described later, is defined as an X direction. A direction orthogonal to the X direction and the Z direction is defined as a Y direction.

Referring to FIGS. 1A and 1i, a housing of the image-forming apparatus 1 includes a front cover 20 (see FIG. 2), an exterior cover 21, a rear cover 22, and a discharge tray 82. A handle 23 is provided in the rear cover 22. The front cover 20 is disposed so as to be capable of being opened and closed on one side of the image-forming apparatus 1, and protects a processing circuit 90 (described later). The rear cover 22 is disposed on a surface of the image-forming apparatus 1 facing the opposite direction so as to be capable of being opened and closed. By grasping the handle 23 of the rear cover 22 and opening the rear cover 22, a user can expose a part of a conveyance path through which sheets are conveyed and a process unit 41, and perform maintenance work such as clearing jams or replacing the process unit 41, for example. FIG. 1A illustrates a state in which the rear cover 22 is closed, and FIG. 1B illustrates a state in which the rear cover 22 is opened.

Referring to FIG. 2, the image-forming apparatus 1 includes a feed unit 30, an image-forming unit 40, a fixing unit 70, a discharge roller pair 80, and the processing circuit 90. The feed unit 30 feeds a recording medium P toward the image-forming unit 40. The image-forming unit 40 forms an image (a toner image) on the sheet by consuming toner, which is a consumable material. The fixing unit 70 fixes the image formed by the image-forming unit 40 onto the recording medium P. The discharge roller pair 80 discharges the recording medium P processed by the fixing unit 70 to the discharge tray 82.

The image-forming unit 40 includes the process unit 41, a scanner unit 42, and a transfer roller 43. The process unit 41 includes the photosensitive drum 44, a developing roller 45, a cleaning unit 46, a charging roller 47, and a preserving container 48. The process unit 41 may be fixed to the main body of the image-forming apparatus 1, or may be removable from the main body.

The photosensitive drum 44 is an image carrier having a photosensitive layer formed from an organic photosensitive material on a drum-shaped substrate. The photosensitive drum 44 is rotationally driven in a direction R in the drawings by a motor. A charging voltage is applied to the charging roller 47 by a high-voltage power supply, and the charging roller 47 is pressed against the photosensitive drum 44 to uniformly charge the surface of the photosensitive drum 44. In accordance with the input image data, the scanner unit 42 irradiates the photosensitive drum 44 with a laser beam to expose the surface of the photosensitive drum 44. An electrostatic latent image corresponding to the input image is formed on the surface of the photosensitive drum 44 as a result of this exposure. Note that the scanner unit 42 may irradiate the photosensitive drum 44 with light from an LED array rather than a laser beam. “LED” is an acronym for “Light-Emitting Diode”.

The developing roller 45 is rotatably supported by the preserving container 48. The preserving container 48 preserves toner. Although not illustrated in FIG. 2, the preserving container 48 may further include a supply roller that applies toner preserved in the preserving container 48 to the surface of the developing roller 45. A developing voltage is applied to the developing roller 45 by the high-voltage power supply. When the toner carried on the developing roller 45 contacts the photosensitive drum 44, the toner transfers from the developing roller 45 to the drum surface according to the potential distribution on the surface of the photosensitive drum 44. The toner image is developed from the electrostatic latent image as a result.

The feed unit 30 includes a cassette 31, a pickup roller 32, a separation roller pair 33, and a conveyance roller pair 34. The cassette 31 is loaded with a bundle of recording media P. The cassette 31 can be removed from the housing of the image-forming apparatus 1. The pickup roller 32 picks up the recording medium P in the cassette 31 and feeds the recording medium P toward the separation roller pair 33. The separation roller pair 33 separates one sheet of the recording medium P and conveys the sheet toward the conveyance roller pair 34. The conveyance roller pair 34 conveys the recording medium P toward a transfer nip between the transfer roller 43 and the photosensitive drum 44. The transfer roller 43 applies a transfer voltage from the high-voltage power supply, and transfers the toner image developed on the surface of the photosensitive drum 44 to the recording medium P conveyed to the transfer nip.

The recording medium P onto which the toner image has been transferred is conveyed along the conveyance path, and reaches the fixing unit 70. The fixing unit 70 includes a heating roller 71, a pressurizing roller 72, and a fixing heater 73. The heating roller 71 and the pressurizing roller 72 heat and pressurize the recording medium P as the recording medium P passes through the nip between the rollers. As a result, the toner particles melt and then harden again, which fixes the toner image to the recording medium P. The recording medium P that has passed through the fixing unit 70 is discharged from a discharge port 81 to the discharge tray 82 by the discharge roller pair 80. The cleaning unit 46 is disposed in the vicinity of the photosensitive drum 44. The cleaning unit 46 cleans the photosensitive drum 44 by scraping off toner remaining on the surface of the photosensitive drum 44.

The processing circuit 90 includes electronic components 91, 92, and 93 disposed on a board. For example, the electronic component 91 may be a processor, the electronic component 92 may be a non-volatile memory, and the electronic component 93 may be an input/output device. The input/output device may include a communication interface. When a job instructing an image to be formed is input to the image-forming apparatus 1, an image-forming process based on input image data received from an external computer, for example, is started. In the image-forming process, as described above, the scanner unit 42 forms an electrostatic latent image on the photosensitive drum 44 according to the input image data, the developing roller 45 develops a toner image from the electrostatic latent image, and the toner image is transferred to the recording medium P by the transfer roller 43. The processing circuit 90 operates as a controller for controlling this image-forming process.

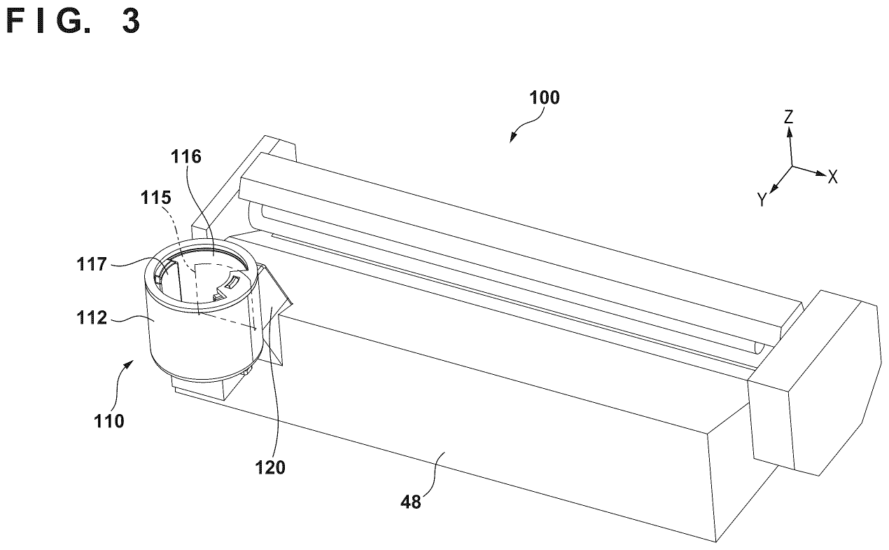

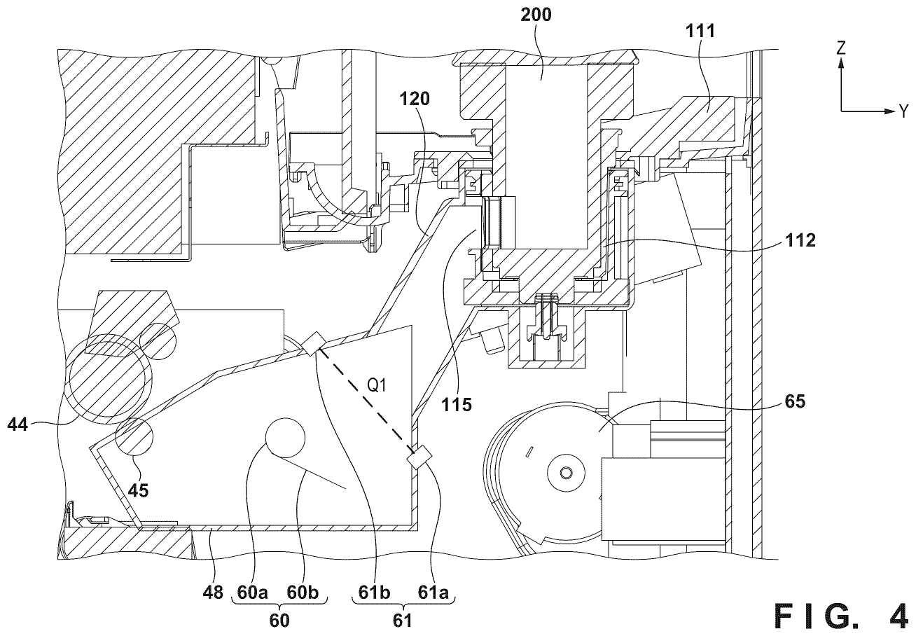

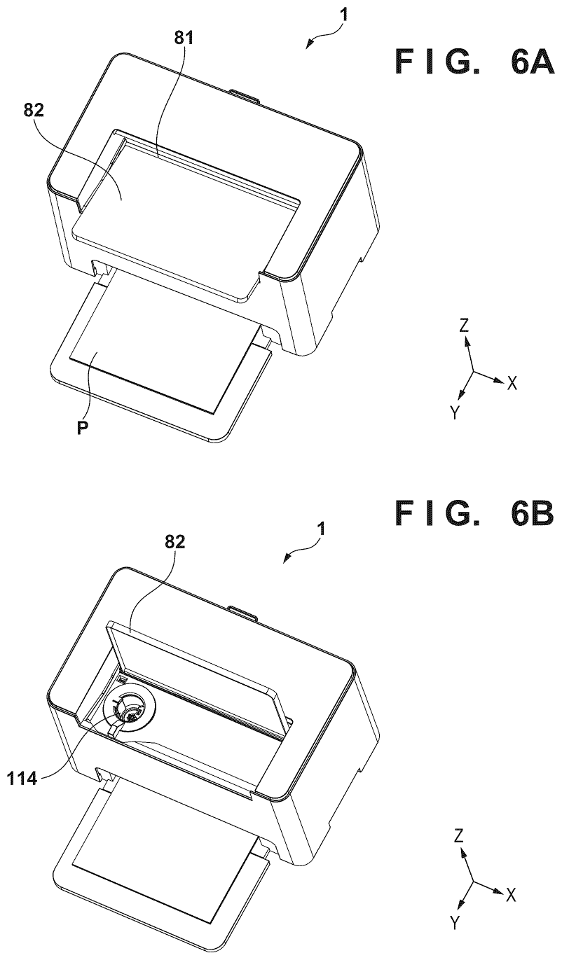

A more detailed example of the configuration related to the preserving container 48 will be described next with reference to FIGS. 3 and 4. FIG. 3 is a schematic perspective view illustrating an example of the configuration of a consumable material refill path of the image-forming apparatus 1. FIG. 4 is a schematic cross-sectional view illustrating an example of the configuration of the preserving container 48 and the periphery thereof. Referring to FIG. 3, the preserving container 48 constitutes a part of a toner refill unit 100. The toner refill unit 100 includes the preserving container 48 and a toner receiving unit 110. A toner receiving unit 110 includes a cylindrical member 112, a main body shutter 116, and a connecting member 120. Although the toner receiving unit 110 further includes a ring member 111, which will be described in detail with reference to FIGS. 6A to 8B, the ring member 111 is not illustrated in FIG. 3 so as to show other constituent elements. An inner space of the cylindrical member 112 communicates with the preserving container 48 via a side opening 115 and the connecting member 120, which is hollow. The main body shutter 116 serves as an opening and closing mechanism capable of opening and closing the refill path of the consumable material (toner, here) from a refill pack 200 (described later) to the preserving container 48. A protruding part 117 is formed on an inner-side surface of the main body shutter 116.

FIG. 4 illustrates a state in which the refill pack 200 is connected to the toner receiving unit 110, along with a cross-section of the configuration of the preserving container 48 and the periphery thereof. The refill pack 200 is an example of a holding device that holds a consumable material consumed for image formation. When the main body shutter 116 is opened, a refill path extending from the refill pack 200 to the preserving container 48 through the connecting member 120 is opened. With the refill path open, the preserving container 48 is refilled with toner released from the refill pack 200 through the refill path.

As illustrated in FIG. 4, an agitation member 60, which includes a shaft 60a disposed parallel to the X direction and a blade 60b that rotates about the shaft 60a, is provided in the interior of the preserving container 48. The blade 60b is driven by a motor 65 so as to revolve. Due to the revolving of the blade 60b, the toner within the preserving container 48 is agitated and reaches the developing roller 45. Note that the agitation member 60 may include a screw-shaped member instead of the blade 60b. The agitation member 60 may be responsible for homogenizing the toner within the preserving container 48 by scraping the toner from the developing roller 45 and causing the toner within the preserving container 48 to circulate.

A remaining amount detection unit 61 is further disposed in the preserving container 48. The remaining amount detection unit 61 is a sensor for detecting the remaining amount of toner in the preserving container 48. The remaining amount detection unit 61 includes a light emitter 61a and a light receiver 61b. The light emitter 61a emits light that proceeds along an optical axis Q1 within the preserving container 48. The light receiver 61b is disposed at a position opposite the light emitter 61a, and receives the light emitted from the light emitter 61a. Note that when the light is guided by a light guide tube, for example, the light receiver 61b does not necessarily have to be disposed at a position opposite the light emitter 61a. The light emitter 61a may be, for example, a light-emitting element such as an LED, or may be a halogen lamp, a fluorescent lamp, or the like. The light receiver 61b may be a phototransistor, a photodiode, or an avalanche photodiode, for example.

The light receiver 61b outputs a light detection signal having a signal level that depends on the amount of light received. The light detection signal is input to the processing circuit 90 after being converted from analog to digital, for example. The processing circuit 90 may estimate the remaining amount of toner based on, for example, the ratio of time that the light from the light emitter 61a is blocked (by the toner) to a constant time window while the toner is being agitated. Note that the remaining amount detection unit 61 is not limited to the configuration example described above, and the remaining amount of toner may be detected or estimated using any method. For example, the remaining amount of toner may be estimated by detecting the electrostatic capacitance of the preserving container 48. Alternatively, the remaining amount of toner may be estimated from a history of the amount of toner used up to that point. The processing circuit 90 can derive the amount of toner used based on statistical values pertaining to the image-forming operations, such as the number of sheets consumed by the printing or the pixel count.

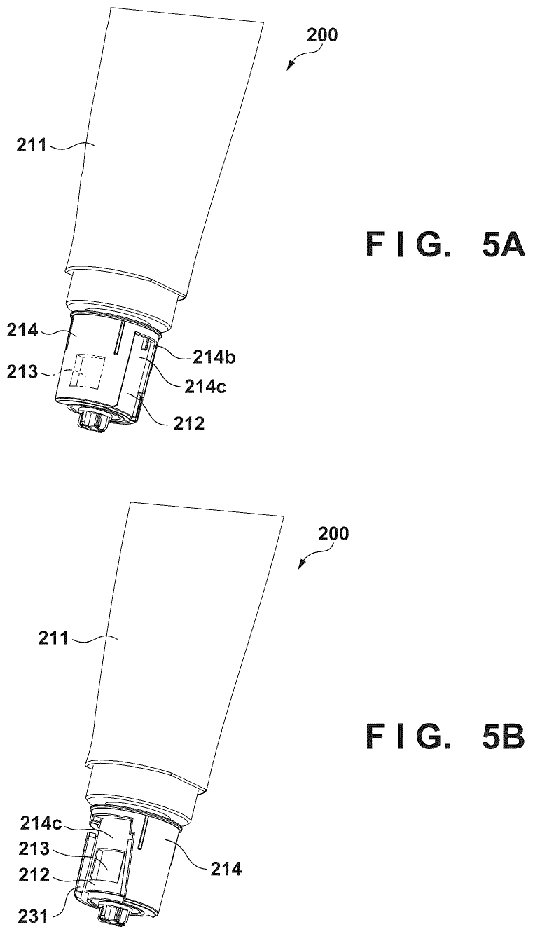

FIGS. 5A and 5B illustrate an example of the overall configuration of the refill pack 200. In this configuration example, the refill pack 200 includes a holding part 211, a nozzle 212, and a pack shutter 214. The holding part 211 can be configured as, for example, a hollow tube or pouch for holding toner, which is a consumable material. The holding part 211 is filled with toner in advance. The holding part 211 may be a plastic bag that can easily deform, for example. However, the holding part 211 is not limited to this example, and may be formed from any material, such as resin, paper, or vinyl, and may have any shape, such as a bottle, cylinder, or box.

The nozzle 212 is an interface part with the toner receiving unit 110 of the image-forming apparatus 1. The inside of the nozzle 212 communicates with the inside of the holding part 211. An opening 213 for releasing the toner to the exterior is formed in a side surface of the nozzle 212. The opening 213 is normally blocked by the pack shutter 214.

The pack shutter 214 is a cylindrical member concentric with the nozzle 212, and is disposed on an outer side of the nozzle 212 in a radial direction. The pack shutter 214 has an opening 214c. A part of an edge that forms the opening 214c constitutes a drive transmission surface 214b. When refilling toner, the pack shutter 214 rotates relative to the nozzle 212 such that the opening 213 in the nozzle 212 overlaps the opening 214c in the pack shutter 214, which makes it possible to open a path for releasing the toner which had been blocked by the pack shutter 214. As will be described later, the drive transmission surface 214b is a surface that receives a force which rotates the pack shutter 214. FIG. 5A illustrates a state in which the toner release path is blocked, and FIG. 5B illustrates a state in which the toner release path is open. A sealing member 231, which normally blocks the opening 213 in the nozzle 212, can further be provided on the inner circumferential surface of the pack shutter 214. The sealing member 231 prevents toner from leaking from the refill pack 200 when toner is not being refilled.

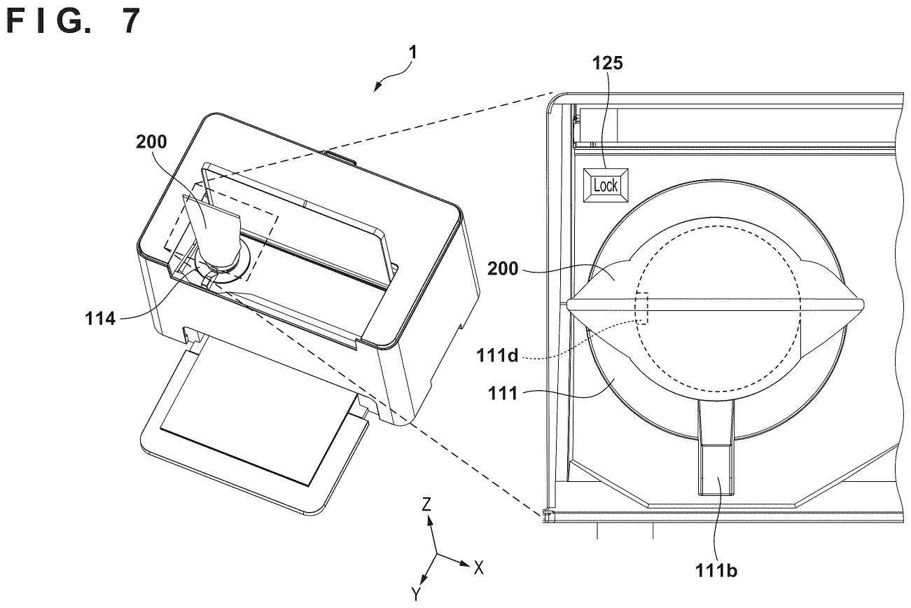

Next, the connection of the refill pack 200 to the toner receiving unit 110 will be described with reference to FIGS. 6A to 7. As illustrated in FIGS. 6A and 6B, the discharge tray 82 is configured to be capable of being opened and closed about an opening and closing shaft provided in the housing along the X direction. In the example illustrated in FIG. 6A, the discharge tray 82 is in a closed state, and the recording medium P discharged from the discharge port 81 is discharged onto the discharge tray 82 in this state. In the example illustrated in FIG. 6B, the discharge tray 82 is in an open state, and a refill port 114 of the toner receiving unit 110 is exposed in this state. In other words, in this configuration example, the discharge tray 82 also functions as a blocking member that blocks the refill port 114. The user can connect the refill pack 200 to the toner receiving unit 110 by lifting and opening the discharge tray 82 as illustrated in FIG. 6B, and inserting the nozzle 212 of the refill pack 200 into the exposed refill port 114, as illustrated on the left side in FIG. 7.

The right side in FIG. 7 illustrates an enlarged view of a state in which the refill pack 200 is connected to the toner receiving unit 110. The ring member 111 surrounding the periphery of the refill port 114 is rotatably supported on the top surface of the cylindrical member 112. The ring member 111 has a lever 111b that is gripped by the user, and a protruding part 111d indicated by a dotted line in the figure. The protruding part 111d engages with the drive transmission surface 214b of the pack shutter 214 in the refill pack 200 inserted into the toner receiving unit 110. The drive transmission surface 214b also engages with the protruding part 117 of the main body shutter 116 (see FIG. 3). When the user manipulates the lever 111b to rotate the ring member 111 around a center axis, force produced in the rotational direction is transmitted from the protruding part 111d to the drive transmission surface 214b of the pack shutter 214, and further from the drive transmission surface 214b to the protruding part 117 of the main body shutter 116. As a result, the main body shutter 116 and the pack shutter 214 of the refill pack 200 can rotate in tandem with the ring member 111, and for example, the toner refill path can be opened after 90 degrees of rotation. When the refill path is opened, the toner held in the holding part 211 of the refill pack 200 is injected into the toner receiving unit 110 from the opening 213 in the nozzle 212, and the preserving container 48 is refilled with the toner through the connecting member 120. Note that the rotation of the ring member 111 can be restricted by a restricting member (not shown) so as not to exceed a predetermined upper limit angle.

Although the above describes an example in which the toner refill path is opened by the force in the direction of rotation produced when the user manipulates the lever 111b, the refill path may be closed and opened by relying on user operations. As an example, the image-forming apparatus 1 may include a pack sensor that detects the refill pack 200 being connected to the toner receiving unit 110, and a drive motor that generates driving force for rotating the ring member 111. In this example, the processing circuit 90 may activate the drive motor and rotate the ring member 111 with the rotational force of the drive motor to open the refill path under the condition that the refill pack 200 being connected to the toner receiving unit 110 has been detected by the pack sensor.

The opening and closing mechanism for opening and closing the refill path is not limited to the mechanism that uses the rotation of the shutter as described above. Instead of a rotating shutter, a shutter that is movable in a linear direction may be employed, or a mechanism different from a shutter, such as a valve, may be employed, for example. It is sufficient for the opening and closing mechanism to be provided in at least one of the holding device, such as the refill pack 200, and the image-forming apparatus. In other words, the refill path from the holding device to the image-forming apparatus may always be open in one of the holding device and the image-forming apparatus, and may be opened and closed only in the other. Alternatively, the refill path may be opened and closed by both the holding device and the image-forming apparatus, as in the example described above. In addition, a sensor for detecting the operation of the opening and closing mechanism by the user or detecting the state of the opening and closing mechanism (the open state or the closed state) may be provided as well.

The action of the opening and closing mechanism described above can be inhibited (either by a user operation or automatically) by a locking mechanism, which will be described below. Like the opening and closing mechanism, it is sufficient for the locking mechanism to be provided in at least one of the holding device and the image-forming apparatus. The refill port 114 of the image-forming apparatus 1 or the opening 213 of the refill pack 200 may be attached to a leak prevention member, such as a lid or a cap, to prevent the toner from leaking. Such a leak prevention member may be freely removable by the user.

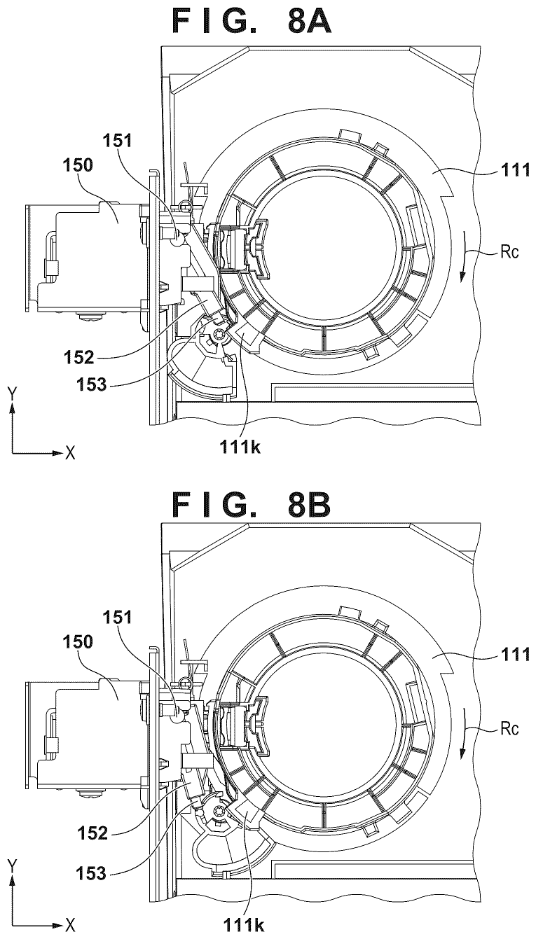

The ring member 111 of the image-forming apparatus 1 may be locked so as not to rotate even if the user applies a force thereto. FIGS. 8A and 8B are explanatory diagrams illustrating an example of a locking mechanism for locking the rotation of the ring member 111. FIGS. 8A and 8B illustrate the toner receiving unit 110 from the inside of the apparatus (toward the Z direction) such that an example of the configuration within the toner receiving unit 110 can be understood in more detail. The toner receiving unit 110 includes, for example, a locking unit 150. The locking unit 150 has a rod-shaped locking member 152, which is supported at one end by a shaft 151 and is capable of pivoting about the shaft 151. The ring member 111 has a protrusion 111k. The locking member 152 is normally biased, by the elastic force of a spring (not shown) within the locking unit 150, in a direction in which a tip 153 on the side opposite from the shaft 151 moves away from the locking unit 150, which positions the tip 153 on the rotational trajectory of the protrusion 111k of the ring member 111. Accordingly, even if the user attempts to rotate the ring member 111 in what is the clockwise direction in the figure (the direction Rc in the figure), the tip 153 of the locking member 152 obstructs the protrusion 111k, which inhibits the rotation of the ring member 111, i.e., locks the opening and closing mechanism of the refill path in the closed state (see FIG. 8A).

The locking unit 150 further includes a solenoid (not shown) for, for example, pivoting the locking member 152 in a direction opposite from the elastic force of the spring. The solenoid is temporarily energized during the period when the refilling of the toner from the refill pack 200 to the image-forming apparatus 1 is permitted, and the locking member 152 is rotated by the attraction force thereof. When the solenoid is energized and the locking member 152 rotates, the tip 153 of the locking member 152 retracts from the rotational trajectory of the protrusion 111k of the ring member 111 (see FIG. 8B). As a result, the user can rotate the ring member 111 in what is the clockwise direction in the figure, i.e., the opening and closing mechanism of the refill path is unlocked. The locking and unlocking of such an opening and closing mechanism can be controlled by the processing circuit 90. Various examples of the conditions under which the opening and closing mechanism is unlocked will be described in the following sections.

Note that the configuration of the locking mechanism that locks and unlocks the opening and closing mechanism is not limited to the example described above, and may be any mechanical, electromagnetic, electrical, or software-based mechanism. For example, the locking member 152 may be driven by a motor or other type of actuator rather than a solenoid. If an opening and closing mechanism activated by computer control is employed rather than relying on operations made by the user, the locking and unlocking of the opening and closing mechanism may be realized simply by program code.

As illustrated on the right side of FIG. 7, an indicator 125 is provided in the vicinity of the ring member 111. The indicator 125 indicates to the user whether the state of the opening and closing mechanism described above is the locked state or the unlocked state. The indicator 125 may be constituted by, for example, a light-emitting diode (LED) disposed within the housing and a window that transmits light from the LED. When the indicator 125 indicates that the opening and closing mechanism is in the unlocked state, the user can rotate the ring member 111 to open the refill path.

### First Embodiment

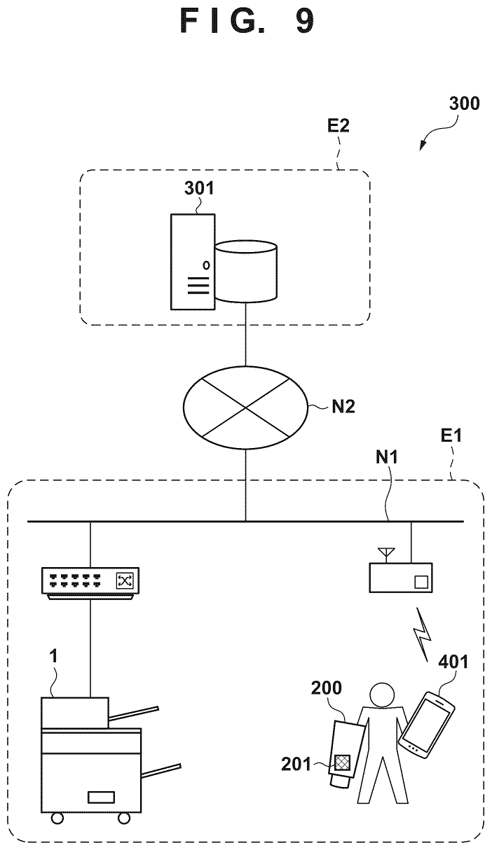

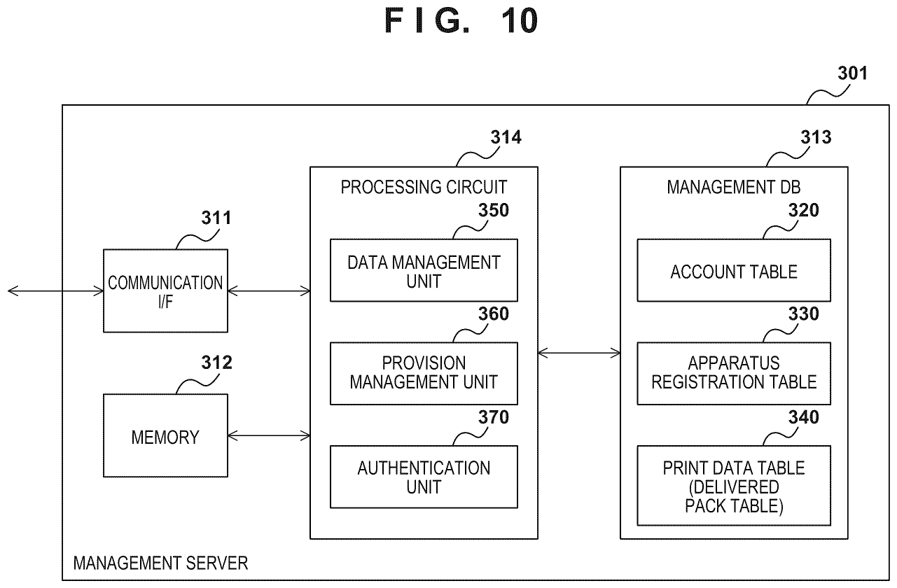

FIG. 9 is a schematic diagram illustrating an example of the configuration of a printing management system 300 according to the present embodiment. Referring to FIG. 9, the printing management system 300 includes the image-forming apparatus 1, a management server 301, and a user terminal 401.

The image-forming apparatus 1 is installed in a user environment E1 of a user who has entered into a subscription contract (referred to simply as a “contract” hereinafter). The image-forming apparatus 1 and the user terminal 401 are connected to a local network N1, which can be a Local Area Network (LAN), for example. The management server 301 is installed in a remote environment E2 and is operated by a business that provides a subscription service. The remote environment E2 is connected to the local network N1 via an external network N2. The external network N2 may be the Internet or a Virtual Private Network (VPN), for example. Each of the local network N1 and the external network N2 may include any number of network devices of any type, such as routers, switches, gateways, wireless access points, and base stations, for example.

The user uses the image-forming apparatus 1 in the user environment E1. As described above, the image-forming apparatus 1 forms an image on a sheet by consuming a consumable material. The consumable material will be assumed to be toner in the following descriptions. When the toner preserved in the image-forming apparatus 1 is depleted, the user connects the refill pack 200, which is a holding device that holds the toner, to the image-forming apparatus 1, and refills the toner in the image-forming apparatus 1 from the refill pack 200.

The management server 301 is a server apparatus for managing the refilling of the toner in the image-forming apparatus 1 from the refill pack 200, and printing using the image-forming apparatus 1. The management server 301 can also be called an “information processing apparatus” or an “information management apparatus”. The management server 301 centrally manages the usage states of individual image-forming apparatuses 1 by a plurality of users. The management server 301 may be implemented as an application server, a database server, or a cloud server, for example, using a high-performance general-purpose computer. The user terminal 401 is a user apparatus or a communication apparatus that provides the user with a user interface for supporting a refill management function of the management server 301. The user terminal 401 may be a general-purpose apparatus such as a smartphone, a mobile phone, a personal computer (PC), or a Personal Digital Assistant (PDA), for example. The image-forming apparatus 1 may also provide a user interface to the user.

Note that the functions of the management server 301, which will be described in detail later, may be provided by a single apparatus, or may be provided by a plurality of physically separate apparatuses interacting with each other. Apart of a database, which is described as being held by the management server 301, may be held by an apparatus separate from the management server 301 (e.g., another database server).

In the subscription service, the remaining amount of toner estimated by the remaining amount detection unit 61 of the image-forming apparatus 1 is sent to the management server 301 sequentially, for example. Based on a change in the remaining amount of toner, the management server 301 sends an in-contract refill pack 200 such that the in-contract refill pack 200 reaches the user before the preserving container 48 of the image-forming apparatus 1 runs out of toner.

FIG. 10 is a block diagram illustrating an example of the configuration of the management server 301 according to the present embodiment. Referring to FIG. 10, the management server 301 includes a communication interface (I/F) 311, a memory 312, a management database (DB) 313, and a processing circuit 314.

The communication I/F 311 is an interface for the management server 301 to communicate with other apparatuses. For example, the communication I/F 311 communicates with the image-forming apparatus 1 and the user terminal 401 present in the user environment E1. The communication I/F 311 may be a wired communication interface or a wireless communication interface.

The memory 312 may include any type of storage medium, including a semiconductor memory such as Read Only Memory (ROM) or Random Access Memory (RAM), an optical disk, or a magnetic disk, for example. The memory 312 may include a non-transitory computer-readable storage medium. The memory 312 stores at least one computer program executed by the processing circuit 314, as well as a variety of data.

The management DB 313 is constituted by a group of tables for managing the printing by at least one image-forming apparatus under the management of the printing management system 300. To be more specific, as illustrated in FIG. 10, the management DB 313 includes an account table 320, an apparatus registration table 330, and a print data table 340. Note that the print data table 340 is replaced with a delivered pack table 340 in a fifth embodiment and the like (described later).

The account table 320 is a table that holds information pertaining to the accounts of users that have entered into contracts. The account table 320 can include the following information items, for example:
“User ID”
“Password”
“Name”
“Address”
“Email address”

“User ID” is identification information for uniquely identifying each user account. “Password” is information used in user authentication when the user logs into the system. “Name” indicates the name of the subscriber. “Address” can be used as a destination when delivering the refill pack 200. “Email address” can be used when making various notifications to each user from the system via email.

The apparatus registration table 330 is a table that holds information pertaining to the image-forming apparatuses under contract. The apparatus registration table 330 can include the following information items, for example:
“Owner”
“Apparatus ID”
“Remaining amount of toner”
“Contract type”
“Remaining number of sheets”

“Owner” indicates the account of the user who owns or manages the image-forming apparatus as “User ID” registered in the account table 320. “Apparatus ID” is identification information for uniquely identifying each image-forming apparatus. A pair constituted by “Owner” and “Apparatus ID” indicates an association between each user account and at least one image-forming apparatus registered as an apparatus for the user who owns that account. Two or more image-forming apparatuses may be associated with a single user account. “Remaining amount of toner” indicates the latest value for the remaining amount of toner as reported from the image-forming apparatus. For example, “Remaining amount of toner” may be expressed as a percentage.

“Contract type” refers to the type of the user contract for when there are various types of contracts. For example, the contract type can be distinguished by the number of sheets that can be printed in a predetermined period; if the number of sheets printed during the predetermined period is less than the number of sheets that can be printed, whether the remaining number of sheets can be carried over to the next predetermined period; and the like. To simplify the descriptions, in the following, the predetermined period is assumed to be one month, i.e., from the first to the last day of each month. “Remaining number of sheets” represents the remaining number of sheets that can be printed onto in the current month. In the present embodiment, the number of sheets that can be printed is associated with individual image-forming apparatuses 1, and thus “Contract type” and “Remaining number of sheets” are included in the apparatus registration table 330. However, if there are a plurality of contracted image-forming apparatuses 1 and the number of sheets that can be printed is set collectively for all the plurality of contracted image-forming apparatuses 1, “Contract type” and “Remaining number of sheets” may be included in the account table 320.

The print data table 340 is a table that holds a list of files that each user is attempting to print. The print data table 340 can include at least one of the following information items, for example:
“Owner”
“Filename”

“Owner” indicates the account of the user who owns the file as “User ID” registered in the account table 320. “Filename” indicates a file to be printed, which is temporarily saved in the memory 312. A plurality of “Filenames” may be associated with one “Owner.”

The processing circuit 314 may be a Central Processing Unit (CPU), for example, and provides various functions of the management server 301 by executing computer programs stored in the memory 312. More specifically, as illustrated in FIG. 10, the processing circuit 314 can function as a data management unit 350, a provision management unit 360, and an authentication unit 370.

In conjunction with other functions provided by the processing circuit 314, e.g., the authentication unit 370, the data management unit 350 manages the registration and updating of data in the management DB 313. The data management unit 350 may cause the user terminal 401 to display a screen for accepting the input of account information to be registered in the account table 320, receive the input account information through the communication I/F 311, and register the input account information in the account table 320. Similarly, the data management unit 350 may cause the user terminal 401 to display a screen for accepting the input of apparatus information for the image-forming apparatus used under the contract, receive the input apparatus information through the communication I/F 311, and register the input apparatus information in the apparatus registration table 330. These input screens may be provided in any format, such as, for example, a web page, an input form, or an application screen. Typically, the input of the apparatus information may be accepted during a period in which user authentication using the user ID and password stored in the account table 320 is successful and the user is logged into the system.

The data management unit 350 can also update the value of “Remaining number of sheets” every predetermined period based on contract details indicated by “Contract type” in the apparatus registration table 330. For example, if “Contract type” permits the printing of up to 50 sheets per month and the unused amount is carried over to the next month, the data management unit 350 increases the value of “Remaining number of sheets” by 50 from the current value on the first day of each month. For example, the data management unit 350 receives, from a registered image-forming apparatus 1, remaining amount information pertaining to the remaining amount of toner in the preserving container 48 of the apparatus, through the communication I/F 311. The data management unit 350 can then update the value of “Remaining amount of toner” in the apparatus registration table 330 based on the received remaining amount information.

Furthermore, the data management unit 350 manages files to be printed. Upon receiving data to be printed from each user, the data management unit 350 saves the file in the memory 312 and registers “Filename” of the saved data in the print data table 340. When the printing is complete, the data management unit 350 deletes the data to be printed from the memory 312 and also deletes “Filename” from the print data table 340.

The provision management unit 360 manages the provision of the in-contract refill pack 200 to users. For example, when the value of “Remaining amount of toner” in the apparatus registration table 330 drops below a predetermined value, the provision management unit 360 performs a procedure for sending an in-contract refill pack 200 to the address of the user registered in the account table 320. The timing of the provision is not limited thereto, and the provision management unit 360 may have a function for determining the timing based on, for example, a change in “Remaining amount of toner” in the apparatus registration table 330.

The authentication unit 370 performs user authentication (e.g., password authentication) when the user logs in to the system. The authentication unit 370 also performs authentication for permitting refilling for the refill pack 200 that is to be used to refill the toner (called “pre-refill authentication” hereinafter), and authentication for permitting printing before the printing is performed (called “pre-printing authentication” hereinafter).

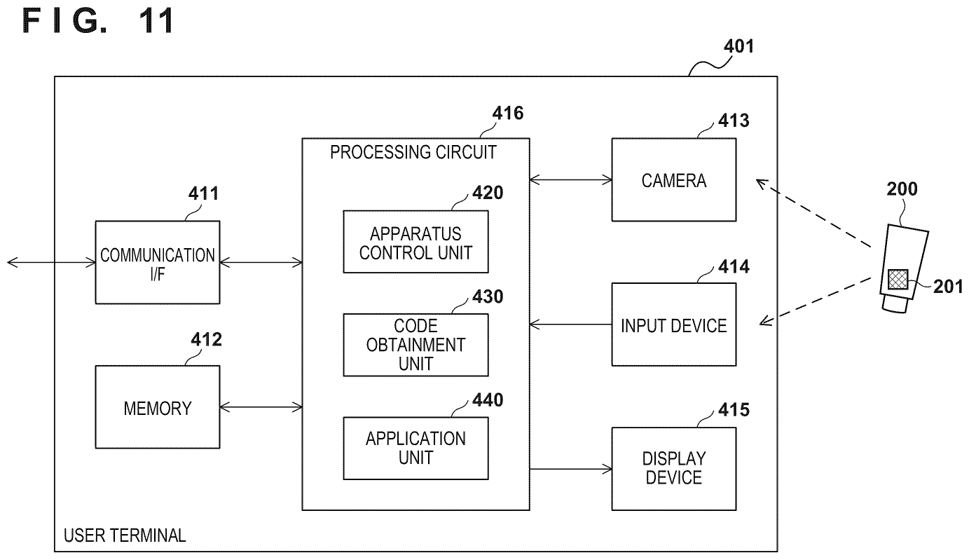

FIG. 11 is a block diagram illustrating an example of the configuration of the user terminal 401 according to the present embodiment. Referring to FIG. 11, the user terminal 401 includes a communication I/F 411, a memory 412, a camera 413, an input device 414, a display device 415, and a processing circuit 416.

The communication I/F 411 is an interface for the user terminal 401 to communicate with other apparatuses. For example, the communication I/F 411 communicates with the image-forming apparatus 1 present in the user environment E1 and the management server 301 present in the remote environment E2. The communication I/F 411 may be a wired communication interface or a wireless communication interface. If the communication I/F 411 is a wireless communication interface, the communication I/F 411 may be, for example, a WLAN interface that communicates with a WLAN access point or a cellular communication interface that communicates with a cellular base station. Although only a single communication I/F 411 is illustrated in FIG. 11, the user terminal 401 may include a plurality of different communication modules for communicating with the image-forming apparatus 1 and the management server 301, respectively. The communication between the user terminal 401 and the image-forming apparatus 1 may be performed using a communication protocol for connecting peripheral devices, such as Bluetooth (registered trademark) or Universal Serial Bus (USB), for example.

The memory 412 may include any type of storage medium, including a semiconductor memory such as a ROM or a RAM, an optical disk, or a magnetic disk, for example. The memory 412 may include a non-transitory computer-readable storage medium. The memory 412 stores at least one computer program executed by the processing circuit 416, as well as a variety of data.

The camera 413 is a module capable of capturing images or video of a subject. In the present embodiment, the camera 413 is used to optically read a code 201 unique to the refill pack 200. In other words, the code 201 is printed on the surface of the holding part 211 of the refill pack 200, or on the package of the refill pack 200, in a format that can be read visually by the user or optically by the user terminal 401. The optically-readable format may include a format such as a one-dimensional barcode or a two-dimensional QR code (registered trademark), for example. In the present embodiment, the code 201 can include first determination information for determining whether the refill pack 200 is an in-contract refill pack 200. The code 201 can also include capacity information indicating the amount of toner the refill pack 200 holds. The code 201 can directly or indirectly indicate the first determination information and the capacity information. When indicated indirectly, the first determination information and the capacity information can indicate, for example, a serial number of the refill pack 200. By referring to information held by the management server 301 or information stored in an external device based on the serial number, the management server 301 can determine the amount of toner contained in the refill pack 200 and whether the refill pack 200 is an in-contract refill pack. When indicated indirectly, the first determination information and the capacity information can be the same information. The code 201 may also be encrypted data that can be decrypted by the management server 301.

The input device 414 is used as a user interface for accepting user operations and the input of information. The input device 414 can include at least one of, for example, a touch sensor, a keypad, a keyboard, a pointing device, and a microphone. The code 201 unique to the refill pack 200 may be input by the user through the input device 414.

The display device 415 is used to display images and information. The display device 415 may be constituted by, for example, a liquid crystal display (LCD) or organic light-emitting diodes (OLED).

The processing circuit 416 may be a CPU, for example, and provides various functions of the user terminal 401 by executing computer programs stored in the memory 412. More specifically, as illustrated in FIG. 11, the processing circuit 416 can function as an apparatus control unit 420, a code obtainment unit 430, and an application unit 440. Although the present specification mainly describes only the functions related to refilling the image-forming apparatus 1 with toner and printing, the processing circuit 416 may also provide the user with a variety of other functions that a user terminal generally includes.

The apparatus control unit 420 controls image-forming and other operations performed by the image-forming apparatus 1. The apparatus control unit 420 may include driver software for the image-forming apparatus 1. For example, the apparatus control unit 420 detects one or more apparatuses that can be used by the user terminal 401 present in the user environment E1, and presents a list of the detected apparatuses to the user in the screen of the display device 415. The apparatus control unit 420 may obtain the status of each apparatus (e.g., power on/off, the remaining amount of toner, and the like) and present the obtained status to the user.

The code obtainment unit 430 obtains the code 201 unique to the refill pack 200 that the user attempts to use to refill the toner. For example, the camera 413 or the input device 414 can be used, as described above.

The application unit 440 can be an application for refill and printing management that runs in cooperation with the management server 301. The application unit 440 may be a web browser. For example, when a user account is newly registered, and when the user account changes, the application unit 440 causes an account information input screen to be displayed in the display device 415. When the account information is input in the account information input screen, the application unit 440 sends the accepted account information to the management server 301 through the communication I/F 411. The application unit 440 also causes the display device 415 to display an apparatus information input screen when the image-forming apparatus 1 is installed in the user environment E1. When the apparatus information is input in the apparatus information input screen, the application unit 440 sends the accepted apparatus information to the management server 301 through the communication I/F 411. When printing is instructed by the user, the application unit 440 sends a print job including data of an image to be printed to the management server 301, and causes the image-forming apparatus 1 to print the image via the management server 301.

The application unit 440 may also provide a user interface for requesting the management server 301 to execute pre-refill authentication for a user who wishes to refill the image-forming apparatus 1 with toner. For example, when the user operates a button for making an authentication request, the application unit 440 starts the code obtainment unit 430 to obtain the code 201 of the refill pack 200, and sends the obtained code 201 to the management server 301 through the communication I/F 411. The application unit 440 may send the code 201 to the management server 301 as part of a request for permission to refill the toner. The application unit 440 may also send the code 201 to the management server 301 as part of a request to open the refill path (or unlock the opening and closing mechanism).

In an example, the application unit 440 may send a sending request to the image-forming apparatus 1 to send the apparatus ID required for pre-refill authentication by the management server 301 to the management server 301. In another example, the application unit 440 may cause the display device 415 to display a message prompting the user to perform an operation in the image-forming apparatus 1 for sending the apparatus ID.

When the pre-refill authentication is performed by the management server 301 based on the code 201 of the refill pack 200, the application unit 440 receives the result of the pre-refill authentication from the management server 301. If the authentication result indicates the pre-refill authentication is successful, the application unit 440 may cause the apparatus control unit 420 to send an unlock command for unlocking the opening and closing mechanism, or an open command for opening the refill path, to the image-forming apparatus 1. Note that if these commands are sent directly to the image-forming apparatus 1 from the management server 301, the user terminal 401 need not send the commands to the image-forming apparatus 1.

The application unit 440 causes the display device 415 to display the result of the pre-refill authentication received from the management server 301. For example, if the result of the pre-refill authentication indicates that the authentication is successful, the user can connect the refill pack 200 to the image-forming apparatus 1, open the toner refill path by operating the opening and closing mechanism that blocked the refill path, and refill the image-forming apparatus 1 with the toner from the refill pack 200. At this time, the opening and closing mechanism is unlocked by the image-forming apparatus 1, and thus the user is not inhibited from performing an operation to open the refill path. Note that the refill pack 200 may be connected to the image-forming apparatus 1 before the request for the pre-refill authentication, or after the authentication is successful. As described above, the image-forming apparatus 1 may automatically activate the opening and closing mechanism instead of the user operating the opening and closing mechanism. If the result of the pre-refill authentication indicates that the authentication has failed, the user retries the pre-refill authentication after taking appropriate measures, or gives up on refilling the toner for the time being, depending on the cause of the failure, which can be displayed on the screen. At this time, the opening and closing mechanism remains locked by the image-forming apparatus 1, or the opening and closing mechanism is not automatically activated and the refill path remains blocked.

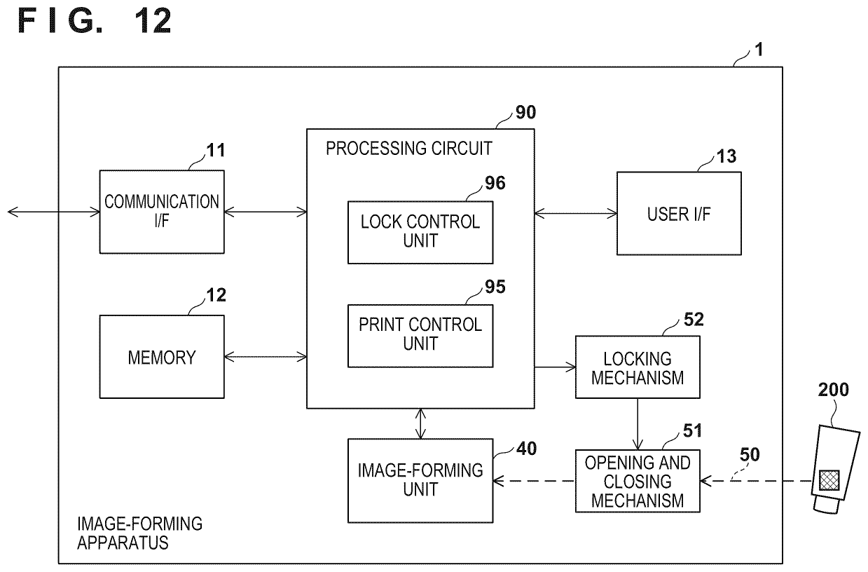

FIG. 12 is a block diagram illustrating an example of the functional configuration of the image-forming apparatus 1 according to the present embodiment. Referring to FIG. 12, the image-forming apparatus 1 includes a communication I/F 11, a memory 12, a user I/F 13, the image-forming unit 40, an opening and closing mechanism 51, a locking mechanism 52, and the processing circuit 90.

The communication I/F 11 is an interface for the image-forming apparatus 1 to communicate with other apparatuses. For example, the communication I/F 11 communicates with the user terminal 401 present in the user environment E1 and the management server 301 present in the remote environment E2. The communication I/F 11 may be a wired communication interface or a wireless communication interface. If the communication I/F 11 is a wireless communication interface, the communication I/F 11 may be, for example, a WLAN interface or a cellular communication interface. Although only a single communication I/F 11 is illustrated in FIG. 12, the image-forming apparatus 1 may include a plurality of different communication modules for communicating with the user terminal 401 and the management server 301, respectively.

The memory 12 may include any type of storage medium, including a semiconductor memory such as a ROM or a RAM, an optical disk, or a magnetic disk, for example. The memory 12 may include a non-transitory computer-readable storage medium. The memory 12 stores at least one computer program executed by the processing circuit 90, as well as a variety of data. The memory 12 stores, in advance, the apparatus ID (also called “apparatus identification information”) that uniquely identifies the image-forming apparatus 1, for example.

The user I/F 13 can include an input device for accepting user operations and the input of information, and a display device for displaying images and information. For example, the user I/F 13 can include at least one of a touch panel, a keypad, buttons, switches, a microphone, and a speaker. The user I/F 13 may be treated as an operation terminal integrated into the image-forming apparatus 1. In an example, the user I/F 13 may be used to accept input of the code 201 of the refill pack 200.

As described with reference to FIG. 2, the image-forming unit 40 forms an image on a sheet by consuming toner preserved in the preserving container 48. The opening and closing mechanism 51 is a mechanism that can open and close a refill path 50 to the preserving container 48 from the refill pack 200 connected to the toner receiving unit 110. The above-described ring member 111 including the lever 111b and the protruding part 111d, the pack shutter 214 of the refill pack 200, and the main body shutter 116 are an example of the opening and closing mechanism 51. The locking mechanism 52 is a mechanism for inhibiting (i.e., locking) and canceling the inhibiting (unlocking) of the operation of the opening and closing mechanism 51 performed by the user or the automatic action of the opening and closing mechanism 51. The above-described locking unit 150 is an example of the locking mechanism 52.

From a functional perspective, the above-described electronic component groups 91, 92, and 93 of the processing circuit 90 can function mainly as a print control unit 95 and a lock control unit 96. The print control unit 95 controls operations for image formation performed by the image-forming unit 40. For example, when a print job is received from the management server 301 via the communication I/F 11, the print control unit 95 controls the image-forming unit 40 to form an image on a sheet based on input image data included in the print job.

The lock control unit 96 controls the locking and unlocking of the opening and closing mechanism 51 by the locking mechanism 52. For example, when a predetermined input signal is detected, the lock control unit 96 sends the apparatus ID stored in the memory 12 to the management server 301. The apparatus ID sent to the management server 301 may be used to verify whether the image-forming apparatus 1 identified by the apparatus ID specified by the user for apparatus registration is actually installed in the user environment E1 of that user. The apparatus ID sent to the management server 301 may be used for the execution of the pre-refill authentication and the pre-printing authentication by the management server 301. The lock control unit 96 may send the remaining amount information indicating the latest remaining amount of toner to the management server 301 along with the apparatus ID.

In an example, the aforementioned input signal that triggers the sending of the apparatus ID is a received signal (e.g., a sending request requesting the apparatus ID be sent) received from the user terminal 401 via the communication I/F 11. In this case, in response to the sending request being received, the lock control unit 96 reads out the apparatus ID from the memory 12 and sends the read-out apparatus ID to the management server 301. In another example, the aforementioned input signal that triggers the sending of the apparatus ID is a user input signal (e.g., an operation signal indicating that a predetermined button has been operated) detected via the user I/F 13. In this case, in response to the user input signal being detected, the lock control unit 96 reads out the apparatus ID from the memory 12 and sends the read-out apparatus ID to the management server 301.

After sending the apparatus ID to the management server 301 for the pre-refill authentication, the lock control unit 96 receives the unlock command, which is a control signal based on the result of the pre-refill authentication, over a predetermined standby period. Then, if the unlock command is received before the standby period ends, the lock control unit 96 causes the locking mechanism 52 to unlock the opening and closing mechanism 51 in accordance with the unlock command. For example, the lock control unit 96 may energize the solenoid of the locking unit 150 to pivot the locking member 152 as in the example illustrated in FIG. 8B. This makes it possible for the user to open the refill path 50 by rotating the main body shutter 116 and the pack shutter 214 of the refill pack 200 along with the ring member 111. Note that if a configuration is employed in which the image-forming apparatus 1 automatically activates the opening and closing mechanism 51, the lock control unit 96 may stand by for the reception of an open command instead of an unlock command, and open the refill path 50 by activating the opening and closing mechanism 51 in accordance with the received open command.

If the standby period ends without the unlock command or the open command being received (i.e., in the case of a timeout), the lock control unit 96 stops standing by for the command. For example, the unlock command or the open command may be stood by for by temporarily opening a specific receiving port of the communication I/F 11. The risk of the image-forming apparatus 1 being operated by a third party can be minimized by standing by for a control signal from the outside only for a limited period of time that is triggered by the detection of a predetermined input signal. In addition, the power consumed by the image-forming apparatus 1 can be reduced by putting the image-forming apparatus 1 into a sleep state during periods aside from the standby period.

If the unlock command or the open command is received before the end of the standby period, the lock control unit 96 may keep the opening and closing mechanism 51 in the unlocked state for a predetermined unlocked period following the reception of the command, and lock the opening and closing mechanism 51 again after the unlocked period ends. In the example illustrated in FIGS. 8A and 8B, even if the solenoid is energized, the ring member 111 can be rotated counterclockwise while the opening and closing mechanism 51 is in the open state. For example, after the opening and closing mechanism 51 is unlocked, the user rotates the ring member 111 in what is the clockwise direction in the figure to open the refill path, and the refilling of the toner is started as a result. After the refilling of the toner is complete, the user rotates the ring member 111 counterclockwise to block the refill path. When the energizing of the solenoid ends and the rotational position of the ring member 111 is returned to the original position, the tip 153 of the locking member 152 returns to the position illustrated in FIG. 8A under the elastic force of the spring. As a result, even if the user attempts to open the refill path by rotating the ring member 111 clockwise again, the rotation of the ring member 111 is inhibited by the locking member 152. The relocking of the opening and closing mechanism 51 can be achieved in this manner. Again, note that the configuration illustrated in FIGS. 8A and 8B is merely an example of the opening and closing mechanism 51 and the locking mechanism 52, and any other configuration may be employed.

The print control unit 95 controls the remaining amount detection unit 61 to detect the remaining amount of toner in the preserving container 48 when, for example, image-forming operations are performed and when the toner is refilled. For example, the remaining amount detection unit 61 causes light to be emitted from the light emitter 61a and obtains a light detection signal from the light receiver 61b while the toner preserved in the preserving container 48 is being agitated by the agitation member 60. The remaining amount detection unit 61 then estimates the remaining amount of toner based on the obtained light detection signal, and reports the estimated remaining amount of toner to the print control unit 95. The print control unit 95 reports the remaining amount information indicating the remaining amount of toner detected in this manner to the management server 301 via the communication I/F 11. The report on the remaining amount of toner may be sent to the management server 301 via the user terminal 401 instead of being sent directly to the management server 301.

When the toner is refilled, the remaining amount of toner increases. As described above, detecting an increase in the remaining amount of toner based on the remaining amount information makes it possible for the management server 301 to ascertain that the refill pack 200 for which the pre-refill authentication was successful has been used by the user. Note that instead of the management server 301, the image-forming apparatus 1 or the user terminal 401 may detect the increase in the remaining amount of toner and send a notification signal indicating that the refill pack 200 has been used to the management server 301.

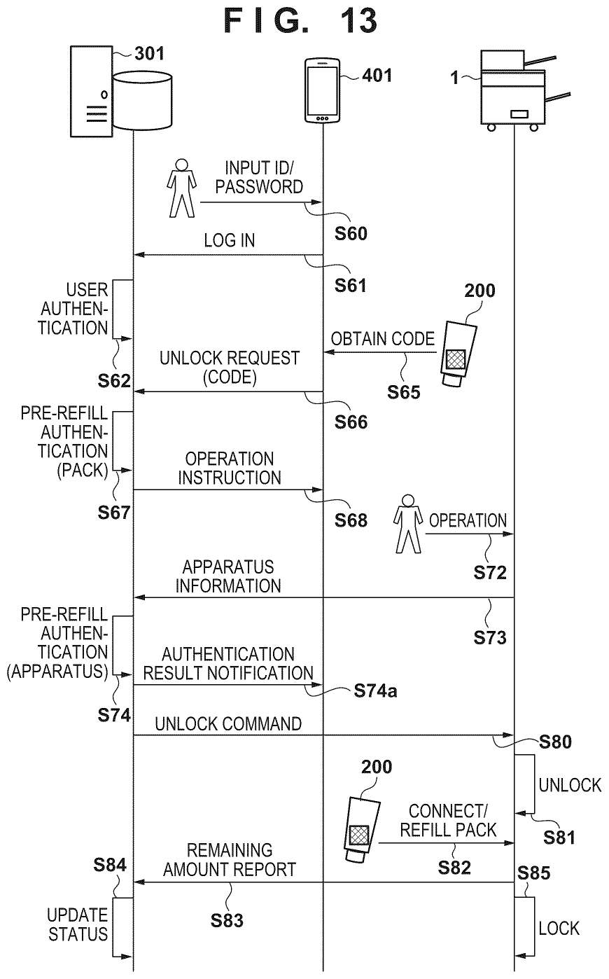

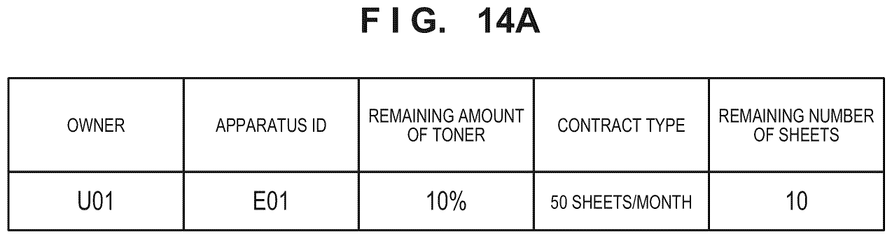

FIG. 13 is a sequence chart illustrating an overview of the toner refilling processing according to the present embodiment. In S60, the user inputs a user ID and password in a login screen displayed in the display device 415 of the user terminal 401. In S61, the application unit 440 of the user terminal 401 sends the input user ID and password to the management server 301. In S62, the authentication unit 370 of the management server 301 executes user authentication to authenticate whether the user ID and password received from the user terminal 401 match a record in the account table 320. It is assumed here that the user authentication is successful and the login to the system is established. The subsequent processing illustrated in FIG. 13 is performed while the login session continues.

In S65, the application unit 440 of the user terminal 401 starts the code obtainment unit 430 in response to an operation made by the user. The code obtainment unit 430 obtains the code 201 of the refill pack 200 by, for example, optically reading the code using the camera 413, or by accepting a user input. Next, in S66, the application unit 440 sends an unlock request, including the code 201 obtained by the code obtainment unit 430, to the management server 301.

The authentication unit 370 of the management server 301 starts the pre-refill authentication in response to the unlock request being received. S67 is a first stage of the pre-refill authentication, in which the authentication unit 370 checks the legitimacy of the code 201 included in the unlock request. If the code 201 is encrypted, checking the legitimacy of the code 201 includes determining whether the code 201 can be decrypted, for example. Checking the legitimacy of the code 201 also includes determining whether the refill pack 200 is an in-contract refill pack 200 or an out-of-contract refill pack 200. If the first stage of the authentication is successful, in S68, the data management unit 350 instructs the application unit 440 to display a message prompting a predetermined operation to be performed in the image-forming apparatus 1 to be refilled. The message is displayed by the display device 415 as a result.

In S72, the user performs the predetermined operation through the user I/F 13 of the image-forming apparatus 1 to be refilled. Upon doing so, in S73, the lock control unit 96 reads out the apparatus ID from the memory 12 and sends the apparatus information, including the read-out apparatus ID, to the management server 301.

S74 is a second stage of the pre-refill authentication, in which the authentication unit 370 determines whether the image-forming apparatus 1 which is to be refilled corresponds properly to the user account of the logged-in user by referring to the apparatus registration table 330 based on the apparatus ID included in the received apparatus information. It is assumed here that the image-forming apparatus 1 corresponds properly to the user account, and the second stage of the authentication is therefore also successful. In response to the pre-refill authentication being successful, in S74a, the data management unit 350 notifies the user terminal 401 of the result that the authentication is successful. Additionally, in S80, the data management unit 350 sends an unlock command to the image-forming apparatus 1 to cause the locking mechanism 52 of the image-forming apparatus 1 to unlock the opening and closing mechanism 51.

In S81, in response to the unlock command from the management server 301 being received, the lock control unit 96 of the image-forming apparatus 1 causes the locking mechanism 52 to unlock the opening and closing mechanism 51.

In S82, the unlocked opening and closing mechanism 51 is operated by the user (or is automatically activated), the refill path 50 is opened, and the image-forming apparatus 1 is refilled with the toner from the refill pack 200.

In S83, the print control unit 95 detects the remaining amount of toner in the preserving container 48 and reports the remaining amount information, which indicates the remaining amount of toner, to the management server 301.

In S84, the data management unit 350 of the management server 301 updates the value of “Remaining amount of toner” in the record of the apparatus registration table 330 corresponding to the image-forming apparatus 1 to be refilled in response to the remaining amount information being received.

Next, based on the code 201 included in the unlock request received in S62, the data management unit 350 determines whether the refill pack 200 used to refill the consumable material is an out-of-contract refill pack 200. If the refill pack 200 used to refill the consumable material is determined to be an out-of-contract refill pack 200, the data management unit 350 performs addition processing for “Remaining number of sheets” in the record. The number of sheets to be added may be determined by dividing the amount of toner refilled using the out-of-contract refill pack 200 by the average amount of toner consumed to print a single sheet. The amount of toner refilled using the out-of-contract refill pack 200 can be a nominal value of the amount of toner contained in the pack, or can be a value based on an amount of increase in the remaining amount of toner reported by the image-forming apparatus 1. As described above, the code 201 can also include capacity information directly or indirectly indicating the amount of toner the refill pack 200 holds. When the capacity information is information directly indicating the toner amount, the nominal value is the toner amount indicated by the capacity information. On the other hand, when the capacity information is information that can specify the serial number of the refill pack 200, the type of the refill pack 200, or the like, for example, the nominal value is the amount of toner obtained by the data management unit 350 from an external device by referring to the external device based on the capacity information. Note that the configuration can also be such that the management server 301 obtains the relationship between the capacity information and the nominal value of the amount of toner held in the refill pack 200 from the external device in advance, and stores that relationship in the management DB 313. In this case, the data management unit 350 can determine the nominal value without needing to refer to the external device each time the capacity information is obtained. Note that if there is only one type of refill pack 200 that can be used in the image-forming apparatus 1, the data management unit 350 stores the nominal value of the amount of toner held in that refill pack 200 in advance. In this case, the data management unit 350 can determine the nominal value without obtaining the capacity information. Note that the average amount of toner consumed by printing a single sheet may be a predetermined value, or may be an average amount of toner consumed when a user prints a single sheet, as determined from that user's past usage.

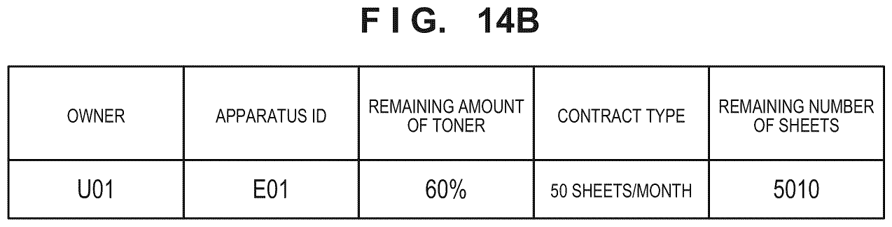

For example, assume that a user whose “User ID” is U01 refills the image-forming apparatus 1 having “Apparatus ID” of E01 with toner from an out-of-contract refill pack 200. FIG. 14A illustrates a pre-refill record in the apparatus registration table 330 in which “Owner” is U01 and “Apparatus ID” is E01. As illustrated in FIG. 14A, before the refill, “Remaining amount of toner” in the image-forming apparatus 1 is 10% and “Remaining number of sheets” is 10 sheets. FIG. 14B illustrates the record after the refill. In S83, the image-forming apparatus 1 reports to the management server 301 that the remaining amount of toner has changed to 60%, and in response, the data management unit 350 updates “Remaining amount of toner” to 60%. Based on the remaining amount of toner before and after the refill, the data management unit 350 determines that the amount of toner has increased by 50%. Assuming that 100 sheets can be printed with a toner amount of 1%, 5,000 sheets can be printed with a toner amount of 50%. Accordingly, the data management unit 350 sets “Remaining number of sheets” to 5010, assuming an increase of 5000. Note that if the toner is refilled using an in-contract refill pack 200, “Remaining number of sheets” remains unchanged at 10.

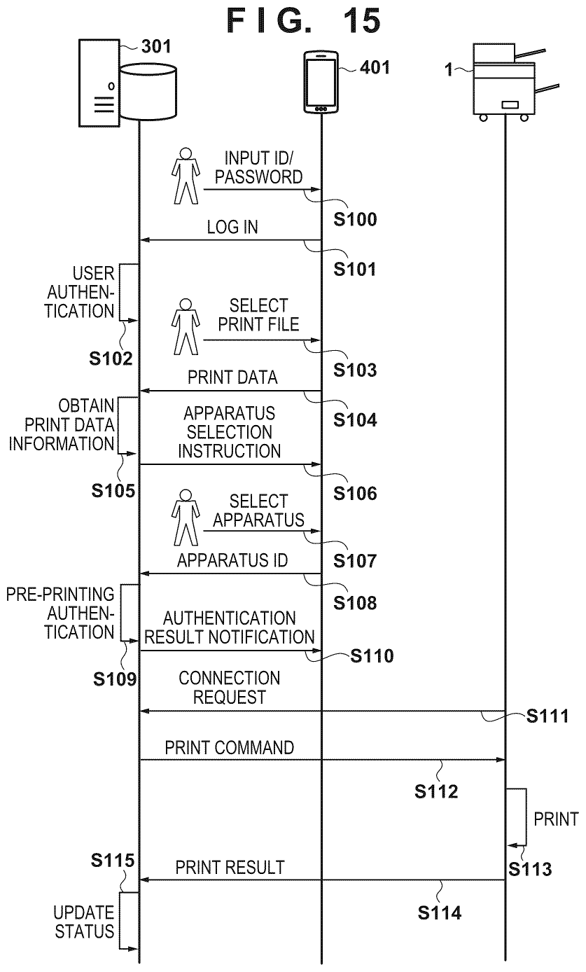

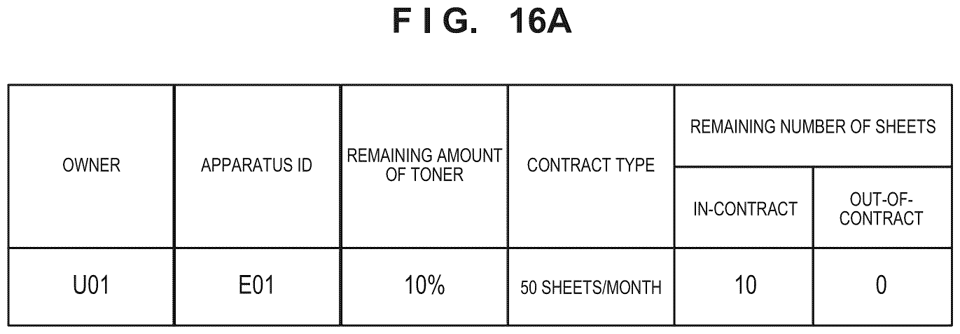

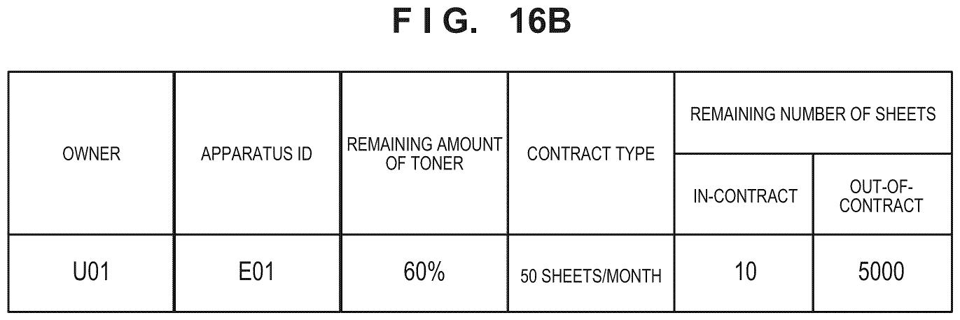

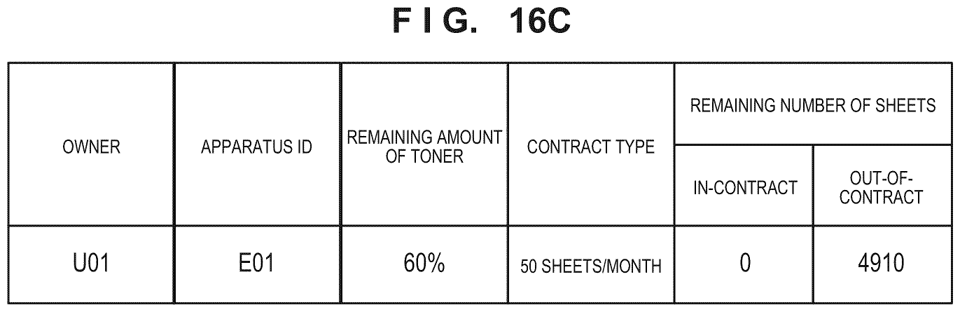

FIG. 15 is a sequence chart illustrating an overview of the printing processing according to the present embodiment. First, in S100, the user inputs the user ID and password in the login screen. In S101, the application unit 440 of the user terminal 401 sends the input user ID and password to the management server 301. In S102, the authentication unit 370 of the management server 301 executes user authentication based on the user ID and password received from the user terminal 401. It is assumed here that the user authentication is successful and the login to the system is established. The subsequent processing illustrated in FIG. 15 is performed while the login session continues.

Next, in S103, the user selects a file to be printed in a print screen provided by the application unit 440. In S104, the application unit 440 of the user terminal 401 sends print data, including print settings such as the data to be printed and the number of copies to be printed, to the management server 301. The data to be printed may remain as the original file, or may be data converted to a PostScript format, another image format, or the like by the application unit 440. Note that if the file of the print data is stored in the memory 312 of the management server 301 in advance, the user terminal 401 need not send the print data to the management server 301 each time. The user may select a filename for printing from the user terminal 401. The management server 301 generates a list of filenames based on the information registered in the print data table 340, and sends information for displaying the generated list to the user terminal 401. A list of candidates for printing is displayed in the user terminal 401 as a result of this transmission.

In S105, the data management unit 350 obtains a total number of printed sheets, which is the print data information of the received print data. For example, the data management unit 350 analyzes the print data received by the processing circuit 314 and obtains the generated print data information. Alternatively, if the user terminal 401 generates the print data information and sends that information to the management server 301 as part of the print data, the data management unit 350 extracts the print data information from the received print data. Alternatively, if the print data sent from the user terminal 401 is data of an original file, such as a document file, the processing circuit 314 converts the data of the original file into data in a predetermined format that can be interpreted by the image-forming apparatus 1. The processing circuit 314 may also generate the print data information during data conversion processing, and the data management unit 350 may obtain that generated print data information. Note that in addition to the total number of printed sheets, the print data information includes attribute information of the print data, such as the filename (job name), a username, the date the print data was created, the size, the type of data, a logical number of pages, and the like, for example. The print data information also includes setting information such as the number of copies to be printed, single-sided/double-sided settings, 2-in-1 layout settings, and the like.

Next, in S106, the data management unit 350 instructs the user terminal 401 to select the image-forming apparatus to be used for printing. At this time, the data management unit 350 can generate a list of image-forming apparatuses selected by the user from the apparatus registration table 330 based on the user ID of the user. The apparatus control unit 420 of the user terminal 401 can create the list of image-forming apparatuses selected by the user by detecting image-forming apparatuses in the vicinity. When in S107 the user selects the image-forming apparatus 1 present in the user environment E1, in S108, the application unit 440 sends the apparatus ID of the image-forming apparatus 1 to the management server 301.

S109 is the pre-printing authentication, and here, the authentication unit 370 determines whether “Remaining number of sheets” for the image-forming apparatus 1 at least the total number of printed sheets calculated in S105, based on the received apparatus ID. If “Remaining number of sheets” is at least the total number of printed sheets, the data management unit 350 permits printing. However, if “Remaining number of sheets” is less than the total number of printed sheets, the data management unit 350 does not permit printing. If printing is permitted, in S110, the data management unit 350 notifies the user terminal 401 of an authentication result indicating that the authentication has succeeded. If printing is not permitted, the data management unit 350 may suspend the sequence of FIG. 15 by notifying the user terminal 401 that the authentication has failed, or may notify the user terminal 401 of a proposal to change the contract. Note that when a notification that the authentication has failed is made, the user terminal 401 can display an indication that printing is not permitted in the display device 415, for example. Additionally, when a notification of a proposal to change the contract is made, the user terminal 401 can display the details of the proposal in the display device 415, for example.

In S111, the image-forming apparatus 1 makes a connection request to the management server 301, and establishes a communication session with the management server 301 for communication between the image-forming apparatus 1 and the management server 301. The communication session is maintained between the image-forming apparatus 1 and the management server 301 for a predetermined period. The image-forming apparatus 1 can be configured to periodically make connection requests to the management server 301. Note that the configuration may be such that the management server 301 sends the connection request to the image-forming apparatus 1. If the authentication is successful in S109, in S112, the data management unit 350 sends the print data to the image-forming apparatus 1 and issues a print command. In S113, the image-forming apparatus 1 executes printing based on the received print data. Once the printing is completed, in S114, the image-forming apparatus 1 sends a print result, including the actual number of printed sheets, to at least the management server 301. In S115, the data management unit 350 of the management server 301 decrements the value of “Remaining number of sheets” by the actual number of printed sheets based on the received print result. Here, if the actual number of printed sheets is greater than “Remaining number of sheets”, the data management unit 350 sets “Remaining number of sheets” to 0 and records the difference between “Remaining number of sheets” and the actual number of printed sheets. This difference can be calculated individually based on the contract. Note that the configuration can also be such that “Remaining number of sheets” is reduced by the total number of printed sheets calculated in S105.

The present embodiment has described an example in which the code 201 can be obtained from both the in-contract refill pack 200 and the out-of-contract refill pack 200. However, one of the in-contract refill pack 200 and the out-of-contract refill pack 200 may not be provided with the code 201, and whether the refill pack 200 is an in-contract refill pack 200 may be determined based on whether the unique code 201 is included in the unlock request.

Additionally, the code 201 in the present embodiment is a code that can be optically read by the user terminal 401, or a code that can be read by the user. However, the configuration can be such that the information indicated by the code 201 (determination information, capacity information, or the like) is converted into data, and a memory device that stores that data is provided in the refill pack 200. In this case, the image-forming apparatus 1 or the user terminal 401 reads the information indicated by the code 201 through wired or wireless communication with the memory device.

The configurations of the management server 301, the user terminal 401, and the image-forming apparatus according to the present embodiment are merely examples, and the above-described functions are not limited to being implemented by one of the management server 301, the user terminal 401, or the image-forming apparatus. For example, the function for checking the legitimacy of the code 201 may be implemented by the image-forming apparatus. The code 201 may also be sent to the management server 301 by the image-forming apparatus 1. Additionally, some or all of the data in the management DB 313 may be stored in the memory 12 of the image-forming apparatus.

Furthermore, whether the management server 301 permits printing is determined in the sequence illustrated in FIG. 15 (S109 in FIG. 15). However, the configuration can also be such that the image-forming apparatus 1 or the user terminal 401 determines whether to permit printing.

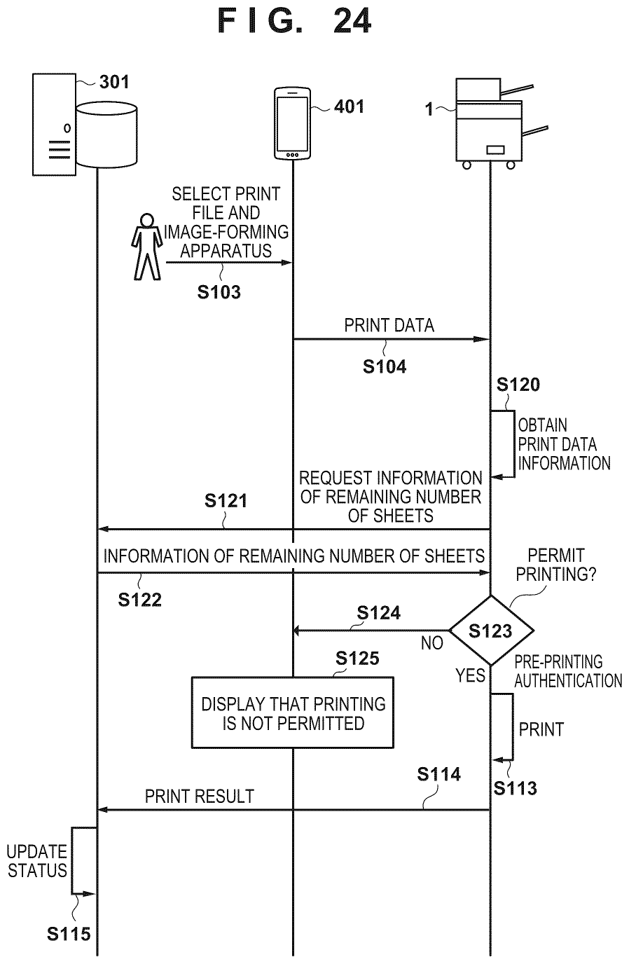

FIG. 24 is a sequence chart illustrating an overview of the printing processing when the image-forming apparatus 1 determines whether to permit printing. Note that in the sequence illustrated in FIG. 24, processing steps that are the same as those in FIG. 15 are given the same step numbers. The processing for establishing a communication session between the image-forming apparatus 1 and the management server 301 (S111 in FIG. 15) is also not shown. In S103, the user selects a file to be printed, and the image-forming apparatus 1 to use for the printing, in the print screen provided by the application unit 440. In S104, the apparatus control unit 420 of the user terminal 401 sends print data to the image-forming apparatus 1 to be used for the printing. In S120, the print control unit 95 of the image-forming apparatus 1 obtains the total number of printed sheets as the print data information. With respect to obtaining the print data information, the image-forming apparatus 1 may execute the same processing as that executed by the data management unit 350 and the processing circuit 314 illustrated in FIG. 15. In S121, the print control unit 95 of the image-forming apparatus 1 notifies the management server 301 of the apparatus ID stored in the memory 12, and requests the information of “Remaining number of sheets” for the image-forming apparatus 1. In S122, in response to the request, the management server 301 obtains “Remaining number of sheets” for the image-forming apparatus 1 that made the request by referring to the management DB 313, and sends the information of “Remaining number of sheets” to the image-forming apparatus 1.

In S123, the print control unit 95 of the image-forming apparatus 1 determines whether to permit printing by comparing “Remaining number of sheets” from the notification made by the management server 301 in S122 with the total number of printed sheets calculated in S120. Specifically, printing is permitted if “Remaining number of sheets” is at least the total number of printed sheets, whereas printing is not permitted if “Remaining number of sheets” is less than the total number of printed sheets. If printing is not permitted, in S124, the print control unit 95 notifies the user terminal 401 that printing is not permitted. When the notification that printing is not permitted is made, in S125, the application unit 440 of the user terminal 401 displays an indication that printing is not permitted in the display device 415. Note that at this time, the image-forming apparatus 1 can also display an indication that printing is not permitted in the display device via the user I/F 13. On the other hand, if printing is permitted, in S113, the print control unit 95 executes printing based on the received print data. Once the printing is completed, in S114, the print control unit 95 sends a print result, including the actual number of printed sheets, to at least the management server 301. In S115, the data management unit 350 of the management server 301 updates the value of “Remaining number of sheets” for the image-forming apparatus 1 in the management DB 313, as described with reference to FIG. 15.

Note that in the sequence chart illustrated in FIG. 24, in S120, the image-forming apparatus 1 calculates the total number of printed sheets by analyzing the received print data, or extracts the total number of printed sheets from the received print data, to obtain the total number of printed sheets. However, the configuration can also be such that the application unit 440 of the user terminal 401 analyzes the print data to calculate or obtain the print data information (the total number of printed sheets), and the print data is sent to the image-forming apparatus 1 along with the total number of printed sheets in S104. Alternatively, the configuration can be such that the user terminal 401 sends only the total number of printed sheets in S104. In this case, if printing is determined to be permitted in S123, the print control unit 95 of the image-forming apparatus 1 sends an indication to that effect to the user terminal 401, and when printing is permitted, the user terminal 401 sends the print data to the image-forming apparatus 1.

Note that the configuration can also be such that in addition to the management server 301, each image-forming apparatus 1 manages the information of “Remaining number of sheets” for itself. In this case, when calculating the total number of printed sheets in S120, the image-forming apparatus 1 determines whether to permit printing in S123 without requesting the information of “Remaining number of sheets” from the management server 301. In other words, the processing of S121 and S122 is omitted. Then, when printing is executed, the image-forming apparatus 1 updates the value of “Remaining number of sheets” managed by the apparatus itself based on the actual number of printed sheets. The method for updating the value of “Remaining number of sheets” is the same as in S115. Note that even in this case, the processing of S114 and S115 can be executed to update the information of “Remaining number of sheets” managed by the management server 301. The information of “Remaining number of sheets” managed by the management server 301 can be used, for example, for a user to log in to the management server 301 by operating the user terminal 401 and confirm “Remaining number of sheets”. Note that the configuration can also be such that instead of updating the value of “Remaining number of sheets”, the image-forming apparatus 1 obtains the updated value of “Remaining number of sheets” from the management server 301 as a response to S114. Alternatively, the configuration can be such that instead of executing the processing of S114 and S115, the image-forming apparatus 1 notifies the management server 301 of the updated value of “Remaining number of sheets”.

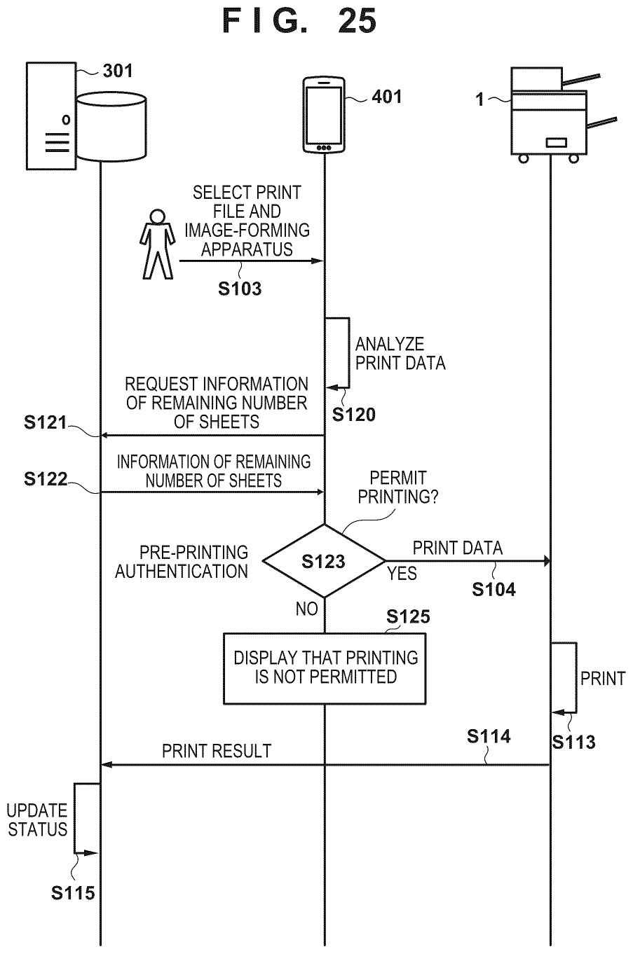

FIG. 25 is a sequence chart illustrating an overview of the printing processing when the user terminal 401 determines whether to permit printing. Note that in the sequence illustrated in FIG. 25, processing steps that are the same as those in FIG. 24 are given the same step numbers. The processing for establishing a communication session between the image-forming apparatus 1 and the management server 301 (S111 in FIG. 15) is also not shown. In S103, the user selects a file to be printed, and the image-forming apparatus 1 to use for the printing, in the print screen provided by the application unit 440. In S120, the application unit 440 of the user terminal 401 analyzes the selected file to calculate and obtain the total number of printed sheets as the print data information. Alternatively, the application unit 440 of the user terminal 401 can generate and obtain the total number of printed sheets as the print data information, from the selected file. In S121, the application unit 440 notifies the management server 301 of the apparatus ID of the image-forming apparatus 1 used for printing, and requests the information of “Remaining number of sheets” for the image-forming apparatus 1. In S122, in response to the request, the management server 301 obtains “Remaining number of sheets” for that image-forming apparatus 1 by referring to the management DB 313, and sends the information of “Remaining number of sheets” to the user terminal 401.

In S123, the application unit 440 determines whether to permit printing by comparing “Remaining number of sheets” from the notification made by the management server 301 in S122 with the total number of printed sheets calculated in S120. Specifically, printing is permitted if “Remaining number of sheets” is at least the total number of printed sheets, whereas printing is not permitted if “Remaining number of sheets” is less than the total number of printed sheets. If printing is not permitted, in S125, the application unit 440 displays an indication that printing is not permitted in the display device 415. On the other hand, if printing is permitted, in S104, the application unit 440 sends the print data to the image-forming apparatus 1 to be used for printing. The print control unit 95 of the image-forming apparatus 1 executes printing based on the received print data. Once the printing is completed, in S114, the image-forming apparatus 1 sends a print result, including the actual number of printed sheets, to at least the management server 301. In S115, the data management unit 350 of the management server 301 updates the value of “Remaining number of sheets” for the image-forming apparatus 1 in the management DB 313, as described with reference to FIG. 15.

Note that in the sequence illustrated in FIG. 25, only the processing of S114 involves communication between the image-forming apparatus 1 and the management server 301. Here, there may be a case where communication between the image-forming apparatus 1 and the management server 301 is not possible during the processing of S114. In such a case, the image-forming apparatus 1 can be configured to notify the user terminal 401, for example, that the print result could not be sent to the management server 301. The user terminal 401 displays an indication in the display device 415 indicating that, for example, the print result could not be sent to the management server 301 and the value of “Remaining number of sheets” managed by the management server 301 is therefore incorrect. Note that this processing can be applied in the same manner in the sequences illustrated in FIGS. 15 and 24.

Note that the configuration can also be such that in addition to the management server 301, the user terminal 401 manages the information of “Remaining number of sheets” for the image-forming apparatus 1. In this case, when calculating the total number of printed sheets in S120, the user terminal 401 determines whether to permit printing in S123 without requesting the information of “Remaining number of sheets” from the management server 301. In other words, the processing of S121 and S122 is omitted. In this case, when performing printing, the image-forming apparatus 1 can be configured to send the print result to the user terminal 401 in S114, in addition to the management server 301. The user terminal 401 updates the value of “Remaining number of sheets” for the image-forming apparatus 1 used for the printing based on the print result. The method for updating the value of “Remaining number of sheets” is the same as in S115. Note that the configuration can also be such that when printing is executed, the image-forming apparatus 1 sends the print result to the management server 301 only. In this case, the user terminal 401 notifies the management server 301 of the apparatus ID of the image-forming apparatus 1 that executed the printing at a predetermined timing thereafter, and obtains the updated value of “Remaining number of sheets” from the management server 301. Furthermore, the configuration can also be such that when printing is executed, the image-forming apparatus 1 sends the print result to the user terminal 401 only. In this case, the user terminal 401 notifies the management server 301 of the updated value of “Remaining number of sheets” along with the apparatus ID of the image-forming apparatus 1, and updates the management DB 313 in the management server 301.

Furthermore, in the sequence chart illustrated in FIG. 15, in S104, if the user terminal 401 sends the print data to the management server 301 and “Remaining number of sheets” is at least the total number of printed sheets, the management server 301 sends the print data to the image-forming apparatus 1 and issues a print command. However, the configuration can also be such that the user terminal 401 sends the print data to the image-forming apparatus 1, and the image-forming apparatus 1 sends the total number of printed sheets to the management server 301. In this case, if “Remaining number of sheets” is at least the total number of printed sheets, the management server 301 sends only a print command to the image-forming apparatus 1, whereas if “Remaining number of sheets” is less than the total number of printed sheets, the management server 301 sends a command to interrupt/abort the sequence illustrated in FIG. 15 to the image-forming apparatus 1. In addition, the image-forming apparatus 1 can send the print data to the management server 301. Furthermore, the configuration can also be such that the user terminal 401 sends the total number of printed sheets to the management server 301, and when the authentication succeeds, the print data is sent to the image-forming apparatus 1 and printed. This corresponds to sending the print command in to the user terminal 401, rather than to the image-forming apparatus 1, in S112 of FIG. 15.

In the sequence illustrated in FIG. 15, the printing instruction is issued after the user terminal 401 has performed the processing for logging into the app, but the configuration is not limited thereto. The printing instruction may be issued from a normal driver screen without using the app, or in other words, without performing the login processing. This eliminates the need to perform the login processing each time a printing instruction is issued, which improves the usability. In addition, the user terminal 401 used in the authentication processing for the refill pack 200 in FIG. 13 and the user terminal 401 used to issue the printing instruction in FIG. 15 may be different devices. The most typical configuration is one in which a smartphone is used for the authentication processing for the refill pack 200, and the printing instruction is issued from a PC installed in an office. Note that the combination of the user terminals 401 is not limited thereto.

As described above, in the present embodiment, the data management unit 350 manages “Remaining number of sheets” for sheets for which image formation is permitted for at least one image-forming apparatuses used in a subscription service, by a user who is subscribed to the subscription service. In addition, when the user refills a first image-forming apparatus among the at least one image-forming apparatus with the consumable material, the data management unit 350 obtains the first determination information for determining whether the refill pack 200 used for refill is an in-contract refill pack 200 or an out-of-contract refill pack 200. The first determination information corresponds to the code 201.

The data management unit 350 can obtain the first determination information from the first image-forming apparatus or the user apparatus used by the user. The user apparatus can correspond to the user terminal 401. The data management unit 350 also determines a refill amount for the consumable material with which the first image-forming apparatus is refilled. For example, the data management unit 350 can determine the refill amount based on the nominal value of the amount of the consumable material held in the holding device used for the refill. The nominal value is a value that is directly indicated by the capacity information in the code 201, or a value that can be obtained and determined by the data management unit 350 based on the capacity information. Note that like the first determination information, the data management unit 350 can obtain the capacity information from the first image-forming apparatus or the user apparatus used by the user. The data management unit 350 can also determine the refill amount based on an amount of change in the remaining amount of the consumable material between before and after the refill, notified by the first image-forming apparatus. The data management unit 350 does not change “Remaining number of sheets” when refilling using an in-contract refill pack 200. However, when refilling using an out-of-contract refill pack 200, the data management unit 350 increases “Remaining number of sheets” by the number of sheets corresponding to the refill amount.

Note that before first image forming performed by the image-forming apparatus 1, the data management unit 350 obtains second determination information for determining a first number of sheets that is a number of sheets on which an image is formed in the first image forming. The data management unit 350 can obtain the second determination information from the image-forming apparatus 1 or the user terminal 401. The second determination information is information directly indicating the first number of sheets, or is information that can specify the first number of sheets, e.g., image data used in the first image forming. The data management unit 350 does not permit the first image forming when the first number of sheets is greater than “Remaining number of sheets”, but permits the first image forming when the first number of sheets is not greater than “Remaining number of sheets”. When the first image forming is permitted, the data management unit 350 instructs and notifies the image-forming apparatus 1 of the execution of the first image forming. When the first image forming is performed, the data management unit 350 updates “Remaining number of sheets” so that “Remaining number of sheets” is less than the second number of sheets. The second number of sheets is equal to the first number of sheets, or is equal to the number of sheets, obtained from a second image-forming apparatus, on which an image has actually been formed in the first image forming.

In addition, as described above, when setting a plurality of image-forming apparatuses 1 as the subject of a contract, the number of sheets that can be printed, which can be used across the plurality of image-forming apparatuses 1, can be set. In such a case, if any one of the image-forming apparatuses 1 subject of the contract has been refilled using an out-of-contract refill pack 200, “Remaining number of sheets” set for the plurality of image-forming apparatuses 1 is updated. Specifically, the first image-forming apparatus and the second image-forming apparatus are set as the subject of the contract, and “Remaining number of sheets” that can be printed by the two apparatuses is set by the management server 301. Then, if the first image-forming apparatus or the second image-forming apparatus has been refilled using an out-of-contract refill pack 200, the management server 301 updates the information of “Remaining number of sheets” that can be printed by the two apparatuses based on that refill amount.

As described above, if the user uses an in-contract refill pack 200, “Remaining number of sheets” is not changed, and the number of sheets that can be printed under the subscription contract is therefore unaffected. However, if the user uses an out-of-contract refill pack 200, “Remaining number of sheets” is increased based on the refill amount of the out-of-contract refill pack 200. This enables the user to print a number of sheets corresponding to the refill amount of the out-of-contract refill pack 200, beyond the number of sheets that can be printed according to the subscription service. The above-described configuration makes it possible to use an out-of-contract refill pack 200 in the subscription contract, i.e., a refill pack 200 obtained by the user outside the subscription service.

### Second Embodiment

In the first embodiment, the value of “Remaining number of sheets” in the apparatus registration table 330 was increased when refilling using an out-of-contract refill pack 200. Here, it is assumed that, for example, the contract type does not permit “Remaining number of sheets” as of the end of the month to be carried over to the next month. In this case, the number of sheets printed using toner from the in-contract refill pack 200 within “Remaining number of sheets” cannot be carried over to the next month, but the number of sheets printed using toner from the out-of-contract refill pack 200 must be carried over to the next month. However, with the configuration of the first embodiment, the number of sheets using toner from the out-of-contract refill pack 200 within “Remaining number of sheets” cannot be determined. Accordingly, in the present embodiment, the remaining number of sheets is divided into “in-contract” and “out-of-contract” and managed as such. The following will describe the present embodiment with focus on the differences from the first embodiment.

FIGS. 16A to 16C illustrate a single record in the apparatus registration table 330 according to the present embodiment. As described above, “Remaining number of sheets” in the first embodiment is divided into “Remaining number of sheets within contract” and “Remaining number of sheets outside contract”. The sequence of the toner refilling processing according to the present embodiment is basically the same as the sequence according to the first embodiment, illustrated in FIG. 13. However, in the present embodiment, the details of the processing for updating the status in S84 are different from those in the first embodiment. In the present embodiment, if an out-of-contract refill pack 200 is determined to have been used for the refilling, in S84, the data management unit 350 increases the value of “Remaining number of sheets outside contract” in the apparatus registration table 330. Note that “Remaining number of sheets within contract” is not changed. On the other hand, if an in-contract refill pack 200 is determined to have been used for the refilling, in S84, the data management unit 350 does not change the values of “Remaining number of sheets within contract” and “Remaining number of sheets outside contract” in the apparatus registration table 330.

For example, assume that, as illustrated in FIG. 16A, “Owner” is U01, “Remaining amount of toner” in the image-forming apparatus 1 having “Apparatus ID” of E01 is 10%, “Remaining number of sheets within contract” in the image-forming apparatus 1 is 10 sheets, and “Remaining number of sheets outside contract” is 0 sheets. Assume also that in S83, a report is made to the management server 301 that the remaining amount of toner has changed to 60% from that state, as a result of refilling using an out-of-contract refill pack 200. In this case, based on the remaining amount of toner before and after the refill, the data management unit 350 determines that the amount of toner has increased by 50%. Assuming that 100 sheets can be printed with a toner amount of 1%, 5,000 sheets can be printed with a toner amount of 50%. Accordingly, the data management unit 350 sets “Remaining number of sheets outside contract” to 5000, assuming an increase of 5000, as illustrated in FIG. 16B.

The sequence of the printing processing according to the present embodiment is basically the same as the sequence according to the first embodiment, illustrated in FIG. 15. However, in the first embodiment, if in S109 “Remaining number of sheets” for the image-forming apparatus 1 is at least the total number of printed sheets calculated in S105, the user terminal 401 is notified of the authentication result indicating that the authentication is successful in S110, and a print command is sent to the image-forming apparatus 1 in S112. On the other hand, in the present embodiment, if in S109 the sum of “Remaining number of sheets within contract” and “Remaining number of sheets outside contract” is at least the total number of printed sheets, the user terminal 401 is notified of the authentication result indicating that the authentication is successful in S110, and a print command is sent to the image-forming apparatus 1 in S112. Note that if the sum of “Remaining number of sheets within contract” and “Remaining number of sheets outside contract” is less than the total number of printed sheets, the authentication unit 370 may make a notification to the user terminal 401 and suspend the sequence of FIG. 15, or may notify the user terminal 401 of a proposal to change the contract.

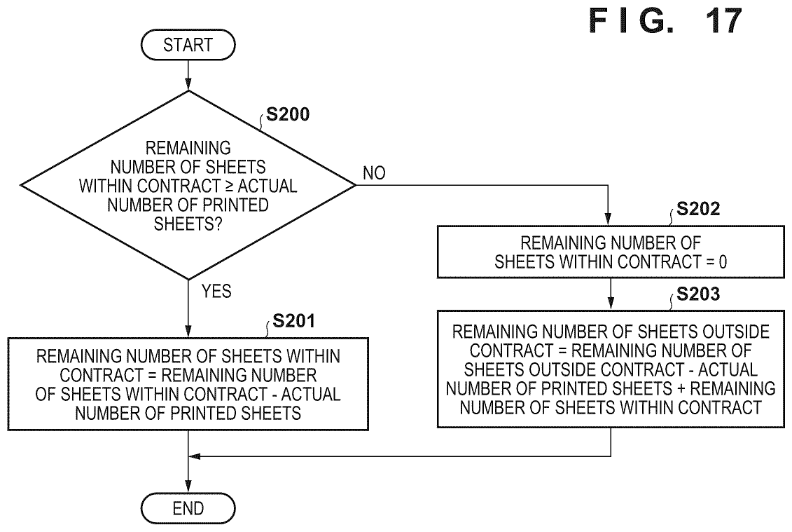

Additionally, in the first embodiment, the numerical value of “Remaining number of sheets” is subtracted from the actual number of printed sheets in S115. In the present embodiment, the processing of S115 is also different from that in the first embodiment. FIG. 17 is a flowchart illustrating processing executed by the data management unit 350 in S115 of FIG. 15 according to the present embodiment. In S200, the data management unit 350 determines whether “Remaining number of sheets within contract” is at least the actual number of printed sheets. If “Remaining number of sheets within contract” is at least the actual number of printed sheets, in S201, the data management unit 350 sets a value obtained by subtracting the actual number of printed sheets from “Remaining number of sheets within contract” as the updated “Remaining number of sheets within contract”. On the other hand, if “Remaining number of sheets within contract” is less than the actual number of printed sheets, in S202, the authentication unit 370 updates “Remaining number of sheets within contract” to 0. Then, in S203, the authentication unit 370 updates “Remaining number of sheets outside contract” by subtracting, from “Remaining number of sheets outside contract”, a value obtained by subtracting “Remaining number of sheets within contract” from the actual number of printed sheets.

For example, if 100 sheets are printed when the apparatus registration table 330 is in the state illustrated in FIG. 16B, “Remaining number of sheets within contract” becomes 0, and “Remaining number of sheets outside contract” becomes 4910, as illustrated in FIG. 16C.

As described above, in the present embodiment, the data management unit 350 divides “Remaining number of sheets” in the first embodiment into a “first remaining number of sheets” and a “second remaining number of sheets”, and manages those numbers as such. The “first remaining number of sheets” corresponds to “Remaining number of sheets within contract” and “second remaining number of sheets” corresponds to “Remaining number of sheets outside contract”. The data management unit 350 changes neither the “first remaining number of sheets” nor the “second remaining number of sheets” when refilling using an in-contract refill pack 200. However, when refilling using an out-of-contract refill pack 200, the data management unit 350 increases the “second remaining number of sheets” by the number of sheets corresponding to the refill amount. Note that the “first remaining number of sheets” is not changed.

Before first image forming by a second image-forming apparatus among at least one image-forming apparatus, the data management unit 350 determines a first number of sheets, which is a number of sheets on which an image is formed in the first image forming. The data management unit 350 permits the first image forming when the first number of sheets is not greater than the sum of the “first remaining number of sheets” and the “second remaining number of sheets”. When the first image forming is performed, the data management unit 350 determines a second number of sheets. The second number of sheets is equal to the first number of sheets, or is equal to the number of sheets, obtained from the second image-forming apparatus, on which an image has actually been formed in the first image forming. If the second number of sheets is not greater than the “first remaining number of sheets”, the data management unit 350 decrements the “first remaining number of sheets” by the second number of sheets. On the other hand, if the second number of sheets is greater than the “first remaining number of sheets”, the data management unit 350 reduces the “second remaining number of sheets” by the difference between the second number of sheets and the “first remaining number of sheets”, and sets the “first remaining number of sheets” to 0.

As described above, by dividing “Remaining number of sheets” into “Remaining number of sheets within contract” (the first remaining number of sheets) and “Remaining number of sheets outside contract” (the second remaining number of sheets), the user can use an out-of-contract refill pack 200 regardless of the contract type.

### Third Embodiment

Next, a third embodiment will be described, focusing on the differences from the second embodiment. For example, when refilling the toner, a case can arise in which the refill is performed from an out-of-contract refill pack 200 after performing the pre-refill authentication based on the code 201 of an in-contract refill pack 200, or vice versa. In the former case, “Remaining number of sheets outside contract” does not increase despite the user having purchased the refill pack 200 him/herself. In the latter case, “Remaining number of sheets outside contract” will increase despite the refill being a refill using an in-contract refill pack 200. The present embodiment provides a configuration for appropriately correcting “Remaining number of sheets outside contract” and “Remaining number of sheets within contract” even if the user makes such an erroneous operation.

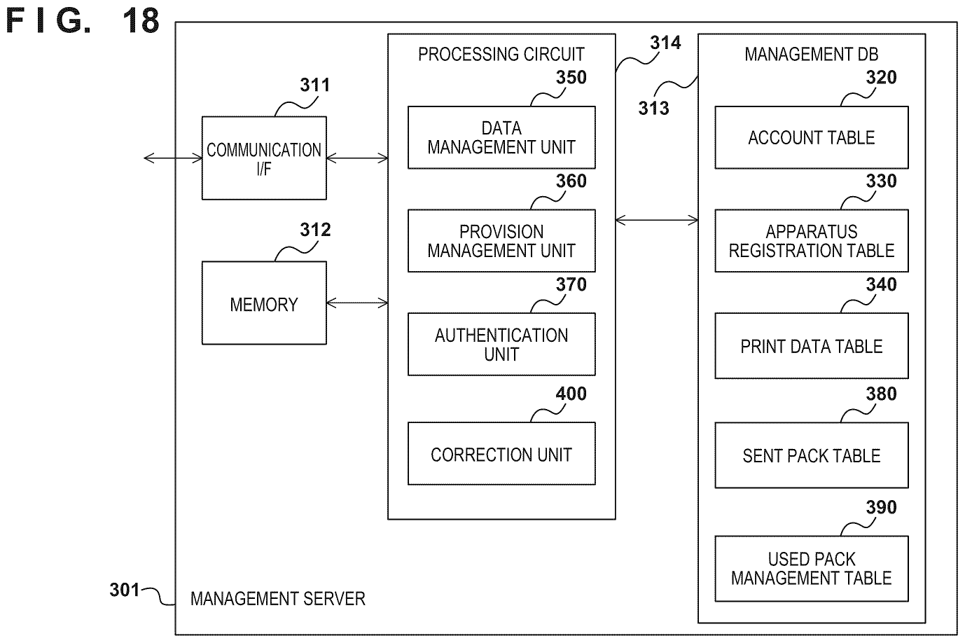

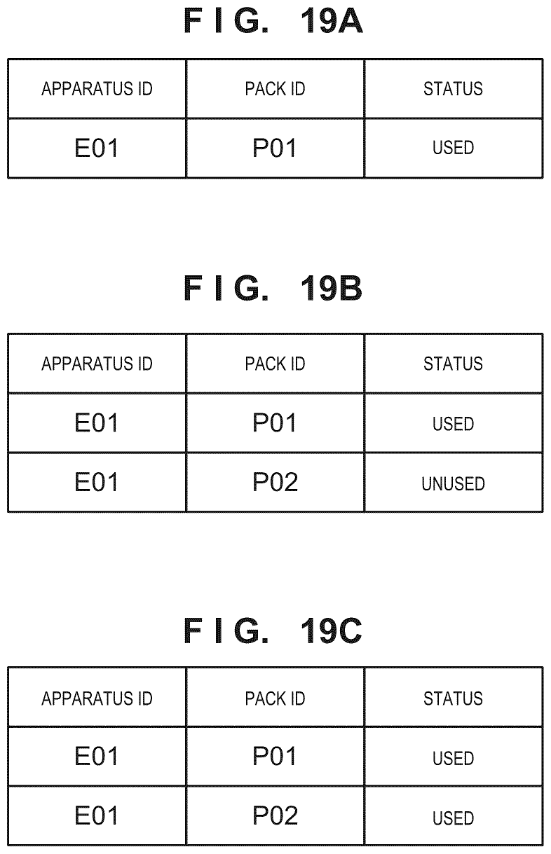

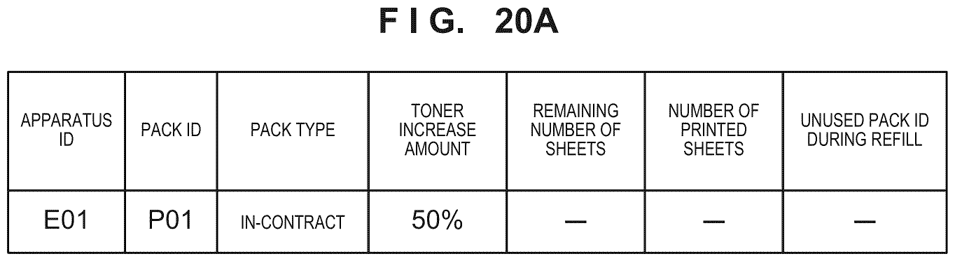

FIG. 18 is a diagram illustrating the overall configuration of the management server 301 according to the present embodiment. In the present embodiment, the management DB 313 includes a sent pack table 380 and a used pack management table 390, in addition to the configuration illustrated in FIG. 10.

The sent pack table 380 is a table that holds information pertaining to in-contract refill packs 200 that have been sent to each user. The sent pack table 380 includes the following information items.
“Apparatus ID”
“Pack ID”
“Status”

“Apparatus ID” indicates the image-forming apparatus 1 to which each refill pack 200 is to be provided as “Apparatus ID” registered in the apparatus registration table 330. Note that the present embodiment assumes that the refill pack 200 is used only in a specific image-forming apparatus 1. However, if the configuration is such that the refill pack 200 may be used in any of the plurality of image-forming apparatuses 1 belonging to the same user, other information registered in the account table 320, such as “User ID”, may be used instead.

“Pack ID” is identification information included in the code 201 for uniquely identifying each refill pack 200.

“Status” indicates a status related to whether each refill pack has been used to refill the image-forming apparatus 1 with toner. At the time the pack is sent, “Status” indicates “Unused”, and is changed to “Used” when the refill pack 200 indicated by “Pack ID” is used to refill the toner.

The used pack management table 390 is a table that holds a usage status of the refill packs 200 used in each image-forming apparatus 1. The used pack management table 390 can include at least one of the following information items, for example.
“Apparatus ID”
“Pack ID”
“Pack type”
“Toner increase amount”
“Remaining number of sheets”
“Number of printed sheets”
“Unused pack ID during refill”

“Apparatus ID” indicates the image-forming apparatus 1 for which the refill pack 200 was used as “Apparatus ID” registered in the apparatus registration table 330.

“Pack ID” is identification information included in the unique code 201 for uniquely identifying each refill pack 200.

“Pack type” indicates whether the refill pack 200 is an in-contract refill pack 200. Although “Pack type” is managed in the used pack management table 390 in the present embodiment, it should be noted that whether the pack is an in-contract refill pack 200 can also be determined based on whether “Pack ID” having the same value is present in the sent pack table 380.

“Toner increase amount” indicates the amount of increase in the remaining amount of toner when the toner is refilled using the refill pack 200.

“Remaining number of sheets” is set when “Pack type” indicates an out-of-contract refill pack 200, and indicates the remaining number of sheets that can be printed using that out-of-contract refill pack 200. If “Pack type” indicates an in-contract refill pack 200, “Remaining number of sheets” is set to a value indicating invalid.

“Number of printed sheets” is set when “Pack type” indicates an out-of-contract refill pack 200, and indicates the number of sheets printed using that out-of-contract refill pack 200. If “Pack type” indicates an in-contract refill pack 200, “Number of printed sheets” is set to a value indicating invalid.

“Unused pack ID during refill” is set when “Pack type” indicates an out-of-contract refill pack 200, and when refilling using that out-of-contract refill pack 200, indicates the pack ID of an unused in-contract refill pack 200 already received by the user.

The processing circuit 314 includes a correction unit 400 in addition to the data management unit 350, the provision management unit 360, and the authentication unit 370 illustrated in FIG. 10. The correction unit 400 has a function for correcting the management DB 313 through the data management unit 350 when it is determined that the refill has been made from a refill pack 200 different from the refill pack 200 for which the code 201 was obtained. The management DB 313 can be corrected by the correction unit 400 by, for example, the business directly manipulating the management server 301 in response to the user contacting the business. Alternatively, the correction can be made in response to the user making a request to the management server 301 using the user terminal 401, or accepting a user request from a web page or the like associated with the management server 301.

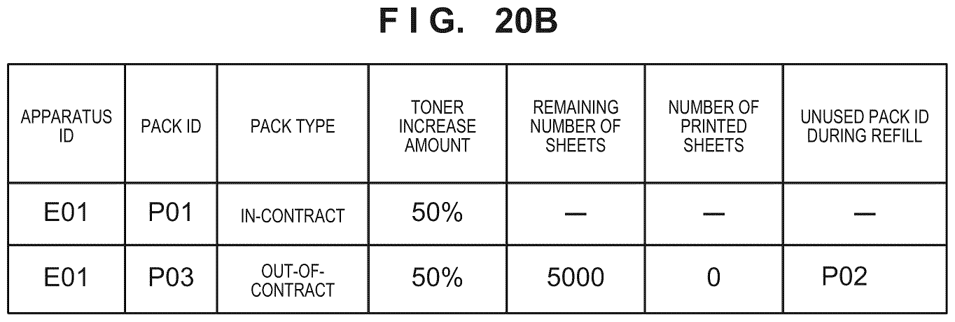

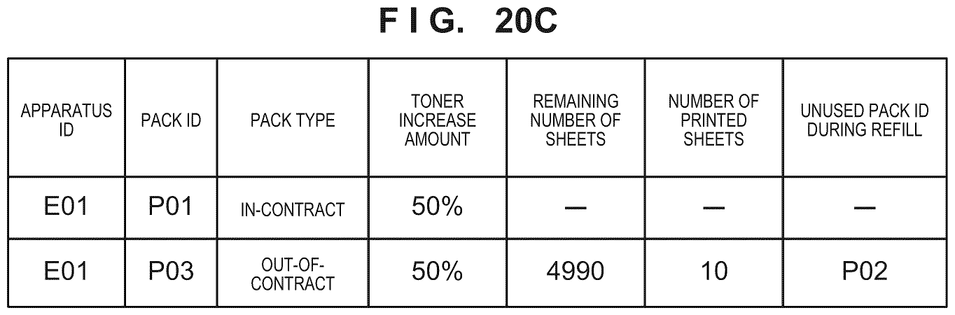

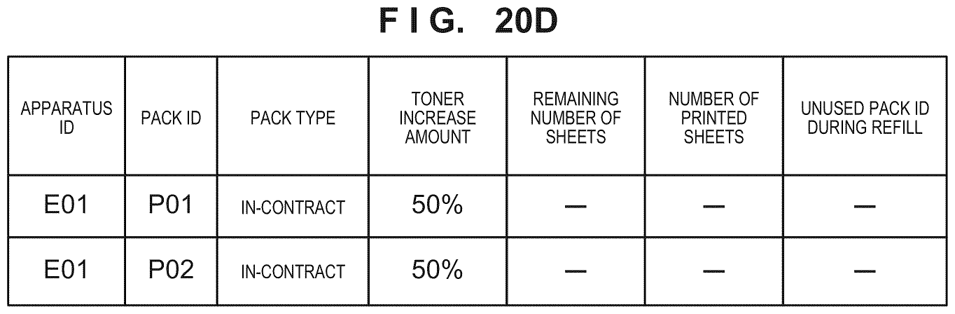

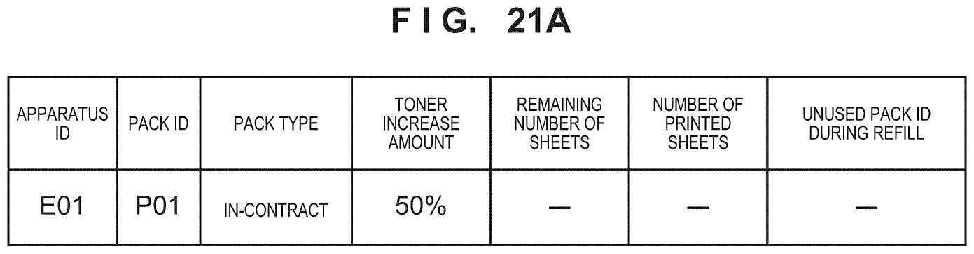

First, processing will be described for correcting a refill pack 200 which was used to an in-contract refill pack 200, when a refill was performed using an in-contract refill pack 200 after reading the code 201 of an out-of-contract refill pack 200. It is assumed that at the point of the start of these descriptions, the user holds an out-of-contract refill pack 200 having “Pack ID” of P03. FIG. 19A illustrates the sent pack table 380 at the point of the start of these descriptions, and FIG. 20A illustrates the used pack management table 390 at the point of the start of these descriptions. As illustrated in FIG. 19A, at the start point, the in-contract refill pack 200 having “Pack ID” of P01 is in a used state for the image-forming apparatus 1 having an Apparatus ID of E01. When the remaining amount of toner in the image-forming apparatus 1 decreases, the provision management unit 360 sends an in-contract refill pack 200. FIG. 19B illustrates a state in which an in-contract refill pack 200 having “Pack ID” of P02 has been sent and a record having “Pack ID” of P02 has been added.

Here, it is assumed that after reading the code 201 of the out-of-contract refill pack 200 having “Pack ID” of P03, the user has mistakenly refilled the toner using the in-contract refill pack 200 having “Pack ID” of P02. In this case, as illustrated in FIG. 20B, a record for the out-of-contract refill pack 200 having “Pack ID” of P03 is added to the used pack management table 390. Because “Pack type” is out-of-contract, the values of “Remaining number of sheets”, “Number of printed sheets”, and “Unused pack ID during refill” are also set. Note that the corresponding value is set for “Toner increase amount” regardless of “Pack type”. According to FIG. 20B, P02, which is “Pack ID” of the unused in-contract refill pack 200, is set for “Unused pack ID during refill”.

As described in the second embodiment, when “Remaining number of sheets within contract” in the apparatus registration table 330 reaches 0, the data management unit 350 reduces “Remaining number of sheets outside contract” for subsequent printing. Upon reducing “Remaining number of sheets outside contract” in the apparatus registration table 330, the data management unit 350 reduces “Remaining number of sheets” in the used pack management table 390, and increases “Number of printed sheets”, by that value. For example, if there are a plurality of records having an “Apparatus ID” of “E01” and “Remaining number of sheets” of “0” in the used pack management table 390, the record for which “Remaining number of sheets” is to be reduced and “Number of printed sheets” is to be increased may be determined as desired. For example, the configuration can be such that “Remaining number of sheets” and “Number of printed sheets” are updated from the record having the lowest “Remaining number of sheets”. FIG. 20C illustrates a state in which “Remaining number of sheets” in the used pack management table 390 has been reduced by 10, and “Number of printed sheets” has been increased by 10, from the state in FIG. 20B, by reducing “Remaining number of sheets outside contract” in the apparatus registration table 330 by 10.

In the state illustrated in FIGS. 19B and 20C, if the user notices an erroneous operation, the business corrects the information in the management DB 313 using the correction unit 400. Specifically, as illustrated in FIG. 19C, the status for “Pack ID” P02 in the sent pack table 380 is changed to “used”. Additionally, as illustrated in FIG. 20D, “Pack ID” in the used pack management table 390 is corrected from P03 to P02, and “Pack type” is changed to “in-contract”. Because “Pack type” is “in-contract”, “Remaining number of sheets”, “Number of printed sheets”, and “Unused pack ID during refill” are changed to invalid data.

As illustrated in FIG. 20C, “Number of printed sheets” at the time of the correction is 10, and thus the business can correct the error in the information by reducing the value of “Remaining number of sheets within contract” in the apparatus registration table 330 by the value indicated by “Number of printed sheets”. If the value of “Remaining number of sheets within contract” in the apparatus registration table 330 is less than the value of “Number of printed sheets”, a separate calculation can be performed.

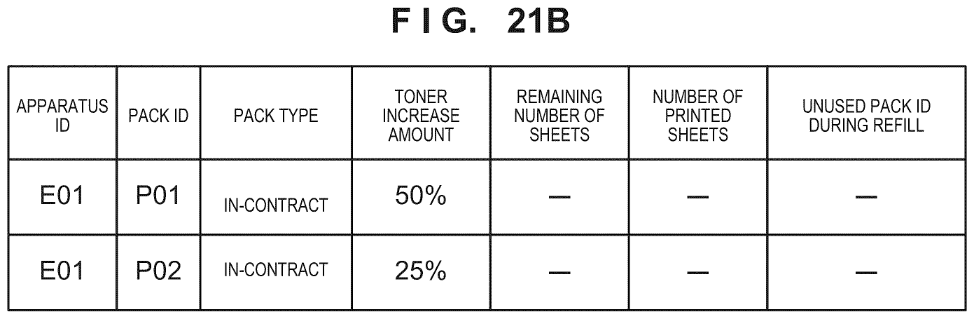

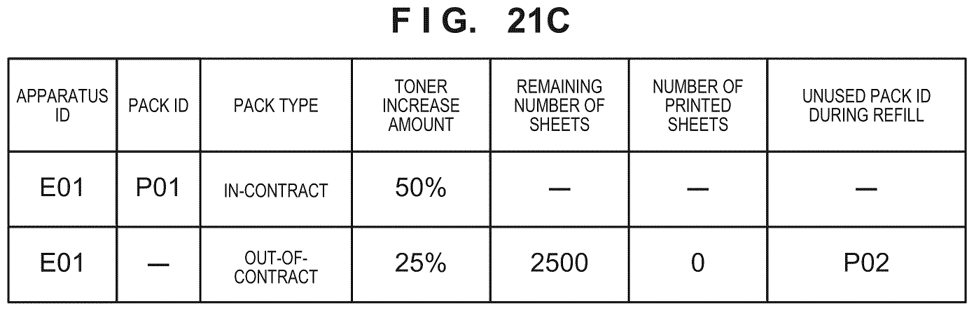

Next, processing will be described for correcting a refill pack 200 that has been used to an out-of-contract refill pack 200, when a refill was performed using an out-of-contract refill pack 200 after reading the code 201 of an in-contract refill pack 200. It is assumed that at the point of the start of these descriptions, the user has an out-of-contract refill pack 200 having a pack ID of P03 and an unused in-contract refill pack 200 having a pack ID of P02. In other words, the sent pack table 380 is as illustrated in FIG. 19B, and the used pack management table 390 is as illustrated in FIG. 21A.

It is assumed that after reading the code 201 of the in-contract refill pack 200 having “Pack ID” of P02, the user has mistakenly refilled the toner using the out-of-contract refill pack 200 having “Pack ID” of P03. In this case, as illustrated in FIG. 19C, the status for “Pack ID” P02 in the sent pack table 380 is changed to “used”. Additionally, as illustrated in FIG. 21B, a record for the in-contract refill pack 200 having “Pack ID” of P02 is added to the used pack management table 390. Because “Pack type” is “in-contract”, the corresponding value is set for “Toner increase amount”.

In the state illustrated in FIGS. 19C and 21B, if the user notices an erroneous operation, the business corrects the information in the management DB 313 using the correction unit 400. Specifically, as illustrated in FIG. 19B, “Status” for “Pack ID” P02 in the sent pack table 380 is changed to “unused”. Additionally, “Pack ID” in the used pack management table 390 is changed from P02 to P03, and “Pack type” is changed to “out-of-contract”. Note that the configuration can be such that if the user has already discarded the out-of-contract refill pack 200 having “Pack ID” of P03 and is unable to obtain the value of that code 201, a value indicating that “Pack ID” is unknown is set, as illustrated in FIG. 21C. Additionally, a value corresponding to “Toner increase amount” is set for “Remaining number of sheets”, and P02, which is “Pack ID” of the in-contract refill pack 200 changed to “unused”, is set for “Unused pack ID during refill”. Furthermore, “Number of printed sheets” is set to 0, assuming that printing was performed using in-contract toner until the erroneous operation was noticed.

Note that the configuration can also be such that only one of the functions for correcting the usage history of the refill pack 200 from out-of-contract to in-contract, and the function for correcting the usage history from in-contract to out-of-contract, is implemented. In addition, after correcting from in-contract to out-of-contract, to avoid the risk of correcting the usage history back to in-contract, a restriction such as prohibiting the correction by the correction unit 400 can also be set if there is an unused in-contract refill pack 200. Furthermore, in the present embodiment, the overall “Remaining number of sheets outside contract” using out-of-contract refill packs 200 is managed using the apparatus registration table 330, and “Remaining number of sheets” of individual out-of-contract refill packs 200 is managed using the used pack management table 390. However, the overall “Remaining number of sheets outside contract” using out-of-contract refill packs 200 can be calculated from “Remaining number of sheets” of the individual out-of-contract refill packs 200. Accordingly, the configuration can be such that the management of “Remaining number of sheets outside contract” in the apparatus registration table 330 is omitted. Alternatively, the configuration can be such that the number of sheets corresponding to the toner increase amount in the used pack management table 390 is equal to the sum of “Remaining number of sheets” and “Number of printed sheets”, and thus only one of “Remaining number of sheets” and “Number of printed sheets” is managed.

Furthermore, in the present embodiment, when printing is performed, “Remaining number of sheets within contract” is first reduced, and when “Remaining number of sheets within contract” is 0, “Remaining number of sheets outside contract” is reduced, as described in the second embodiment. However, the configuration can be such that when forming an image, the user specifies the number of “in-contract” sheets and the number of “out-of-contract” sheets. In this case, the data management unit 350 reduces “Remaining number of sheets within contract” and “Remaining number of sheets outside contract”, respectively, by the number of sheets specified by the user. Note that this configuration can also be applied to the second embodiment.

As described above, the data management unit 350 manages whether each of the in-contract refill packs 200 has been used to refill the consumable material. Additionally, when refilling the image-forming apparatus 1 with the consumable material from the refill pack 200, the data management unit 350 records whether the refill pack 200 is an out-of-contract refill pack 200 and the refill amount for the consumable material in association with the identifier of the refill pack 200 used for refilling. Furthermore, when an out-of-contract refill pack 200 is used for refilling, the data management unit 350 records an identifier of the in-contract refill pack 200 that is still unused at that point in time, and a number of sheets corresponding to the refill amount, in association with the identifier of the holding device used for refilling. Then, when reducing “Remaining number of sheets outside contract”, the value for the reduction is associated with the identifier of the holding device and recorded as “Number of printed sheets”.

According to the configuration described above, the database can be appropriately corrected even when the user has performed an erroneous operation.

### Fourth Embodiment

In the first to third embodiments, when refilling using an out-of-contract refill pack 200, “Remaining number of sheets” or “Remaining number of sheets outside contract” was increased. In the present embodiment, in order to simplify the data managed by the management DB 313, when a refill is performed using an out-of-contract refill pack 200, the contract is temporarily suspended. The present embodiment will be described hereinafter, focusing on the differences from the first embodiment.

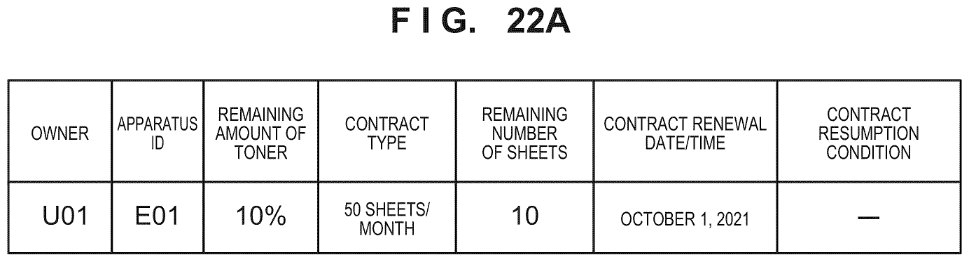

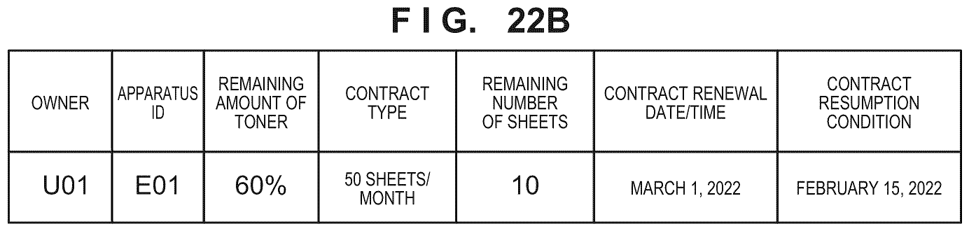

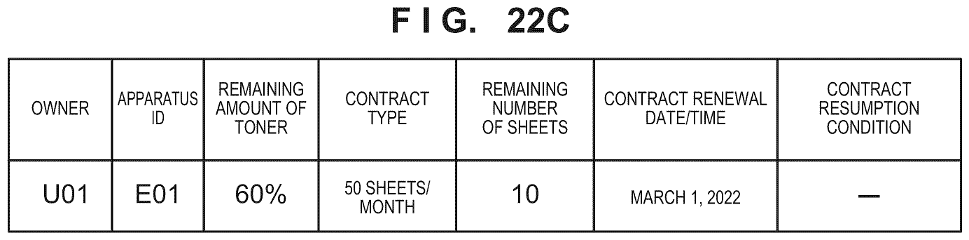

FIGS. 22A to 22C illustrate the apparatus registration table 330 according to the present embodiment. The apparatus registration table 330 of the present embodiment includes, in addition to the information items described in the first embodiment, “Contract renewal date/time” and “Contract resumption condition”.

“Contract renewal date/time” indicates the next update date of “Remaining number of sheets” for the image-forming apparatus 1 corresponding to that record. When “Contract renewal date/time” is reached, the data management unit 350 updates the value of “Remaining number of sheets” based on the contract details indicated by “Contract type” in the apparatus registration table 330, and sets the next update timing for “Contract renewal date/time”.

A condition for resuming the contract is set in “Contract resumption condition” when the contract with the business is temporarily suspended.

The sequence of the toner refilling processing according to the present embodiment is basically the same as the sequence according to the first embodiment, illustrated in FIG. 13. However, in the present embodiment, the processing in S84 is different when refilling using an out-of-contract refill pack 200. Specifically, when refilling using an out-of-contract refill pack 200, the data management unit 350 does not update “Remaining number of sheets” in the apparatus registration table 330. Instead, the data management unit 350 sets a condition for resuming the contract in “Contract resumption condition”. For example, the data management unit 350 obtains a period of time according to a predetermined standard based on the amount of toner increased by the refill. Then, a date/time after the current point by a time equivalent to the obtained period is set in “Contract resumption condition”. In addition, “Contract renewal date/time” is also updated to be extended by that period. This corresponds to assuming that the printing is being performed using out-of-contract toner during a period corresponding to the toner amount increased by the refill. It is assumed that the user is not charged based on the subscription service during this period.

This processing will be described in detail with reference to a single record in the apparatus registration table 330 illustrated in FIG. 22A. According to FIG. 22A, “Contract type” is a type through which 50 sheets can be printed per month, “Remaining amount of toner” is 10%, and “Contract renewal date/time” is Oct. 1, 2021. Here, assume that a refill was performed using an out-of-contract refill pack 200 on Sep. 15, 2021, and “Remaining amount of toner” increased by 50%. Assuming that the period corresponding to 50% of the toner amount is six months, the data management unit 350 sets Feb. 15, 2022, which is six months later, for “Contract resumption condition”, as illustrated in FIG. 22B. In addition, the data management unit 350 extends “Contract renewal date/time” by six months, to Mar. 1, 2022. Thereafter, when the contract resumption date, i.e., Feb. 15, 2022, is reached, the data management unit 350 deletes the value set for “Contract resumption condition”, and sets that item to “unset”.

The data management unit 350 can also set the remaining amount of toner before the refill for “Contract resumption condition”. The meaning of “Contract resumption condition” in this case is that the contract is resumed when “Remaining amount of toner” reaches the value set for “Contract resumption condition”. In this case, the current date/time is also set to “Contract resumption condition”. Then, when the contract is resumed, “Contract renewal date/time” is extended by the difference between the date/time set in “Contract resumption condition” and the date/time at which the contract is resumed.

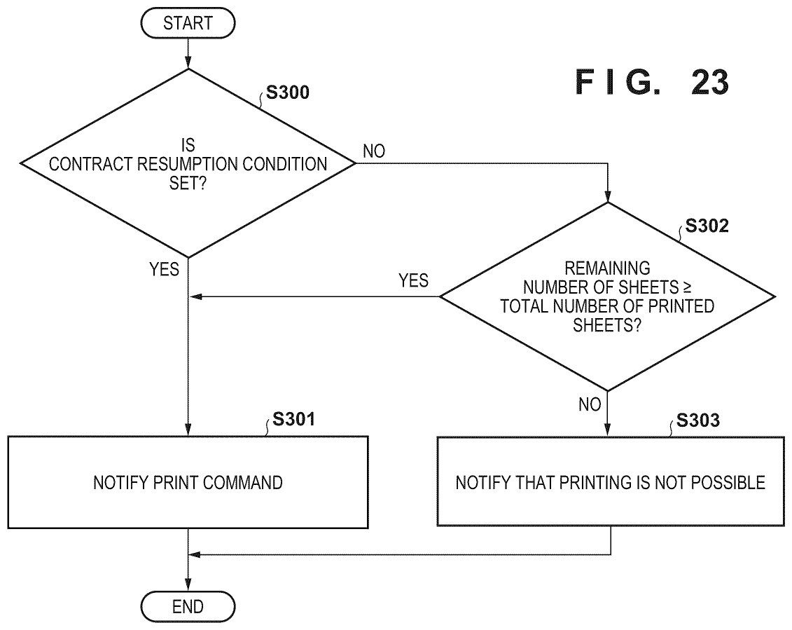

The sequence of the printing processing according to the present embodiment is basically the same as the sequence according to the first embodiment illustrated in FIG. 15, but the processing in S109 and S115 in FIG. 15 is different from that of the first embodiment. FIG. 23 is a flowchart illustrating processing executed by the management server 301 in S109 of FIG. 15 according to the present embodiment. In S300, the data management unit 350 determines whether “Contract resumption condition” is set. If “Contract resumption condition” is set, because the printing is performed out-of-contract, in S301, the data management unit 350 communicates the print command to the image-forming apparatus 1. On the other hand, if “Contract resumption condition” is not set in S300, in S302, the data management unit 350 determines whether “Remaining number of sheets” is at least the total number of printed sheets. If “Remaining number of sheets” is at least the total number of printed sheets, in S301, the data management unit 350 communicates the print command to the image-forming apparatus 1. However, if “Remaining number of sheets” is less than the total number of printed sheets, in S303, the authentication unit 370 notifies the user terminal 401 that printing is not possible (that the authentication has failed). At this time, the user terminal 401 can also be notified of a proposal to change the contract.

In the present embodiment, if “Contract resumption condition” is set, the data management unit 350 does not update “Remaining number of sheets” in S115 of FIG. 15 after the printing. On the other hand, if “Contract resumption condition” is not set, the data management unit 350 updates “Remaining number of sheets” in S115 of FIG. 15, in the same manner as in the first embodiment.

As described above, in the present embodiment, if an out-of-contract refill pack 200 is used to refill a first image-forming apparatus among at least one image-forming apparatus with the consumable material, the data management unit 350 sets a first condition and does not update “Remaining number of sheets” even after printing until the first condition is satisfied. Note that the first condition corresponds to “Contract resumption condition”. For example, the first condition can be a condition that is satisfied when a predetermined timing is reached, as illustrated in FIG. 22B. Note that in FIG. 22B, the predetermined timing is Feb. 15, 2022. In this case, the data management unit 350 can set the predetermined timing based on the refill amount of the out-of-contract refill pack 200. Furthermore, the first condition can be a condition that is satisfied when the remaining amount of toner in the first image-forming apparatus reaches a predetermined amount. The predetermined amount can be the remaining amount of toner before the refill when refilling using an out-of-contract refill pack 200.

As described above, in the present embodiment, when refilling using an out-of-contract refill pack 200, the contract is temporarily suspended and printing is performed out-of-contract until the contract is resumed. This configuration makes it possible for the user to use an out-of-contract refill pack 200 while simplifying the data to be managed.

Although the present embodiment describes an example in which the contract is temporarily suspended, the configuration is not limited thereto. If refilling is performed using an out-of-contract refill pack 200, the updating of “Remaining number of sheets” may be stopped for a given period of time while continuing the contract. At this time, the first condition for starting the update of “Remaining number of sheets” may include refilling using an in-contract refill pack 200 in addition to the conditions described above. In other words, when refilling using an out-of-contract refill pack 200, the updating of “Remaining number of sheets” may be temporarily suspended, and when refilling using an in-contract refill pack 200, the updating of “Remaining number of sheets” may be started again. Here, because the contract continues, it is assumed that the in-contract refill pack 200 will be automatically sent to the user when the remaining amount of toner decreases.

Note that charging the user a fee based on the subscription service may be stopped during the period when the updating of “Remaining number of sheets” is stopped. Alternatively, a fee structure that charges the user a lower price than usual may be used. For example, if the contract is structured such that the user can use a maintenance service for the printer provided by the business even during the period when the updating of “Remaining number of sheets” is stopped, it will be advantageous for the user to continue the contract at a lower price.

### Other Embodiments

The present invention can also be realized as a process executed by supplying a program implementing one or more functions of the above-described embodiments to a system or apparatus over a network or by a storage medium and then causing one or more processors of a computer of the system or apparatus to read out and execute the program. The present invention can also be implemented by a circuit (for example, an ASIC) for implementing one or more functions.

### Fifth Embodiment

Incidentally, there is a business model called a “subscription”, in which consumable materials are delivered to users according to predetermined contract details. This eliminates or reduces disadvantages for the user, such as failures, malfunctions, or drops in image quality of the image-forming apparatus caused by using a consumable material or a holding device that is not genuine, or the consumable material being depleted at an unexpected timing. On the other hand, the user may hold a plurality of consumable materials in an unused state. Consuming an older consumable material in an unused state in preference to a newer consumable material in an unused state has many advantages, for both the user and from the standpoint of the environmental impact. However, the user may have forgotten the existence of a consumable material delivered earlier, and may have used a consumable material which had been delivered later first. Accordingly, an object of the present invention is to encourage a user to consume a consumable material delivered earlier in preference to a consumable material delivered later.

Specifically, for example, in the present embodiment, the data management unit 350 may perform a simple verification for the apparatus information registered in the apparatus registration table 330, as to whether the apparatus is actually installed in the user environment of the corresponding user. For example, when the user logs in to the system and inputs the apparatus information of the image-forming apparatus 1 into the input screen, the data management unit 350 presents a message to the user prompting a predetermined operation to be performed in the image-forming apparatus 1. The predetermined operation may be, for example, pressing a specific physical button of the image-forming apparatus 1 or touching a button on a Graphical User Interface (GUI). Additionally, when the power of the image-forming apparatus 1 is off, the data management unit 350 may also notify the user that the image-forming apparatus 1 is to be powered on. When the user performs the prompted operation in the image-forming apparatus 1, the image-forming apparatus 1 sends the apparatus ID that identifies that apparatus itself to the management server 301. The data management unit 350 stands by to receive the apparatus ID from the image-forming apparatus 1 until a predetermined period of time has passed following the presentation of the aforementioned message. Then, if the same apparatus ID as the apparatus ID input by the user has been received from the image-forming apparatus 1 prior to a timeout, the data management unit 350 determines that the image-forming apparatus 1 identified by that apparatus ID is actually installed in the user environment. The data management unit 350 sets the value of “Status” in the apparatus registration table 330 to “Unverified” for the apparatus before this verification is complete, and sets the value of “Status” in the apparatus registration table 330 to “Verified” for the apparatus after this verification is complete.

In the present embodiment, the data management unit 350 also manages the updating of the value of “Remaining amount of toner” in the apparatus registration table 330. For example, the data management unit 350 receives, from a registered image-forming apparatus 1, remaining amount information pertaining to the remaining amount of the consumable material in the preserving container 48 of the apparatus, through the communication I/F 311. The data management unit 350 then updates status information pertaining to the remaining amount of the consumable material, i.e., the value of “Remaining amount of toner” in the apparatus registration table 330, based on the received remaining amount information.

The provision management unit 360 manages the provision of the refill pack 200 to the user of the printing management system 300. For example, the provision management unit 360 monitors the occurrence of trigger events that trigger the provision of the refill pack 200 to the user.

An example of a trigger event may be the user purchasing the refill pack 200. The provision management unit 360 may start providing the refill pack 200 to the user who is the purchaser when, for example, an order for the refill pack 200 is accepted through a website which sells consumable materials for image formation (i.e., when an individual contract is established).

Another example of a trigger event is the arrival of a provision timing based on a contract with the user. For example, a user may have a periodic purchase agreement with a business to periodically (e.g., once a month or once every several months) purchase a certain number of refill packs 200. This is called a subscription. The provision management unit 360 may start providing the refill pack 200 to such a user when it is determined that the next provision timing for the refill pack 200 has arrived for that user.

Another example of a trigger event may be a decrease in the remaining amount of toner in the image-forming apparatus 1 registered in the apparatus registration table 330 being detected. For example, a user may have an automatic purchase agreement with a business operator in which the user is automatically provided with a new refill pack 200 when the remaining amount of toner in the image-forming apparatus 1 owned by the user decreases. In this case, the provision management unit 360 monitors the value of “Remaining amount of toner” in the apparatus registration table 330 for the registered image-forming apparatus 1 owned or held by the user. The provision management unit 360 may start providing the refill pack 200 to the user when it is determined that the remaining amount of toner is below a predetermined threshold. In addition to or instead of this, the trigger event pertaining to the automatic purchase of the refill pack 200 may be a number of times the registered image-forming apparatus 1 has operated (e.g., the number of jobs executed, or the total number of sheets of the recording medium that have been consumed) reaching a threshold. In addition to or instead of this, the trigger event pertaining to the automatic purchase of the refill pack 200 may be the usage of a refill pack 200 provided to the user in the past being detected. For example, the provision management unit 360 monitors “Status” in the delivered pack table 340 for a refill pack 200 already provided to a user who has entered into an automatic purchase agreement. The provision management unit 360 may start providing the refill pack 200 when the value changes from “unused” to “used”.

The delivered pack table 340 is a table that holds information pertaining to the refill packs that have been sent to the respective users. The delivered pack table 340 can include at least one of the following information items, for example:
“Subscriber”
“Pack ID”
“Shipping date”
“Status”
“Usage date”

“Subscriber” indicates “User ID” of the user to whom each refill pack is provided. “User ID” matches “User ID” registered in the account table 320. “Pack ID” is identification information for uniquely identifying each refill pack. A pair constituted by “Subscriber” and “Pack ID” indicates an association between each user account and at least one refill pack provided to the user who owns that account. Because each user repeatedly consumes toner, the number of refill packs associated with one user account in the delivered pack table 340 increases over time. “Shipping date” indicates the date on which each refill pack was shipped to “Subscriber”. “Status” indicates a status related to whether each refill pack has been used to refill the image-forming apparatus with toner. At the time of shipment, “Status” indicates “Unused”, and when each refill pack arrives in the user environment, is authenticated, and the toner is refilled, “Status” can be changed to “Used”. “Usage date” indicates the date on which each refill pack was used to refill the toner.

Providing the user with a new refill pack 200 periodically or automatically in response to such a trigger event being detected makes it possible to reduce the likelihood of the image-forming apparatus 1 becoming unusable when the consumable material is depleted at an unexpected timing for the user.

The provision management unit 360 may determine which events, among the trigger events described above, to monitor for each user based on the content of “Contract type” in the account table 320. When a trigger event is determined to have occurred for a user, the provision management unit 360 assigns a new refill pack 200 to that user and sends a message to a delivery person instructing the assigned refill pack 200 to be delivered. In addition, the provision management unit 360 adds a new record to the delivered pack table 340 indicating the user ID of the user to whom the pack is to be delivered and the pack ID identifying the assigned refill pack 200, and registers the association between the user account and the refill pack 200 in the management DB 313. “Shipping date” in the delivered pack table 340 can be set to the day on which the refill pack 200 is sent. “Status” and “Usage date” can be set to “Unused” and blank, respectively, as default values.

In addition to user authentication executed when the user logs in to the system (e.g., password authentication), the authentication unit 370 performs authentication for permitting refilling for the refill pack 200 from which the user is attempting to refill the toner (called “pre-refill authentication” hereinafter). The pre-refill authentication includes a determination as to whether the refill pack 200 can be permitted to be used (e.g., whether the refill pack 200 has been provided to the user through a legitimate route). In the present embodiment, as described with reference to FIG. 9, each refill pack 200 is provided with a unique code 201 for uniquely identifying that refill pack 200. The code 201 is printed on, for example, each refill pack 200 or on the package thereof, in a format that can be read by the user or by the user terminal 401. The authentication unit 370 receives the code of the refill pack 200 that is to be used from code obtaining processor provided in the user environment E1, and performs the pre-refill authentication based on the received code. Several examples of how the code of the refill pack 200 is obtained in the user environment E1 will be given below.

As an example, the code 201 may be equivalent to the pack ID of each refill pack 200. In this case, the authentication unit 370 can use the received code as-is for the pre-refill authentication. As another example, the code 201 may be generated by encoding the pack ID of each refill pack 200. In this case, the authentication unit 370 can use the pack ID, derived by decoding the code 201, for the pre-refill authentication.

The pre-refill authentication includes a determination as to whether there is a refill pack 200 which is associated with the user account aside from the refill pack 200 identified based on the code 201 and for which “Status” is “Unused”. For example, the authentication unit 370 refers to the delivered pack table 340 to obtain “Status” of the refill pack 200 associated with the user ID of the logged-in user. The authentication unit 370 counts the number of “Status” (the number of refill packs 200) that are “Unused” among “Status” obtained. If the number of refill packs 200 for which “Status” is “Unused” is at least a predetermined value, the authentication unit 370 can determine that the user has not recognized the refill pack. This determination is not limited to the number of unused refill packs 200. For example, an unused period of the unused refill pack 200 may be used as the determination standard. The authentication unit 370 can determine that the user has not recognized the refill pack if the unused period is at least a predetermined value. Confirming the unused refill pack 200 in this manner makes it possible to encourage the user to use the unused refill pack 200 and prevent situations where the user neglects to use a refill pack 200, for example.

In addition to or instead of this, the pre-refill authentication may include a determination as to whether the refill pack 200 identified based on the code 201 is managed in correspondence with the user account of the logged-in user. For example, the authentication unit 370 checks whether an association between the Pack ID based on the code 201 and the user ID of the logged-in user is registered in the delivered pack table 340. If this association is registered in the delivered pack table 340, the authentication unit 370 can determine that the refill pack 200 to be used for the refill is being managed in correspondence with the user account of the user attempting to perform the refill. Verifying the correspondence between the refill pack 200 and the user account in this manner makes it possible to prevent a refill pack 200 obtained without a contract from being used to refill the consumable material.

In addition to or instead of this, the pre-refill authentication may include a determination as to whether the image-forming apparatus 1 to be refilled with the consumable material is being managed in correspondence with the user account of the logged-in user. For example, the authentication unit 370 presents a message to the user who attempts to perform the refill, prompting the user to perform a predetermined operation in the image-forming apparatus 1 which is to be refilled. Here, too, the predetermined operation may be, for example, pressing a specific physical button of the image-forming apparatus 1 or touching a button on a GUI. When the user performs the prompted operation in the image-forming apparatus 1, the image-forming apparatus 1 sends the apparatus ID that identifies that apparatus itself to the management server 301. The authentication unit 370 stands by to receive the apparatus ID from the image-forming apparatus 1 until a predetermined period of time has passed following the presentation of the aforementioned message. Then, the authentication unit 370 checks whether an association between the apparatus ID received from the image-forming apparatus 1 prior to a timeout and the user ID of the logged-in user is registered in the apparatus registration table 330. If such an association is registered in the apparatus registration table 330, the authentication unit 370 can determine that the image-forming apparatus 1 which is to be refilled is being managed in correspondence with the user account of the logged-in user. Taking the apparatus to be refilled having been registered as the user's apparatus as a condition for the authentication succeeding in this manner makes it possible to facilitate the registration of the apparatus information in the database. In addition, by receiving the apparatus ID from the image-forming apparatus 1, the management server 301 can reliably recognize the apparatus for which the user is attempting to refill the toner, and can send control commands (e.g., an unlock command or an open command, which will be described later) to the apparatus to be refilled.

The authentication unit 370 may receive the remaining amount information indicating the latest remaining amount of toner along with the apparatus ID from the image-forming apparatus 1 in response to the aforementioned predetermined operation. Then, the authentication unit 370 may reject the refilling of toner in the image-forming apparatus 1 if the received remaining amount information indicates that a sufficient amount of toner remains. This makes it possible to prevent the image-forming apparatus 1 from being refilled with excessive toner.

In addition to or instead of this, the pre-refill authentication may include a determination as to whether the refill pack 200 identified based on the code 201 has already been used based on the value of “Status” in the delivered pack table 340. For example, the authentication unit 370 can refer to the record of the Pack ID based on the code 201 in the delivered pack table 340 and permit the refill pack 200 to be used for the refill if the value of “Status” is “Unused”. On the other hand, the authentication unit 370 can reject the use of the refill pack 200 for the refill if the value of “Status” in the referenced record is “Used”.

In addition to or instead of this, the pre-refill authentication may include a determination as to whether the refill pack 200 identified based on the code 201 is a genuine product compatible with the apparatus to be refilled. To determine whether a product is genuine, the apparatus registration table 330 may include a model number for each image-forming apparatus as an additional data item. The delivered pack table 340 may include a model number for each refill pack as an additional data item. Additionally, the management DB 313 may include an additional table indicating model numbers of one or more refill packs that match for each image-forming apparatus model number. In this case, the authentication unit 370 may permit the refill pack 200 to be used for refilling only when the respective model numbers of the apparatus to be refilled and the refill pack 200 are determined to be compatible with each other.

As described above, at least one of the refill pack 200 and the image-forming apparatus 1 includes the opening and closing mechanism capable of opening and closing the consumable material refill path. The opening and closing mechanism is normally locked by the locking mechanism so as not to open. When the above-described pre-refill authentication is successful, the authentication unit 370 sends a result indicating the authentication is successful to the image-forming apparatus 1 through the communication I/F 311, and causes the image-forming apparatus 1 to enable the refill path to be opened by the opening and closing mechanism (i.e., causes the locking mechanism to unlock the opening and closing mechanism). Note if the opening and closing mechanism is activated by computer control rather than relying on user operations in the image-forming apparatus 1, the authentication unit 370 may cause the opening and closing mechanism of the image-forming apparatus 1 to open the consumable material refill path, instead of unlocking the opening and closing mechanism. The unlock command (or the open command) to the image-forming apparatus 1 may be sent directly from the management server 301 to the image-forming apparatus 1. Alternatively, the user terminal 401 that has received the result indicating the authentication is successful from the management server 301 may send the unlock command (or the open command) to the image-forming apparatus 1. When the pre-refill authentication fails due to any of the above-described conditions not being met, the authentication unit 370 sends a result indicating the authentication has failed to the image-forming apparatus 1 or the user terminal 401 through the communication I/F 311. The authentication unit 370 may cause a message indicating the cause of the authentication failing (e.g., an illegitimate pack, an unregistered apparatus, or pack has been used) to be displayed in the screen of any of the apparatuses.

When the opening and closing mechanism is unlocked based on the authentication result, the refill path is opened, and the image-forming apparatus 1 is refilled with toner from the refill pack 200, the remaining amount of toner in the preserving container 48 of the image-forming apparatus 1 increases. As will be described later, the image-forming apparatus 1 detects the remaining amount of toner in the preserving container 48 and sends the remaining amount information to the management server 301. The data management unit 350 receives this remaining amount information through the communication I/F 311 and updates the value of “Remaining amount of toner” in the apparatus registration table 330. In addition, if the received remaining amount information indicates that the remaining amount of toner has increased, the data management unit 350 changes “Status” for the refill pack 200 in the delivered pack table 340 to “Used”. Accordingly, if an attempt is made to reuse the same refill pack 200 thereafter, the authentication unit 370 may not permit the refill pack 200 to be reused based on the status information. In addition, the provision management unit 360 can assign a new refill pack 200 to the user in response to the provision management unit 360 detecting the use of the refill pack 200.

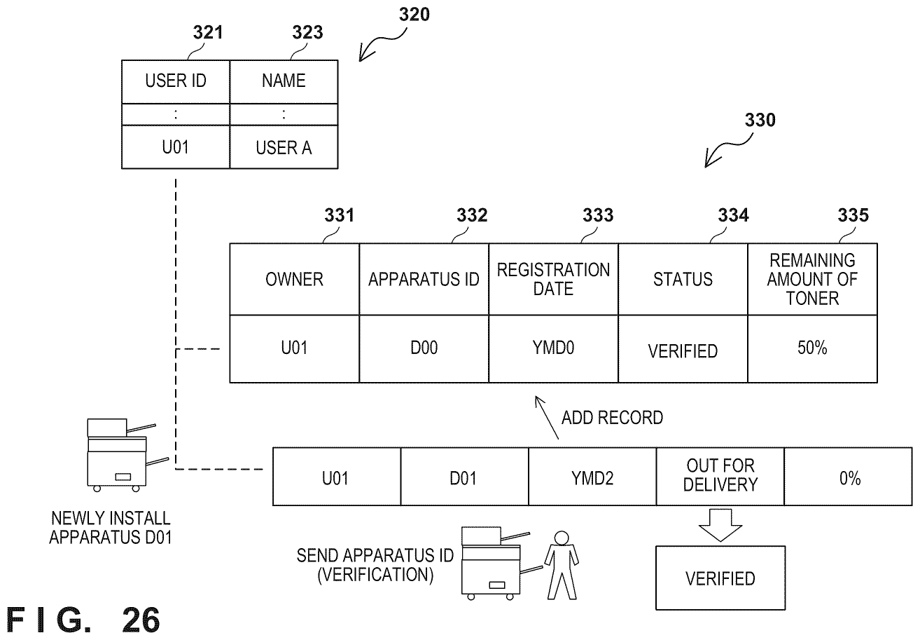

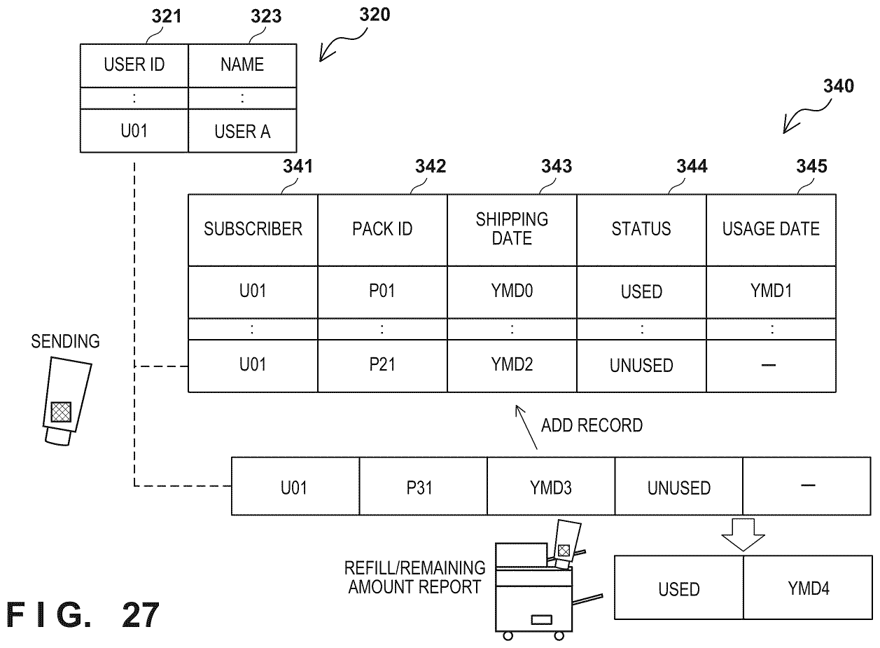

Updating of the content of the management DB 313 according to a typical flow of processing will be described hereinafter with reference to FIGS. 26 and 27. FIG. 26 illustrates an example of the updating of the apparatus registration table 330 when an apparatus is registered. The account table 320 having User ID 321 and Name 323 as data items is illustrated in the upper part of FIG. 26. Other data items in the account table 320 are not illustrated. The apparatus registration table 330 having Owner 331, Apparatus ID 332, Registration date 333, Status 334, and Remaining amount of toner 335 as data items is illustrated in the middle part of FIG. 26. In the example in FIG. 26, the account of a user identified by a user ID “U01” (called a “user U01” hereinafter) is already registered in the account table 320. Meanwhile, an image-forming apparatus identified by an apparatus ID “D00” is already registered in the apparatus registration table 330 as the apparatus of the user U01.

The user U01 newly installs an image-forming apparatus identified by an apparatus ID “D01” (called an “apparatus D01” hereinafter) in the user environment E1. When the user U01 inputs the apparatus information of the apparatus D01 through the input screen provided by the management server 301, the management server 301 adds a record for the apparatus information of the apparatus D01 to the apparatus registration table 330. In the added record, Owner 331 is “U01”, Apparatus ID 332 is “D01”, Registration date 333 is the date of registration, Status 334 is “Out for delivery (unverified)”, and Remaining amount of toner 335 is “0%”.

Furthermore, the user U01 performs an operation for registering the apparatus in the newly-installed apparatus D01 in accordance with a message displayed in the screen, for example. The apparatus D01 stores its own apparatus ID “D01” in advance. The apparatus D01 sends the apparatus information including the apparatus ID to the management server 301 in response to the operation by the user. The apparatus ID received in this manner may match the apparatus ID input by the user U01. In this case, the data management unit 350 changes the value of Status 334 of the record added to the apparatus registration table 330 from “Out for delivery (unverified)” to “Verified”, as illustrated in the lower part of FIG. 26.

FIG. 27 illustrates an example of the updating of the delivered pack table 340 when a pack is delivered. The upper part of FIG. 27 illustrates the content of the account table 320, which is similar to that illustrated in FIG. 26. The delivered pack table 340, which has data items of Subscriber 341, Pack ID 342, Shipping date 343, Status 344, and Usage date 345, is illustrated in the middle part of FIG. 27. In the example in FIG. 27, the refill pack 200 identified by a pack ID “P01” and the refill pack 200 identified by a pack ID “P21” (“refill pack P21” hereinafter) have already been provided to the user U01, and the refill pack P21 is unused.

In response to detecting one of the trigger events described above, the provision management unit 360 newly assigns a refill pack 200 identified by a pack ID “P31” (called a “refill pack P31” hereinafter) to the user U01. The provision management unit 360 adds a record for managing the status of the assigned refill pack P31 to the delivered pack table 340. In the added record, Subscriber 341 is “U01”, Pack ID 342 is “P31”, Shipping date 343 is the date of shipment, Status 344 is “Unused”, and Usage date 345 is blank.

History information of accumulated refill packs is used to authenticate the unused refill packs described above. In the example in FIG. 27, it can be seen that when the delivered pack table 340 is referenced when authenticating the unused refill pack P31, the refill pack P21 having a status of “Unused” (not “Used”) is already present in the delivered pack table 340. Authentication of the unused refill pack P31 can therefore fail.

The authentication by the authentication unit 370 is successful when the user U01 consents to the use of the refill pack P31 a user interface in the user terminal 401 or the image-forming apparatus 1. When the apparatus to be refilled is then refilled with toner from the refill pack P31, the apparatus to be refilled makes a report to the management server 301 indicating that the remaining amount of toner has increased. Based on this report, the data management unit 350 changes the value of Status 344 of the record added to the delivered pack table 340 from “Unused” to “Used”, and adds the date on which the increase in the remaining amount of toner was reported to Usage date 345.

### (Example of Configuration of User Terminal)

FIG. 11 is a block diagram illustrating an example of the configuration of the user terminal 401 according to the present embodiment. Referring to FIG. 11, the user terminal 401 includes the communication I/F 411, the memory 412, the camera 413, the input device 414, the display device 415, and the processing circuit 416.

The communication I/F 411 is an interface for the user terminal 401 to communicate with other apparatuses (a communication circuit). For example, the communication I/F 411 communicates with the image-forming apparatus 1 present in the user environment E1 and the management server 301 present in the remote environment E2. The communication I/F 411 may be a wired communication interface or a wireless communication interface. If the communication I/F 411 is a wireless communication interface, the communication I/F 411 may be, for example, a WLAN interface that communicates with a WLAN access point or a cellular communication interface that communicates with a cellular base station. Although only a single communication I/F 411 is illustrated in FIG. 11, the user terminal 401 may include a plurality of different communication modules for communicating with the image-forming apparatus 1 and the management server 301, respectively. The communication between the user terminal 401 and the image-forming apparatus 1 may be performed using a communication protocol for connecting peripheral devices, such as Bluetooth (registered trademark) or Universal Serial Bus (USB), for example.

The memory 412 may include any type of storage medium, including a semiconductor memory such as a ROM or a RAM, an optical disk, or a magnetic disk, for example. The memory 412 may include a non-transitory computer-readable storage medium. The memory 412 stores at least one computer program executed by the processing circuit 416, as well as a variety of data.

The camera 413 is a module capable of capturing images or video of a subject. In an example described below, the camera 413 is used to optically read the code 201 unique to the refill pack 200.

The input device 414 is used as a user interface for accepting user operations and the input of information. The input device 414 can include at least one of, for example, a touch sensor, a keypad, a keyboard, a pointing device, and a microphone. In an example described below, the code 201 unique to the refill pack 200 is input by the user through the input device 414.

The display device 415 is used to display images and information. The display device 415 may be constituted by, for example, a liquid crystal display (LCD) or organic light-emitting diodes (OLED).

The processing circuit 416 may be a CPU, for example, and provides various functions of the user terminal 401 by executing computer programs stored in the memory 412. More specifically, as illustrated in FIG. 11, the processing circuit 416 can function as the apparatus control unit 420, the code obtainment unit 430, and the application unit 440. Although only the functions related to managing the refilling of the image-forming apparatus 1 with the consumable material are mainly described in the present specification, the processing circuit 416 may also provide the user with a variety of other functions that a user terminal generally includes.

The apparatus control unit 420 controls image forming and other operations performed by the image-forming apparatus 1. The apparatus control unit 420 may include driver software for the image-forming apparatus 1. For example, the apparatus control unit 420 detects one or more apparatuses that can be used by the user terminal 401 present in the user environment E1, and presents a list of the detected apparatuses to the user in the screen of the display device 415. The apparatus control unit 420 may obtain the status of each apparatus (e.g., power on/off, the remaining amount of toner, and the like) and present the obtained status to the user. When an image-forming apparatus 1 is selected by the user and printing is instructed, the apparatus control unit 420 sends a print job including image data of the image to be printed to the image-forming apparatus 1, and causes the image-forming apparatus 1 to print the image.

The code obtainment unit 430 obtains the code 201 unique to the refill pack 200 that the user attempts to use for refilling the consumable material. As an example, the code 201 can be an optically-readable code printed on the refill pack 200 or a package thereof (e.g., packaging, a piece of paper included in the package, or the like). In this case, the code obtainment unit 430 may optically read the code 201 using the camera 413. As another example, the code 201 can be a code that can be read by a human (e.g., visually). As another example, the code obtainment unit 430 may allow the user to input the code 201 using the input device 414 and obtain the input code 201.

The application unit 440 can be an application for printing management that runs in cooperation with the management server 301. The application unit 440 may be a web browser. For example, when a user account is newly registered, and when the user account changes, the application unit 440 causes an account information input screen to be displayed in the display device 415. When the account information is input in the account information input screen, the application unit 440 sends the accepted account information to the management server 301 through the communication I/F 411. The application unit 440 also causes the display device 415 to display an apparatus information input screen when the image-forming apparatus 1 is installed in the user environment E1. When the apparatus information is input in the apparatus information input screen, the application unit 440 sends the accepted apparatus information to the management server 301 through the communication I/F 411.

The application unit 440 may also provide a user interface for requesting the management server 301 to execute the pre-refill authentication to a user who wishes to refill the image-forming apparatus 1 with the consumable material from the refill pack 200. For example, when the user operates a button for making an authentication request, the application unit 440 starts the code obtainment unit 430 to obtain the code unique to the refill pack 200, and sends the obtained code 201 to the management server 301 through the communication I/F 411. The application unit 440 may send the code 201 to the management server 301 as part of a request for permission to refill the consumable material. The application unit 440 may also send the code 201 to the management server 301 as part of a request to open the refill path (or unlock the opening and closing mechanism).

In one example, the application unit 440 may send a sending request to the image-forming apparatus 1. The sending request is a request for the image-forming apparatus 1 to send the apparatus ID required for the pre-refill authentication by the management server 301 to the management server 301. In another example, the application unit 440 may cause the display device 415 to display a message prompting the user to perform an operation in the image-forming apparatus 1 for sending the apparatus ID.

When the pre-refill authentication is performed by the management server 301 based on the unique code 201 assigned to the refill pack 200, the application unit 440 receives the result of the pre-refill authentication from the management server 301. If the authentication result indicates the pre-refill authentication is successful, the application unit 440 may cause the apparatus control unit 420 to send an unlock command for unlocking the opening and closing mechanism, or an open command for opening the refill path, to the image-forming apparatus 1. Note that if these commands are sent directly to the image-forming apparatus 1 from the management server 301, the user terminal 401 need not send the commands to the image-forming apparatus 1.

The application unit 440 causes the display device 415 to display the result of the pre-refill authentication received from the management server 301. For example, if the result of the pre-refill authentication indicates that the authentication is successful, the user can connect the refill pack 200 to the image-forming apparatus 1, open the consumable material refill path by operating the opening and closing mechanism that blocked the refill path, and refilling the image-forming apparatus 1 with the consumable material from the refill pack 200. At this time, the opening and closing mechanism is unlocked by the image-forming apparatus 1, and thus the user is not inhibited from performing an operation to open the refill path. Note that the refill pack 200 may be connected to the image-forming apparatus 1 before the request for the pre-refill authentication, or after the authentication is successful. As described above, the image-forming apparatus 1 may automatically activate the opening and closing mechanism instead of the user operating the opening and closing mechanism. If the result of the pre-refill authentication indicates that the authentication has failed, the user retries the pre-refill authentication after taking appropriate measures, or gives up on refilling the consumable material for the time being, depending on the cause of the failure, which can be displayed on the screen. At this time, the opening and closing mechanism remains locked by the image-forming apparatus 1, or the opening and closing mechanism is not automatically activated and the refill path remains blocked.

### (Example of Configuration of Image-Forming Apparatus)

FIG. 12 is a block diagram illustrating an example of the functional configuration of the image-forming apparatus 1 according to the present embodiment. Referring to FIG. 12, the image-forming apparatus 1 includes the communication I/F 11, the memory 12, the user I/F 13, the image-forming unit 40, the opening and closing mechanism 51, the locking mechanism 52, and the processing circuit 90.

The communication I/F 11 is an interface for the image-forming apparatus 1 to communicate with other apparatuses. For example, the communication I/F 11 communicates with the user terminal 401 present in the user environment E1 and the management server 301 present in the remote environment E2. The communication I/F 11 may be a wired communication interface or a wireless communication interface. If the communication I/F 11 is a wireless communication interface, the communication I/F 11 may be, for example, a WLAN interface or a cellular communication interface. Although only a single communication I/F 11 is illustrated in FIG. 12, the image-forming apparatus 1 may include a plurality of different communication modules for communicating with the user terminal 401 and the management server 301, respectively.

The memory 12 may include any type of storage medium, including a semiconductor memory such as a ROM or a RAM, an optical disk, or a magnetic disk, for example. The memory 12 may include a non-transitory computer-readable storage medium. The memory 12 stores at least one computer program executed by the processing circuit 90, as well as a variety of data. The memory 12 stores, in advance, the apparatus ID (also called “apparatus identification information”) that uniquely identifies the image-forming apparatus 1, for example.

The user I/F 13 can include an input device for accepting user operations and the input of information, and a display device for displaying images and information. For example, the user I/F 13 can include at least one of a touch panel, a keypad, buttons, switches, a microphone, and a speaker. The user I/F 13 may be treated as an operation terminal integrated into the image-forming apparatus 1. In an example, the user I/F 13 may be used to accept input of the code 201 unique to the refill pack 200.

As described with reference to FIG. 2, the image-forming unit 40 forms an image on a recording medium by consuming toner preserved in the preserving container 48. The opening and closing mechanism 51 is a mechanism that can open and close a refill path 50 to the preserving container 48 from the refill pack 200 connected to the toner receiving unit 110. The above-described ring member 111 including the lever 111b and the protruding part 111d, the pack shutter 214 of the refill pack 200, and the main body shutter 116 are an example of the opening and closing mechanism 51. The locking mechanism 52 is a mechanism for inhibiting (i.e., locking) and canceling the inhibiting (unlocking) the operation of the opening and closing mechanism 51 performed by the user or the automatic action of the opening and closing mechanism 51. The above-described locking unit 150 is an example of the locking mechanism 52.

From a functional perspective, the above-described electronic component groups 91, 92, and 93 of the processing circuit 90 can function mainly as a print control unit 95 and a lock control unit 96. The print control unit 95 controls operations for image formation performed by the image-forming unit 40. For example, when a print job is received from an external apparatus via the communication I/F 11, the print control unit 95 controls the image-forming unit 40 to form an image on a recording medium based on input image data included in the print job.

The lock control unit 96 controls the locking and unlocking of the opening and closing mechanism 51 by the locking mechanism 52. For example, when a predetermined input signal is detected, the lock control unit 96 sends the apparatus ID stored in the memory 12 to the management server 301. The apparatus ID sent to the management server 301 may be used to verify whether the image-forming apparatus 1 identified by the apparatus ID specified by the user for apparatus registration is actually installed in the user environment E1 of that user. The apparatus ID sent to the management server 301 may be used for the execution of the pre-refill authentication by the management server 301. The lock control unit 96 may send the remaining amount information indicating the latest remaining amount of toner to the management server 301 along with the apparatus ID.

In an example, the aforementioned input signal that triggers the sending of the apparatus ID is a received signal (e.g., a sending request requesting the apparatus ID be sent) received from the user terminal 401 via the communication I/F 11. In this case, in response to the sending request being received, the lock control unit 96 reads out the apparatus ID from the memory 12 and sends the read-out apparatus ID to the management server 301. In another example, the aforementioned input signal that triggers the sending of the apparatus ID is a user input signal (e.g., an operation signal indicating that a predetermined button has been operated) detected via the user I/F 13. In this case, in response to the user input signal being detected, the lock control unit 96 reads out the apparatus ID from the memory 12 and sends the read-out apparatus ID to the management server 301.

After sending the apparatus ID to the management server 301 for the pre-refill authentication, the lock control unit 96 receives the unlock command, which is a control signal based on the result of the pre-refill authentication, over a predetermined standby period. Then, if the unlock command is received before the standby period ends, the lock control unit 96 causes the locking mechanism 52 to unlock the opening and closing mechanism 51 in accordance with the unlock command. For example, the lock control unit 96 may energize the solenoid of the locking unit 150 to pivot the locking member 152 as in the example illustrated in FIG. 8B. This makes it possible for the user to open the refill path 50 by rotating the main body shutter 116 and the pack shutter 214 of the refill pack 200 along with the ring member 111. Note that if a configuration is employed in which the image-forming apparatus 1 automatically activates the opening and closing mechanism 51, the lock control unit 96 may stand by for the reception of an open command instead of an unlock command, and open the refill path 50 by activating the opening and closing mechanism 51 in accordance with the received open command.

If the standby period ends without the unlock command or the open command being received (i.e., in the case of a timeout), the lock control unit 96 stops standing by for the command. For example, the unlock command or the open command may be stood by for by temporarily opening a specific receiving port provided in the communication I/F 11. Risks such as the unauthorized operation of the image-forming apparatus 1 by a malicious third party can be minimized by standing by for a control signal from the outside only for a limited period of time that is triggered by the detection of a predetermined input signal. In addition, the power consumed by the image-forming apparatus 1 can be reduced by putting the image-forming apparatus 1 into a sleep state during periods aside from the standby period.

If the unlock command or the open command is received before the end of the standby period, the lock control unit 96 may keep the opening and closing mechanism 51 in the unlocked state for a predetermined unlocked period following the reception of the command, and lock the opening and closing mechanism 51 again after the unlocked period ends. In the example illustrated in FIG. 8B, even if the solenoid is energized, the ring member 111 can be rotated counterclockwise while the opening and closing mechanism 51 is in the open state. For example, after the opening and closing mechanism 51 is unlocked, the user rotates the ring member 111 in what is the clockwise direction in the figure to open the refill path, and the refilling of the consumable material is started as a result. After the refilling of the consumable material is complete, the user rotates the ring member 111 counterclockwise to block the refill path. When the energizing of the solenoid ends and the rotational position of the ring member 111 is returned to the original position, the tip 153 of the locking member 152 returns to the position illustrated in FIG. 8A under the elastic force of the spring. As a result, even if the user attempts to open the refill path by rotating the ring member 111 clockwise again, the rotation of the ring member 111 is inhibited by the locking member 152. The relocking of the opening and closing mechanism 51 can be achieved in this manner. Again, note that the configuration illustrated in FIG. 8A is merely an example of the opening and closing mechanism 51 and the locking mechanism 52, and any other configuration may be employed.

The print control unit 95 controls the remaining amount detection unit 61 to detect the remaining amount of consumable material in the preserving container 48 when, for example, image-forming operations are performed and when the toner is refilled. For example, the remaining amount detection unit 61 causes light to be emitted from the light emitter 61a and obtains a light detection signal from the light receiver 61b while the toner preserved in the preserving container 48 is being agitated by the agitation member 60. The remaining amount detection unit 61 then estimates the remaining amount of toner based on the obtained light detection signal, and reports the estimated remaining amount of toner to the print control unit 95. The print control unit 95 reports the remaining amount information indicating the remaining amount of toner detected in this manner to the management server 301 via the communication I/F 11. The report on the remaining amount of toner may be sent to the management server 301 via the user terminal 401 instead of being sent directly to the management server 301.

When the toner is refilled, the remaining amount of toner increases. As described above, detecting an increase in the remaining amount of toner based on the remaining amount information makes it possible for the management server 301 to ascertain that the refill pack 200 for which the pre-refill authentication was successful has been used by the user. Note that instead of the management server 301, the image-forming apparatus 1 or the user terminal 401 may detect the increase in the remaining amount of toner and send a notification signal indicating that the refill pack 200 has been used to the management server 301.

### (Flow of Processing)

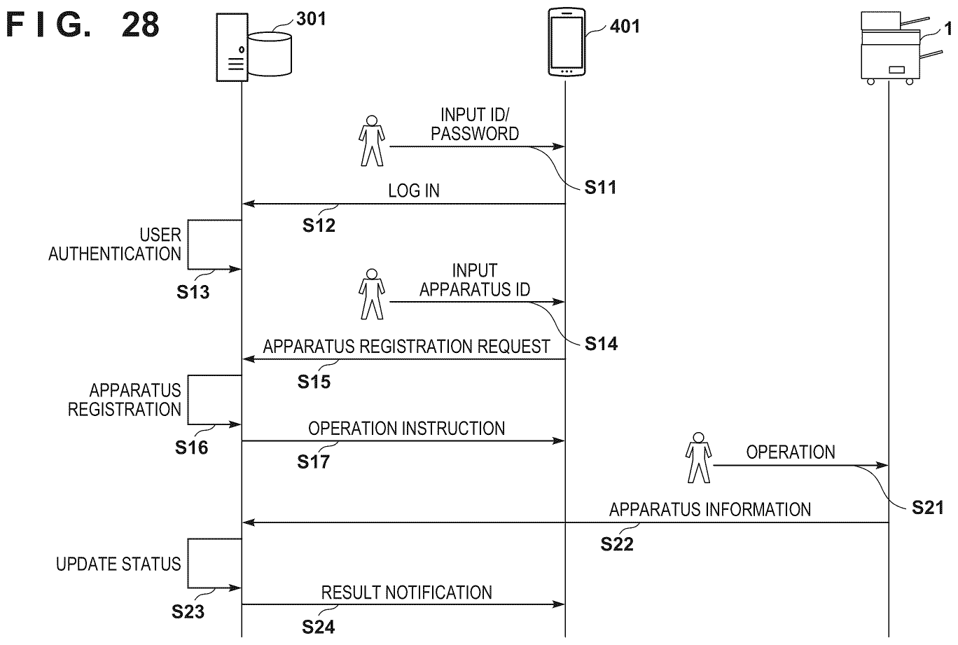

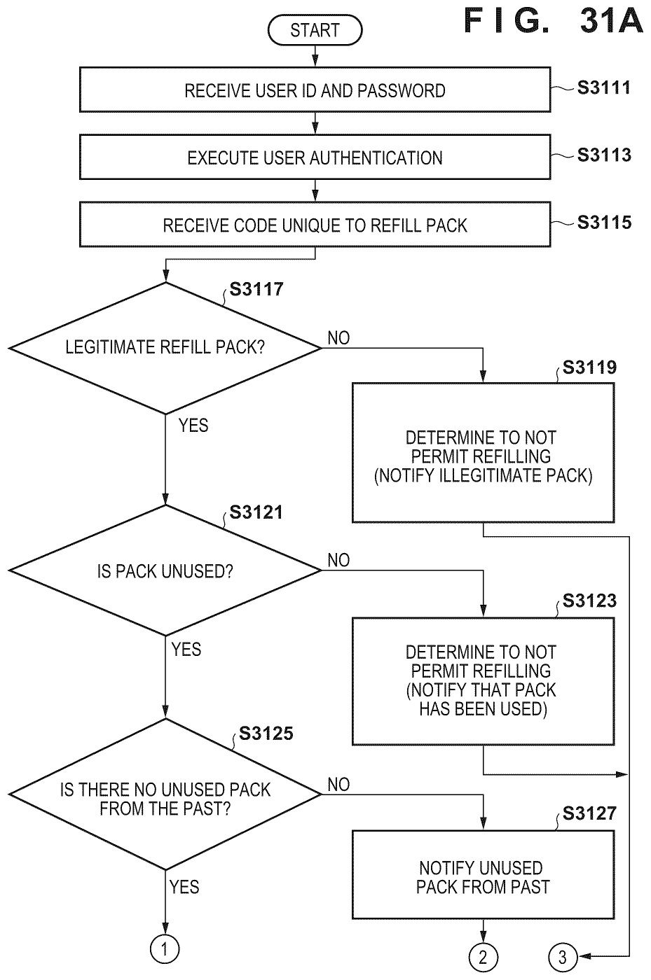

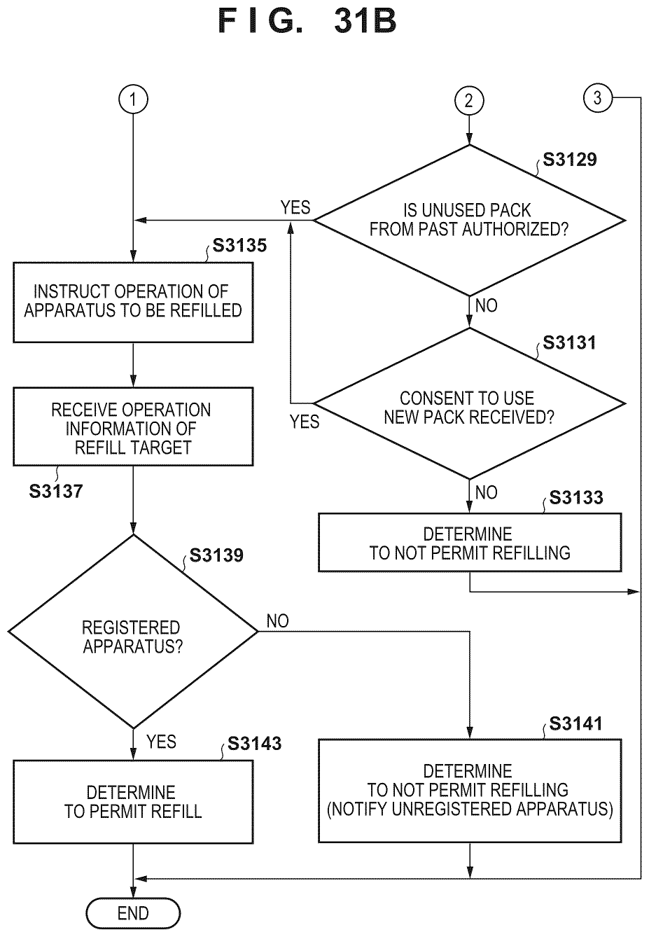

This section will describe several examples of the flow of processing that can be executed in the printing management system 300 according to the present embodiment, with reference to the sequence charts in FIGS. 28 to 30 and the flowcharts in FIGS. 31A to 33. Note that in the following descriptions, processing steps are indicated by an S, indicating “step”.

### (Apparatus Information Registration)

FIG. 28 is a sequence chart illustrating an example of the overall flow of processing related to apparatus registration. The sequence illustrated in FIG. 28 mainly involves the image-forming apparatus 1, the management server 301, and the user terminal 401. It is assumed that the account information of the user is already registered in the account table 320 of the management DB 313 prior to the start of the sequence.

In S11, the user inputs the user ID and password in a login screen provided by the application unit 440 of the user terminal 401, for example. In S12, the application unit 440 sends the input user ID and password to the management server 301 in order to log in. In S13, the authentication unit 370 of the management server 301 executes user authentication based on the user ID and password received from the user terminal 401. It is assumed here that the user authentication is successful and the login to the system is established. The subsequent processing illustrated in FIG. 28 is performed while the login session continues.

In S14, the user inputs the apparatus information including the apparatus ID of the image-forming apparatus 1 installed in the user environment E1 into the apparatus information input screen provided by the application unit 440, for example. In S15, the application unit 440 sends an apparatus registration request including the input apparatus information to the management server 301. In S16, the data management unit 350 registers the apparatus information included in the received apparatus registration request in the apparatus registration table 330. In S17, the data management unit 350 instructs the application unit 440 to display a message prompting a predetermined operation to be performed in the image-forming apparatus 1, and that message is displayed by the display device 415.

In S21, the user performs the predetermined operation through the user I/F 13 of the image-forming apparatus 1. Then, in S22, the lock control unit 96 of the image-forming apparatus 1 reads out the apparatus ID from the memory 12 and sends the apparatus information including the read-out apparatus ID to the management server 301. In S23, the data management unit 350 verifies the apparatus ID included in the apparatus information received from the image-forming apparatus 1 against the apparatus ID registered in the apparatus registration table 330 in S16. If the apparatus IDs match, the data management unit 350 updates the value of the corresponding “Status” in the apparatus registration table 330 to “Verified”. In S24, the data management unit 350 notifies the application unit 440 of the user terminal 401 of the result of the verification. The application unit 440 displays the verification result from the notification in the screen.

### (Provision of Refill Pack)

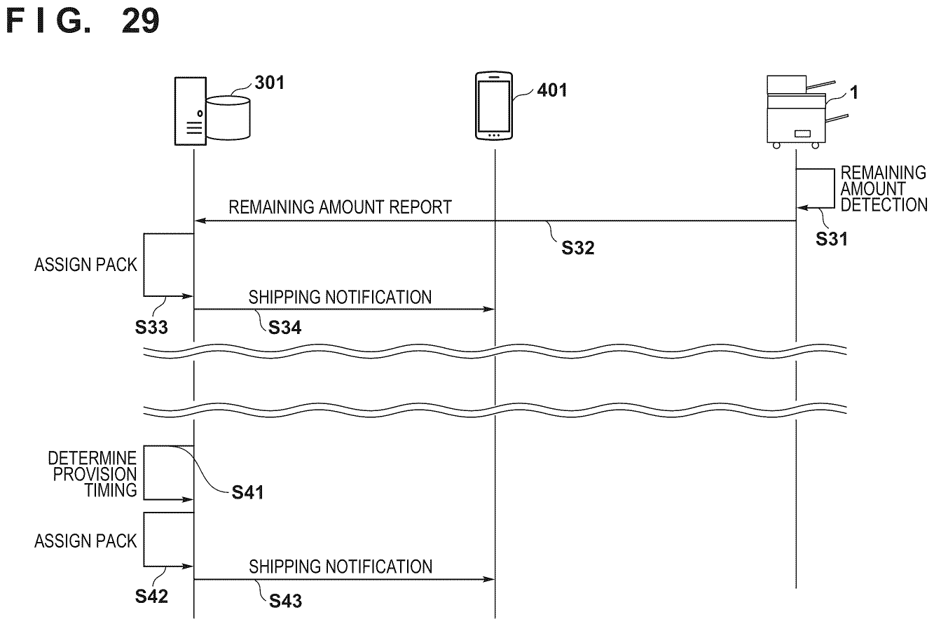

FIG. 29 is a sequence chart illustrating some examples of the overall flow of processing related to providing a refill pack to a user. The sequence illustrated in FIG. 29 mainly involves the image-forming apparatus 1, the management server 301, and the user terminal 401. Note that the provision management unit 360 of the management server 301 continuously monitors for the occurrence of a trigger event that triggers the provision of the refill pack 200 to the user. Here, a decrease in the remaining amount of toner will be described as a first example of a trigger event, and a provision timing based on a periodic purchase agreement arriving will be described as a second example.

In the first example, in S31, the print control unit 95 of the image-forming apparatus 1 detects the remaining amount of toner in the preserving container 48 when, for example, image-forming operations are performed. It is assumed here that the remaining amount of toner is below a remaining amount threshold that triggers the provision of a new refill pack 200. In S32, the print control unit 95 reports the remaining amount information indicating the detected remaining amount of toner to the management server 301. In S33, the provision management unit 360 of the management server 301 recognizes that the remaining amount of toner in the image-forming apparatus 1 has decreased, and assigns a new unused refill pack 200 to the user who owns the image-forming apparatus 1. Assigning the refill pack 200 to the user can include adding a new record indicating the user ID and the pack ID identifying the refill pack 200 to the delivered pack table 340 and setting the status of the refill pack to “Unused.” In addition, the provision management unit 360 sends a message, to a delivery person, instructing the assigned refill pack 200 to be delivered. When a new refill pack 200 is sent to the user, in S34, the provision management unit 360 sends a shipping notification to the user terminal 401.

In the second example, in S41, the provision management unit 360 determines that the provision timing for the refill pack 200 has arrived for the user who has entered into the periodic purchase agreement. In S42, the provision management unit 360 assigns a new unused refill pack 200 to the user for whom the provision timing has arrived. In addition, the provision management unit 360 sends a message, to a delivery person, instructing the assigned refill pack 200 to be delivered. When the refill pack 200 is sent to the user, in S43, the provision management unit 360 sends a shipping notification to the user terminal 401.

### (Authentication Referring to Unused Toner Pack (First Example))

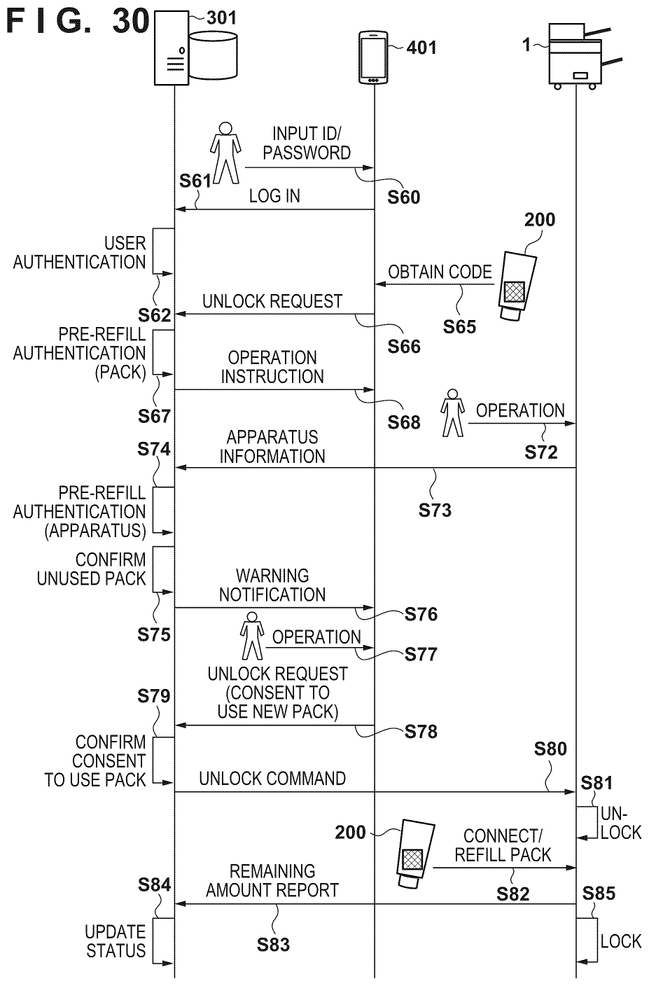

FIG. 30 is a sequence chart illustrating an example of the overall flow of processing according to a first example when refilling the consumable material. The sequence illustrated in FIG. 30 mainly involves the image-forming apparatus 1, the management server 301, and the user terminal 401. Note that the unused new refill pack 200 is assumed to have been delivered to the user environment E1 prior to the start of the sequence.

In S60, the user inputs the user ID and password in the login screen. In S61, the application unit 440 of the user terminal 401 sends the input user ID and password to the management server 301. In S62, the authentication unit 370 of the management server 301 executes user authentication based on the user ID and password received from the user terminal 401. It is assumed here that the user authentication is successful and the login to the system is established. The subsequent processing illustrated in FIG. 30 is performed while the login session continues.

In S65, the application unit 440 starts the code obtainment unit 430 in response to an operation made by the user. The code obtainment unit 430 obtains the code 201 unique to the refill pack 200 by, for example, optically reading the code using the camera 413, or by accepting a user input. Next, in S66, the application unit 440 sends an unlock request, including the code 201 obtained by the code obtainment unit 430, to the management server 301.

The authentication unit 370 of the management server 301 starts the pre-refill authentication in response to the unlock request being received. S67 is a first stage of the pre-refill authentication, in which the authentication unit 370 determines whether the refill pack 200 identified by the code 201 included in the unlock request is being managed in correspondence with the account of the logged-in user by referring to the delivered pack table 340. It is assumed here that the refill pack 200 is being managed in correspondence with the user account, and the first stage of the authentication is therefore successful. In response to the first stage of the authentication being successful, in S68, the authentication unit 370 instructs the application unit 440 to display a message prompting a predetermined operation to be performed in the apparatus to be refilled, and that message is displayed by the display device 415.

In S72, the user performs the predetermined operation through the user I/F 13 of the image-forming apparatus 1 that is the apparatus to be refilled. Upon doing so, in S73, the lock control unit 96 reads out the apparatus ID from the memory 12 and sends the apparatus information, including the read-out apparatus ID, to the management server 301. S74 is a second stage of the pre-refill authentication, in which the authentication unit 370 determines whether the image-forming apparatus 1 which is to be refilled is being managed in correspondence with the user account of the logged-in user by referring to the apparatus registration table 330 based on the apparatus ID included in the received apparatus information. It is assumed here that the image-forming apparatus 1 is being managed in correspondence with the user account, and the second stage of the authentication is therefore also successful.

S75 is a third stage of the pre-refill authentication. In S75, the authentication unit 370 determines whether there is another unused refill pack associated with the account of the logged-in user by referring to the delivered pack table 340. Here, “unused refill pack” is a refill pack that is being managed in association with the account of the logged-in user, and for which “Status” is set to “Unused”. It is assumed here that an unused refill pack is registered in the delivered pack table 340, and the third stage of the authentication therefore fails.

In S76, the authentication unit 370 sends a warning notification to the user terminal 401. The warning notification is a message instructing the application unit 440 to display the authentication result that the pre-refill authentication has failed. The application unit 440 displays a notification screen in the display device 415 communicating the authentication result in accordance with the warning notification. Here, the notification includes information for making the user aware that there is another unused refill pack 200 that was delivered earlier. Furthermore, the notification may include information for confirming the use of the refill pack 200 subject to the pre-refill authentication with the user. Here, it is assumed that the user has consented to the use of the refill pack 200 subject to authentication. In other words, the user may wish to use an unused refill pack 200 that was delivered later. This can help mitigate a disadvantageous situation where the image-forming apparatus 1 cannot be used because another unused refill pack 200 that was delivered earlier cannot be found.

In S77, the user operates the user terminal 401 and, through the input device 414, inputs an indication that they consent to the use of the refill pack 200.

In S78, the application unit 440 sends an unlock request to the management server 301 through the communication I/F 411. The unlock request includes information indicating that the user consents to the use of the unused refill pack 200.

In S79, the management server 301 confirms that the user has consented to the use of the refill pack 200 based on the unlock request. In S80, the management server 301 sends an unlock command to the image-forming apparatus 1.

In S81, in response to the unlock command from the management server 301 being received, the lock control unit 96 of the image-forming apparatus 1 causes the locking mechanism 52 to unlock the opening and closing mechanism 51. The unlocked opening and closing mechanism 51 is operated by the user (or is automatically activated), the refill path 50 is opened, and the image-forming apparatus 1 is refilled with the consumable material from the refill pack 200.

In S82, the print control unit 95 detects the remaining amount of toner in the preserving container 48 and reports the remaining amount information, which indicates the remaining amount of toner, to the management server 301.

In S83, the data management unit 350 of the management server 301 updates the value of “Remaining amount of toner” in the record of the apparatus registration table 330 corresponding to the image-forming apparatus 1 in response to the remaining amount information being received. In addition, the data management unit 350 changes “Status” for the record in the delivered pack table 340 corresponding to the used refill pack 200 from “Unused” to “Used”.

On the other hand, when a predetermined unlocked period has passed following the timing at which the unlock command was received or the opening and closing mechanism 51 was unlocked, in S84, the lock control unit 96 locks the opening and closing mechanism 51 again.

### (Authentication Processing)

FIGS. 31A and 31B are flowcharts illustrating an example of the flow of the authentication processing executed by the management server 301. The flowcharts illustrated in FIGS. 31A and 31B are stored as programs in the memory 312 of the management server 301 and are executed by the processing circuit 314. The authentication processing in FIGS. 31A and 31B corresponds to the processing executed by the authentication unit 370 of the management server 301 in S62 to S80 in FIG. 30.

In S3111, the authentication unit 370 receives the user ID and password entered in the login screen. Next, in S3113, the authentication unit 370 executes user authentication based on the received user ID and password. It is assumed here that the user authentication is successful, and thus the flow of processing performed when the user authentication has failed will not be described.

Next, in S3115, the authentication unit 370 receives the unique code 201 assigned to the refill pack 200 obtained in the user environment E1. Next, in S3117, the authentication unit 370 determines whether the refill pack is a legitimate refill pack. This determination may be a determination as to whether the refill pack has been provided to the user through a legitimate route. For example, the authentication unit 370 determines whether the refill pack 200 identified based on the received code 201 is being managed (is registered) in correspondence with the user account of the logged-in user. There are cases where an association between the Pack ID based on the received code 201 and the user ID of the logged-in user is registered in the delivered pack table 340. In this case, the refill pack 200 is determined to be a refill pack 200 that the user is permitted to use, and the sequence moves to S3121. However, there are also cases where an association between the Pack ID based on the received code 201 and the user ID of the logged-in user is not registered in the delivered pack table 340. In this case, the refill pack 200 is determined not to be a refill pack 200 that is permitted to be used, and the sequence moves to S3119.

In S3119, because it has been determined that the refill pack 200 has not been provided to the user through a legitimate route, the authentication unit 370 determines not to permit the refilling of the consumable material from that refill pack 200. In this case, the authentication unit 370 sends, to the user terminal 401, an authentication result notification indicating that the pre-refill authentication has failed because the refill pack 200 is not a refill pack 200 that is permitted to be used. In this manner, a notification indicating that the refill pack 200 is an illegitimate pack may be sent.

In S3121, the authentication unit 370 determines whether the status of the refill pack 200 identified by the received code 201 is “Unused” by referring to the delivered pack table 340. If the status is “Unused”, the sequence moves to S3125. On the other hand, if the status is “Used”, the sequence moves to step S3123.

In S3123, the refill pack 200 has already been used, and thus the authentication unit 370 determines not to permit the refilling of the consumable material from the refill pack 200. In this case, the authentication unit 370 sends, to the user terminal 401, an authentication result notification indicating that the pre-refill authentication has failed because the refill pack 200 has already been used. This notification may include information indicating that the refill pack 200 has already been used.

In S3125, the authentication unit 370 determines whether an unused refill pack 200 from the past is present. “Unused refill pack 200 from the past” is an unused refill pack 200 that was delivered to the user before the refill pack 200 subject to the authentication was delivered to the user. The refill pack 200 subject to the authentication may be called a “first refill pack 200”, and the unused refill pack 200 from the past may be called a “second refill pack”. The refill pack 200 subject to the authentication may also be called a “new unused refill pack 200”, and the unused refill pack 200 from the past may be called an “old unused refill pack 200”. In this manner, the determination corresponds to determining whether the user is in possession of an excess refill pack 200. It may be ecologically unsound for a user to stockpile an excessive amount of unused refill packs 200. Accordingly, it is determined that the user will stockpile an excessive amount of unused refill packs 200. The authentication unit 370 refers to the delivered pack table 340 to identify the user to whom the refill pack 200 identified by the received code 201 is assigned. Furthermore, the authentication unit 370 determines, based on the delivered pack table 340, whether there is another refill pack 200 which is associated with the identified user and which has a status of “Unused”. If the unused refill pack 200 has already been assigned to the user, the sequence moves to S3127. However, if the unused refill pack 200 has not yet been assigned to the user, the sequence moves to S3135. The determination standard for the unused refill pack 200 here is merely one example. For example, a determination standard such as the number of unused refill packs being at least a given threshold may be used.

In S3127, the authentication unit 370 notifies the user terminal 401 that an unused refill pack 200 from the past is present. The user who sees this notification may switch the authentication target from the new unused refill pack 200 to the unused refill pack 200 from the past, and attempt to authenticate the unused refill pack 200 from the past. The user obtains the pack ID of the unused refill pack 200 from the past and sends that pack ID to the management server 301 using the user terminal 401 or the image-forming apparatus 1. In this manner, the authentication unit 370 may receive the pack ID of the unused refill pack 200 from the past and perform authentication on the unused refill pack 200 from the past.

In S3129, the authentication unit 370 determines whether the unused refill pack 200 from the past has been authenticated. If the unused refill pack 200 from the past has been authenticated (the authentication succeeds), the sequence moves to S3135. However, if the unused refill pack 200 from the past has not been authenticated (the authentication fails), the sequence moves to S3131.

In S3131, the authentication unit 370 determines whether the user has consented to the use of the new unused refill pack 200. The authentication unit 370 confirms with the user whether they consent to the use of the new unused refill pack 200. An inquiry message for the confirmation is displayed in the display device 415 of the user terminal 401 or the user I/F 13 of the image-forming apparatus 1. A response indicating whether to consent is input through the input device 414 of the user terminal 401 or the user I/F 13 of the image-forming apparatus 1. In this manner, whether the user consents to the use of the new unused refill pack 200 is confirmed regardless of whether another unused refill pack 200 that was delivered in the past is present. If the user has consented to the use of the new unused refill pack 200, the sequence moves to step S3135. However, if the user has not consented to the use of the new unused refill pack 200, the sequence moves to step S3133.

In S3133, the authentication unit 370 determines not to permit the refilling of the consumable material from the new unused refill pack 200. In this manner, if an unused refill pack 200 from the past is present and the user has not consented to the use of a new unused refill pack 200, the refilling of the consumable material from the new unused refill pack 200 is prohibited. Accordingly, the new unused refill pack 200 will not be unlocked.

In this manner, there are situations where the refill pack 200 identified by the received code 201 is an unused refill pack and there are no unused refill packs 200 from the past, or the user consents to the use of a new unused refill pack 200. In this case, in S3135, the authentication unit 370 instructs the user to perform a predetermined operation in the apparatus to be refilled (e.g., by displaying a message on the screen).

In S3137, the authentication unit 370 receives the apparatus information including the apparatus ID from the image-forming apparatus 1 that is the apparatus to be refilled. In S3139, the authentication unit 370 determines whether the apparatus to be refilled, identified by the received apparatus ID, is already registered as an apparatus of the logged-in user. For example, if an association between the received apparatus ID and the user ID of the logged-in user is registered in the apparatus registration table 330, the apparatus to be refilled is already registered as an apparatus of the logged-in user, and thus the sequence moves to S3143. On the other hand, if an association between the received apparatus ID and the user ID of the logged-in user is not registered in the apparatus registration table 330, the apparatus to be refilled is not registered as an apparatus of the logged-in user, and thus the sequence moves to S3141.

In S3141, the apparatus to be refilled is not registered as an apparatus of the logged-in user, and thus the authentication unit 370 determines not to permit the refilling of the apparatus to be refilled with the consumable material. In this case, the authentication unit 370 sends, to the user terminal 401, an authentication result notification indicating that the pre-refill authentication has failed due to the apparatus not being registered.

In S3143, the authentication unit 370 determines that the apparatus to be refilled is already registered as an apparatus of the logged-in user, and thus determines to permit the refilling of the image-forming apparatus 1, which is the apparatus to be refilled, with the consumable material from the refill pack 200. In this case, the authentication unit 370 sends an unlock command to cause the locking mechanism 52 of the image-forming apparatus 1 to unlock the opening and closing mechanism 51, and sends, to the user terminal 401, an authentication result notification indicating the authentication is successful. Although not illustrated in FIGS. 31A and 31B, in S3143, the authentication unit 370 may permit the refilling of the apparatus to be refilled with the consumable material only if the remaining amount information indicates that the remaining amount of toner in the apparatus to be refilled is less than a predetermined remaining amount threshold, as described above.

### (Lock Control Processing)

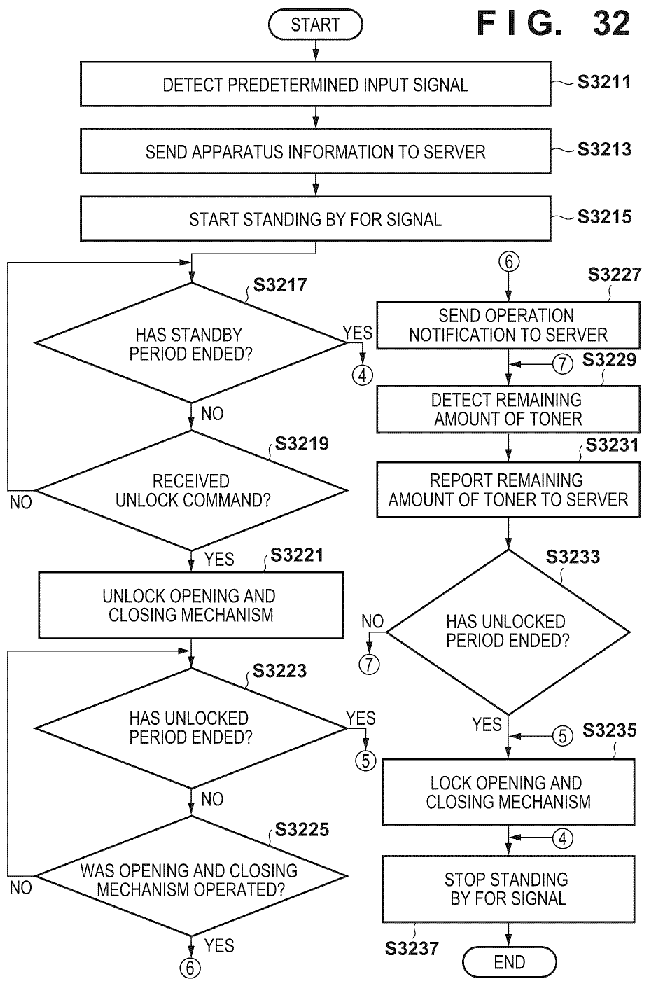

FIG. 32 is a flowchart illustrating an example of the flow of lock control processing executed by the image-forming apparatus 1. The lock control processing in FIG. 32 corresponds to the processing executed by the lock control unit 96 of the image-forming apparatus 1 in S72 to S81 in FIG. 30.

First, in S3211, the lock control unit 96 detects a predetermined input signal. Here, the input signal may be, for example, an ID sending request received from the user terminal 401 via the communication I/F 11, or a user input signal detected via the user I/F 13. In S3213, in response to the predetermined input signal being detected, the lock control unit 96 reads out the apparatus ID from the memory 12 and sends the apparatus information, including the read-out apparatus ID, to the management server 301. Next, in S3215, the lock control unit 96 starts standing by for the unlock command, which is a control signal based on the result of the pre-refill authentication.

In S3217, the lock control unit 96 determines whether the predetermined standby period has ended by referring to the value of a timer that starts when the standby starts, for example. If the standby period has ended, the sequence moves to S3237. On the other hand, if the standby period has not ended, the sequence moves to S3219.

In S3219, the processing branches depending on whether an unlock command has been received from the management server 301. If an unlock command has been received from the management server 301, the sequence moves to S3221. If an unlock command is not received, the sequence returns to S3217.

In S3221, the lock control unit 96 causes the locking mechanism 52 to unlock the opening and closing mechanism 51 in accordance with the unlock command received from the management server 301. Next, in S3223, the lock control unit 96 stands by until the unlocked period ends by using a timer that starts when the opening and closing mechanism 51 is unlocked, for example. Meanwhile, in S3225, the lock control unit 96 monitors the operation of the opening and closing mechanism 51 by the user. When the opening and closing mechanism 51 is operated by the user and the refill path 50 is opened, the sequence moves to step S3227.

In S3227, the lock control unit 96 sends, to the management server 301, an operation notification indicating that the refill path 50 has been opened. In addition, in S3229, the remaining amount detection unit 61 detects the remaining amount of toner in the preserving container 48. Then, in S3231, the print control unit 95 reports the remaining amount of toner detected by the remaining amount detection unit 61 to the management server 301. The detection and reporting of the remaining amount of toner in S3229 and S3231 may be repeated until it is determined in S3233 that the unlocked period has ended.

If it is determined in S3223 or S3233 that the unlocked period has ended, in S3235, the lock control unit 96 causes the locking mechanism 52 to lock the opening and closing mechanism 51 again. Additionally, in S3237, the lock control unit 96 ends the standby for the control signal from an external device. The lock control processing illustrated in FIG. 32 then ends.

### (Authentication and Refill of Consumable Agent (Second Example))

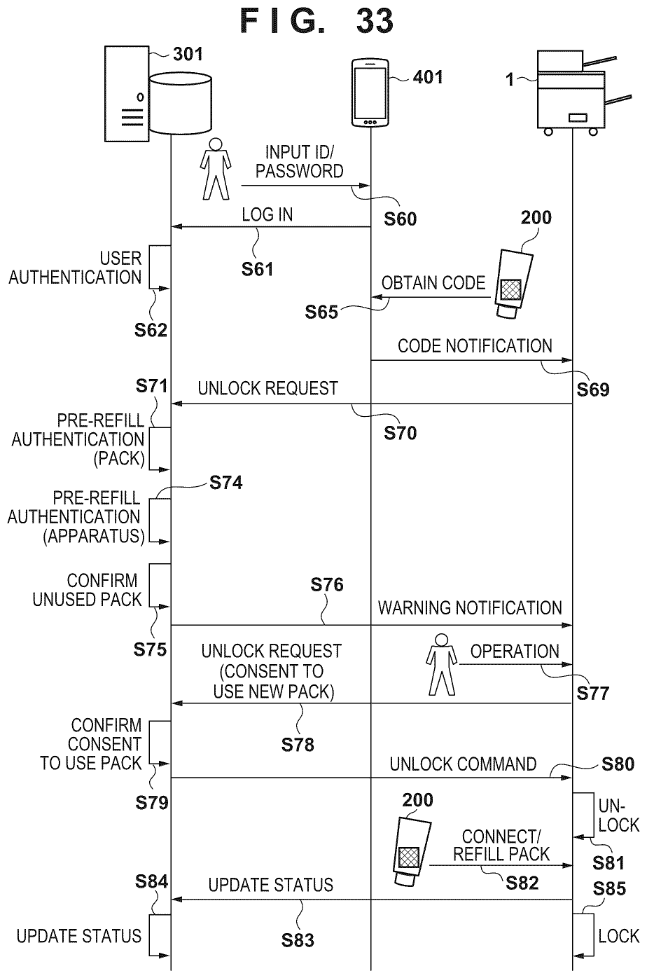

FIG. 33 is a sequence chart illustrating an example of the overall flow of processing according to a second example when refilling the consumable material. The sequence illustrated in FIG. 33 mainly involves the image-forming apparatus 1, the management server 301, and the user terminal 401. Note that the unused new refill pack 200 is assumed to have been delivered to the user environment E1 prior to the start of the sequence.

S60 to S62, which are processing steps related to login and user authentication, may be the same as in the first example illustrated in FIG. 30, and will therefore not be described again here.

In S65, the code obtainment unit 430 of the user terminal 401 starts up in response to an operation made by the user, and obtains the unique code 201 provided for the refill pack 200. Next, in S69, the apparatus control unit 420 sends a code notification to the image-forming apparatus 1. The code notification includes the code 201 obtained by the code obtainment unit 430. In response to the code notification being received, in S70, the lock control unit 96 of the image-forming apparatus 1 sends an unlock request to the management server 301. The unlock request may include the code 201 for which the notification was made and the apparatus information. The apparatus information includes the apparatus ID of the image-forming apparatus 1.

Note that instead of sending the code notification including the code 201 to the image-forming apparatus 1 in S69, the user terminal 401 may send an unlock request including the code 201 to the management server 301 and send an ID sending request (which does not include the code 201) to the image-forming apparatus 1. In this case, in response to the ID sending request being received, the lock control unit 96 of the image-forming apparatus 1 sends the apparatus information including the apparatus ID of the image-forming apparatus 1 to the management server 301, as in S73 in FIG. 30.

The authentication unit 370 of the management server 301 starts the pre-refill authentication in response to the unlock request being received. In S71, the authentication unit 370 determines whether the refill pack 200 identified by the code 201 included in the unlock request is being managed in correspondence with the account of the logged-in user. This determination is made by referring to the delivered pack table 340. It is assumed here that the refill pack 200 is being managed in correspondence with the user account.

Next, in S74, the authentication unit 370 determines whether the image-forming apparatus 1 which is the refill target is being managed in correspondence with the user account of the logged-in user based on the apparatus ID included in the unlock request. This determination is made by referring to the apparatus registration table 330. It is assumed here that the image-forming apparatus 1 is being managed in correspondence with the user account.

In S75, the authentication unit 370 determines whether the refill pack 200 has not been used for at least a predetermined period. Here, the subject of the determination is the refill pack 200 that has already been assigned to the logged-in user, and for which the status is “Unused”. The predetermined period may be determined in advance according to the contract or the like, for example. For example, it is determined whether a period from the shipping date or the arrival date of the refill pack 200 to the present date is at least the predetermined period. Here, it is assumed that a refill pack 200 which is assigned to the user and which has not been used for at least the predetermined period is present.

In S76, the authentication unit 370 notifies the image-forming apparatus 1 of the presence of the unused refill pack 200. This notification may be called a warning notification. In response to receiving the notification, the processing circuit 90 of the image-forming apparatus 1 outputs a warning notification to the user through the user I/F 13, for example.

In S77, the processing circuit 90 outputs a message from the user I/F 13 to inquire whether the user consents to the use of the new refill pack 200, and accepts a user operation. When the user performs an operation indicating their consent in the user I/F 13, the sequence moves to S78.

In S78, the processing circuit 90 sends an unlock request to the management server 301. The unlock request may include information indicating, indirectly or directly, that the user has consented to the use of the new refill pack 200.

In S79, the authentication unit 370 confirms (recognizes) that the user has consented to the use of the new refill pack 200 by receiving the unlock request. In S80, the authentication unit 370 sends an unlock command to the image-forming apparatus 1. The unlock command is a command that causes the locking mechanism 52 of the image-forming apparatus 1 to unlock the opening and closing mechanism 51. Here, it is assumed that the user has consented to the use of the new refill pack 200. S81 to S85, which are processing steps performed after the unlock command has been sent, may be the same as in the first example illustrated in FIG. 30, and will therefore not be described again here.

### Summary of Fifth Embodiment

According to the fifth embodiment described in this section, an opening and closing mechanism capable of opening and closing a consumable material refill path from a holding device holding a consumable material consumed for image formation to an image-forming apparatus is provided in at least one of the holding device and the image-forming apparatus. A unique code is also assigned to the holding device that is to be used to refill the consumable material. The unique code is obtained by a terminal present in the user environment, and the obtained code is sent to a server apparatus in a remote environment. Authentication for permitting the refilling of the consumable material from the holding device is then performed by the server apparatus based on the aforementioned code.

When this authentication is successful, the consumable material refill path is opened by the opening and closing mechanism, or the opening and closing mechanism becomes capable of opening the refill path. Accordingly, the refilling of the consumable material can be permitted or prohibited in light of conditions not easily determined by the image-forming apparatus alone, such as the consistency of the correspondence between the holding device and the user account, the consistency of the correspondence between the apparatus to be refilled and the user account, or the like. In addition, in the above-described authentication, the unused refill pack 200 associated with the user is confirmed and the user is notified thereof. This makes it possible to reduce disadvantageous situations where the user cannot use the unused refill pack 200. For example, the user can recall the presence of the old unused refill pack 200, and the old unused refill pack 200 can be consumed preferentially over the new unused refill pack 200.

Additionally, according to the fifth embodiment, the aforementioned code that is unique to the holding device is an optically-readable code or a code which can be read visually by the user, printed on the device or the package thereof. Accordingly, the user can easily obtain the code using a user interface or a camera of the terminal. This eliminates the need to provide a memory for storing the code in each of the holding devices, which are consumed one after another, and this makes it possible to reduce the running costs borne by the user.

In the fifth embodiment, when the opening and closing mechanism 51 is to be unlocked, the user terminal 401 or the image-forming apparatus 1 provided in the user environment E1 sends an unlock request to the management server 301 provided in the remote environment. However, this is merely an example. After sending the code unique to the refill pack 200 to the management server 301, an authentication request for authenticating whether the refill pack 200 is registered in association with the user may be sent. The management server 301 may send the authentication result notification to the user terminal 401 or the image-forming apparatus 1 instead of the unlock command. Accordingly, it is determined whether either the user terminal 401 or the image-forming apparatus 1 is to unlock the opening and closing mechanism 51 based on the authentication result notification.

In the fifth embodiment, after refilling the toner from the refill pack 200, “Status” for the record corresponding to the refill pack 200 is changed from “Unused” to “Used” in the management server 301. The trigger for this change is not limited to the report on the remaining amount of toner. For example, the following notification may be employed as a trigger to change “Status”. The display device 415 of the user terminal 401 or the user I/F 13 provided in the image-forming apparatus 1 displays a message asking the user whether the refill is complete. When the refill is complete, the user operates either the input device 414 of the user terminal 401, or a hardware button included in the user I/F 13 or a software button displayed in the GUI of the image-forming apparatus 1. In response to the operation, the user terminal 401 or the image-forming apparatus 1 sends a refill complete notification to the management server 301. The management server 301 may use this notification as a trigger to change “Status”. Alternatively, the image-forming apparatus 1 may include a sensor that detects the position of the lever 111b. When the sensor detects that the lever 111b has returned to its original position, the image-forming apparatus 1 sends a notification to the management server 301. The management server 301 may use this notification as a trigger to change “Status”.

### Sixth Embodiment

### (Printing Management System)

The foregoing fifth embodiment described an example in which a code that is unique to the holding device is provided in a format that is optically readable or visually readable by the user. A sixth embodiment, described in this section, includes an example in which a code that is unique to the holding device is stored in a memory installed in the holding device.

### (System Overview)

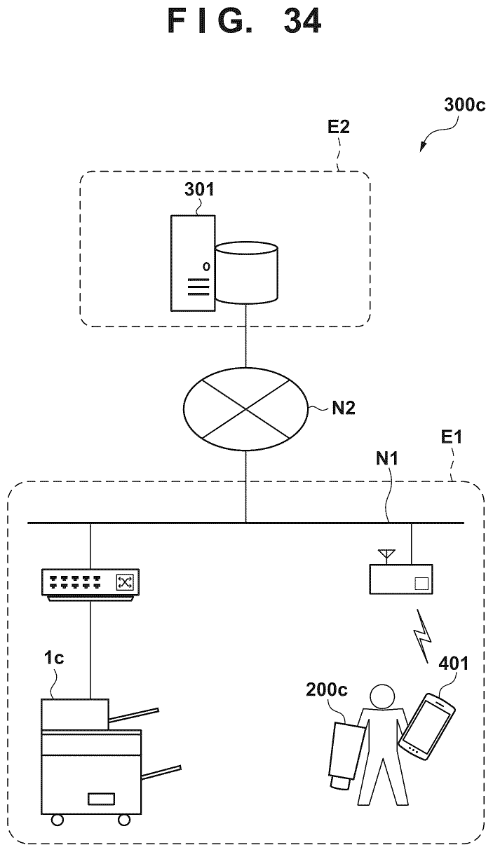

FIG. 34 is a schematic diagram illustrating an example of the configuration of a printing management system 300c according to the sixth embodiment. Referring to FIG. 34, the printing management system 300c includes an image-forming apparatus 1c, the management server 301, and the user terminal 401.

The image-forming apparatus 1c is installed in the user environment E1 in which a user is present. The user terminal 401 is also present in the user environment E1, and is owned by a user. The image-forming apparatus 1c and the user terminal 401 are connected to the local network N1, which can be a LAN, for example.

The user uses the image-forming apparatus 1c in the user environment E1. As described above, the image-forming apparatus 1c forms an image on a recording medium by consuming toner, which serves as a consumable material. When the toner preserved in the image-forming apparatus 1c is depleted, the user connects a refill pack 200c, which is a holding device that holds the toner, to the image-forming apparatus 1c, and refills the image-forming apparatus 1c with the toner from the refill pack 200c. In the present embodiment, each refill pack 200c is provided with a unique code for uniquely identifying that refill pack 200c. With the exception of including a memory chip (called a “memory tag” hereinafter) that stores the code assigned to the refill pack, the refill pack 200 may be configured in the same manner as the refill pack 200c described above. Aside from additionally including a configuration for reading the code from the memory tag of the refill pack 200c, the image-forming apparatus 1c may be configured in the same manner as the image-forming apparatus 1 described above.

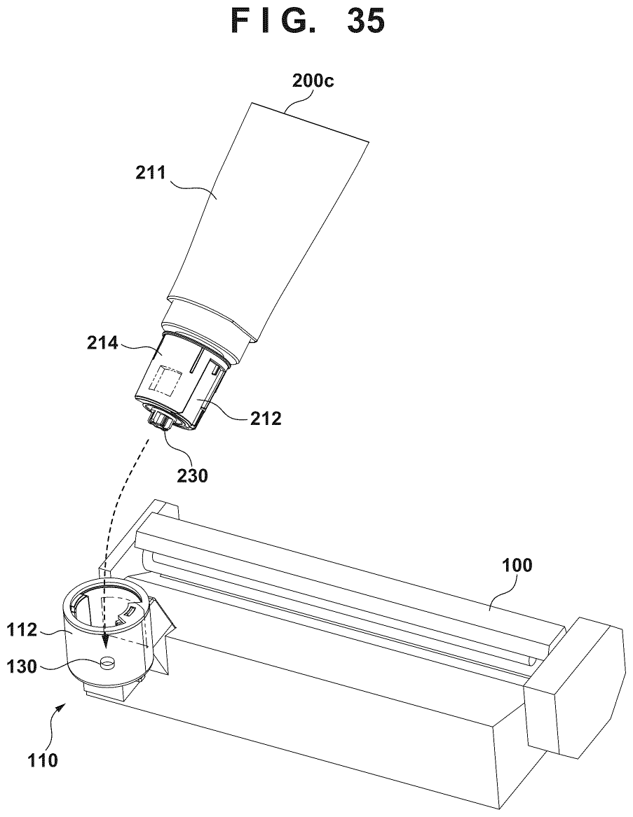

FIG. 35 is a schematic diagram illustrating a connection between the refill pack 200c and the image-forming apparatus 1c according to the present embodiment. As illustrated in FIG. 35, the refill pack 200c includes the holding part 211, the nozzle 212, the pack shutter 214, and a memory tag 230. The memory tag 230 is disposed, for example, at the tip of the nozzle 212. On the other hand, a tag terminal 130 is disposed on a bottom surface of the cylindrical member 112 of the toner receiving unit 110 of the image-forming apparatus 1c. The tag terminal 130 makes electrical contact with an output terminal of the memory tag 230 when the refill pack 200c is connected to the toner receiving unit 110. The image-forming apparatus 1c can read out information stored in the memory tag 230 of the refill pack 200c through the electrical contact between these terminals.

### (Example of Configuration of Image-Forming Apparatus)

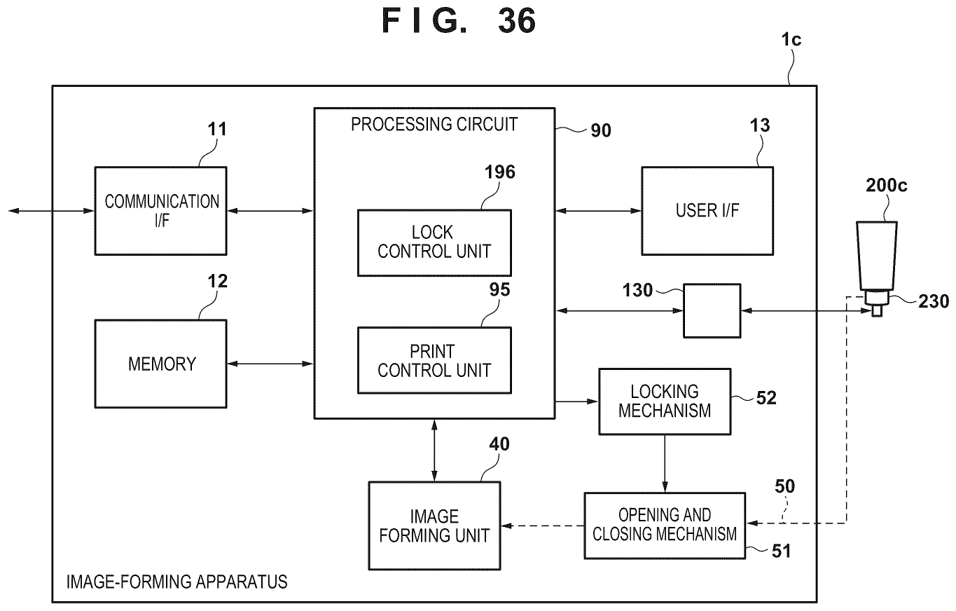

FIG. 36 is a block diagram illustrating an example of the functional configuration of the image-forming apparatus 1c according to the present embodiment. Referring to FIG. 36, the image-forming apparatus 1c includes the communication I/F 11, the memory 12, the user I/F 13, the image-forming unit 40, the opening and closing mechanism 51, the locking mechanism 52, the processing circuit 90, and the tag terminal 130. From a functional perspective, the processing circuit 90 can function mainly as the print control unit 95 and a lock control unit 196.

Like the lock control unit 96 of the image-forming apparatus 1 according to the fifth embodiment, the lock control unit 196 controls the locking and unlocking of the opening and closing mechanism 51 by the locking mechanism 52. Only the differences between the lock control unit 96 and the lock control unit 196 will be described here.

Upon the connection of the refill pack 200c being detected (e.g., using a sensor (not shown)), the lock control unit 196 reads out the code unique to the refill pack 200c from the memory tag 230 of the refill pack 200c through the tag terminal 130. The lock control unit 196 also reads out the apparatus ID that uniquely identifies the image-forming apparatus 1c from the memory 12. The lock control unit 196 then sends an unlock request, including the code unique to the refill pack 200c and the apparatus ID of the image-forming apparatus 1c, to the management server 301 via the communication I/F 11. Prior to the sending of the unlock request or after the sending of the unlock request, the user inputs the user ID and password through the user I/F 13, and logs into the system when the user authentication is successful. The management server 301 executes the pre-refill authentication described above using the user ID of the logged-in user, as well as the code and the apparatus ID received from the image-forming apparatus 1c.

After sending the apparatus ID to the management server 301 for the pre-refill authentication, the lock control unit 196 receives the unlock command, which is a control signal based on the result of the pre-refill authentication, over a predetermined standby period. Then, if the unlock command is received before the standby period ends, the lock control unit 196 causes the locking mechanism 52 to unlock the opening and closing mechanism 51 in accordance with the unlock command. If the standby period ends without the command being received from the management server 301, the lock control unit 196 stops standing by for the command.

### (Flow of Processing)

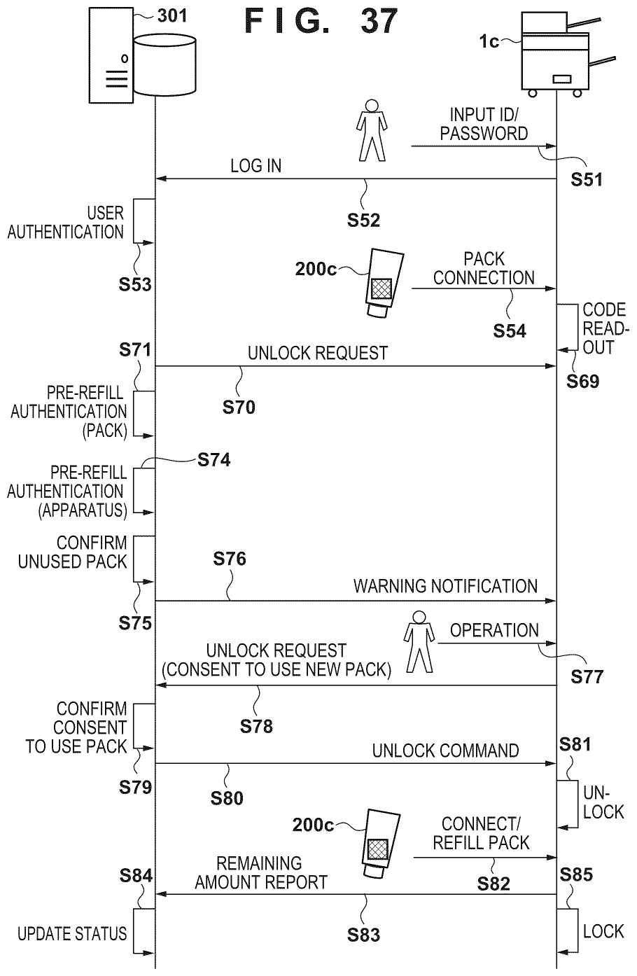

FIG. 37 is a sequence chart illustrating an example of the overall flow of processing when refilling the consumable material according to the present embodiment. The sequence illustrated in FIG. 37 mainly involves the image-forming apparatus 1c and the management server 301. Note that the unused new refill pack 200 is assumed to have been delivered to the user environment E1 prior to the start of the sequence.

First, in S51, the user inputs the user ID and password in the login screen provided by the user I/F 13 of the image-forming apparatus 1c, for example. In S52, the lock control unit 196 sends the input user ID and password to the management server 301 in order to log in. In S53, the authentication unit 370 of the management server 301 executes user authentication based on the user ID and password received from the image-forming apparatus 1c. It is assumed here that the user authentication is successful and the login to the system is established. The subsequent processing illustrated in FIG. 37 is performed while the login session continues.

In S54, the refill pack 200c is connected to the image-forming apparatus 1c by the user, and that connection is detected by the lock control unit 196. Next, in S55, the lock control unit 196 reads out the code unique to the refill pack 200c from the memory tag 230 of the refill pack 200c through the tag terminal 130. Next, in S70, the lock control unit 196 sends an unlock request, which can include the code read out from the memory tag 230 and the apparatus information including the apparatus ID of the image-forming apparatus 1, to the management server 301.

The authentication unit 370 of the management server 301 starts the pre-refill authentication in response to the unlock request being received. In S71, the authentication unit 370 determines whether the refill pack 200c identified by the code included in the unlock request is being managed in correspondence with the account of the logged-in user by referring to the delivered pack table 340. It is assumed here that the refill pack 200c is being managed in correspondence with the user account. Next, in S74, the authentication unit 370 determines whether the image-forming apparatus 1c is being managed in correspondence with the user account of the logged-in user by referring to the apparatus registration table 330 based on the apparatus ID included in the unlock request. In S75, the authentication unit 370 determines whether the refill pack 200c has not been used for at least a predetermined period. The subject of the determination is the refill pack 200c, which is a refill pack 200 already assigned to the logged-in user, and for which the status is “Unused”. The predetermined period may be determined in advance according to the contract or the like, for example. Here, it is assumed that a refill pack 200c which is assigned to the user and which has not been used for the predetermined period is present.

In S75, the authentication unit 370 determines whether the refill pack 200 has not been used for at least a predetermined period. Here, the subject of the determination is the refill pack 200 that has already been assigned to the logged-in user, and for which the status is “Unused”. The predetermined period may be determined in advance according to the contract or the like, for example. For example, it is determined whether a period from the shipping date or the arrival date of the refill pack 200 to the present date is at least the predetermined period. Here, it is assumed that a refill pack 200 which is assigned to the user and which has not been used for at least the predetermined period is present.

In S76, the authentication unit 370 notifies the image-forming apparatus 1 of the presence of the unused refill pack 200. This notification may be called a warning notification. In response to receiving the notification, the processing circuit 90 of the image-forming apparatus 1 outputs a warning notification to the user through the user I/F 13, for example.

In S77, the processing circuit 90 outputs a message from the user I/F 13 to inquire whether the user consents to the use of the new refill pack 200, and accepts a user operation. When the user performs an operation indicating their consent in the user I/F 13, the sequence moves to S78.

In S78, the processing circuit 90 sends an unlock request to the management server 301. The unlock request may include information indicating, indirectly or directly, that the user has consented to the use of the new refill pack 200.

In S79, the authentication unit 370 confirms (recognizes) that the user has consented to the use of the new refill pack 200 by receiving the unlock request. In S80, the authentication unit 370 sends an unlock command to the image-forming apparatus 1. The unlock command is a command that causes the locking mechanism 52 of the image-forming apparatus 1 to unlock the opening and closing mechanism 51. Here, it is assumed that the user has consented to the use of the new refill pack 200. S81 to S85, which are processing steps performed after the unlock command has been sent, may be the same as in the first example illustrated in FIG. 30, and will therefore not be described again here.

### Summary of Sixth Embodiment

According to the sixth embodiment described in this section, an opening and closing mechanism capable of opening and closing a consumable material refill path from a holding device holding a consumable material consumed for image formation to an image-forming apparatus is provided in at least one of the holding device and the image-forming apparatus. A unique code is also assigned to the holding device that is to be used to refill the consumable material. A unique code is read out to the image-forming apparatus, and the read-out code is sent to the server apparatus in the remote environment. Authentication for permitting the refilling of the image-forming apparatus with the consumable material from the holding device is then performed by the server apparatus based on the aforementioned code.

When this authentication is successful, the consumable material refill path is opened by the opening and closing mechanism, or the opening and closing mechanism becomes capable of opening the refill path. The consistency (legitimacy) of the correspondence between the holding device and the user account, the consistency (legitimacy) of the correspondence between the image-forming apparatus and the user account, or the like are conditions which are not easily determined by the image-forming apparatus. The refilling of the consumable material can be permitted or prohibited by the server apparatus in light of such difficult conditions. In addition, in the above-described authentication, the unused refill pack 200 associated with the user is confirmed and the user is notified thereof. This makes it possible to reduce disadvantageous situations where the user cannot use the unused refill pack 200. For example, the user can recall the presence of the old unused refill pack 200, and the old unused refill pack 200 can be consumed preferentially over the new unused refill pack 200.

In the sixth embodiment, when the opening and closing mechanism 51 is to be unlocked, the image-forming apparatus 1c provided in the user environment E1 sends an unlock request to the management server 301 provided in the remote environment. However, this is merely an example. After sending the code unique to the refill pack 200c to the management server 301, an authentication request for authenticating whether the refill pack 200c is registered in association with the user may be sent. The management server 301 may send the authentication result notification to the image-forming apparatus 1c instead of the unlock command. Accordingly, it is determined whether the image-forming apparatus 1c is to unlock the opening and closing mechanism 51 based on that notification.

In the sixth embodiment, after refilling the toner from the refill pack 200c, “Status” for the record corresponding to that pack is changed to “Used” in the management server 301. The trigger for this change may be a trigger different from the report on the remaining amount of toner. For example, the following notification may be employed as a trigger to change “Status”. The display device 415 of the user terminal 401 or the user I/F 13 provided in the image-forming apparatus 1c displays a message asking the user whether the refill is complete. When the refill is complete, the user operates either the input device 414 of the user terminal 401, or a hardware button included in the user I/F 13 or a software button displayed in the GUI of the image-forming apparatus 1c. In response to the operation, the user terminal 401 or the image-forming apparatus 1c sends a refill complete notification to the management server 301. The management server 301 may use this notification as a trigger to change “Status”. Alternatively, the image-forming apparatus 1 may include a sensor that detects the position of the lever 111b. When the sensor detects that the lever 111b has returned to its original position, the image-forming apparatus 1 sends a notification to the management server 301. The management server 301 may use this notification as a trigger to change “Status”.

The first and sixth embodiments described in the present specification, as well as the various examples and variations, may be combined with each other in any way. The features described in connection with a given example, and the effects thereof, are applicable to any embodiment, example, and variation unless explicitly stated otherwise.

### (Example of GUI)

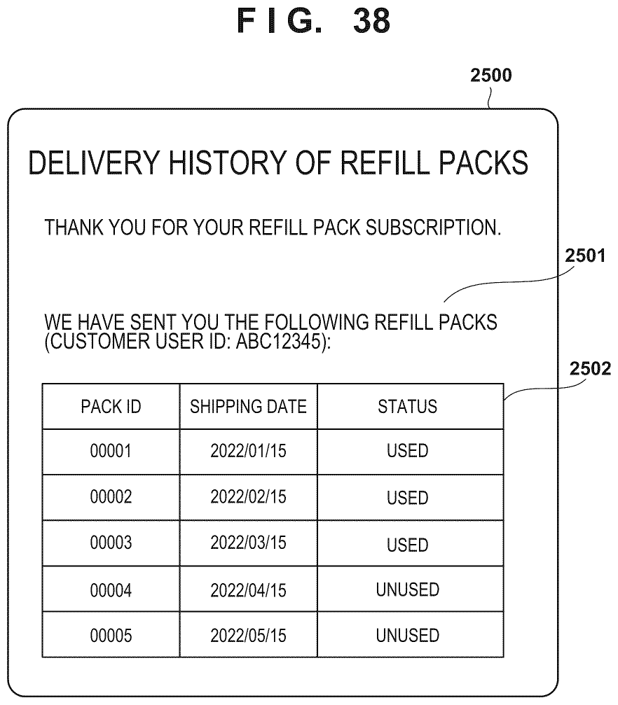

FIG. 38 illustrates an example of a GUI 2500 displayed when a user logs in to the management server 301 through the user terminal 401 or the image-forming apparatus 1. The GUI 2500 primarily includes information pertaining to the delivery history of refill packs. Account information 2501 includes the user ID or username of the user who has successfully logged in. A delivery history 2502 includes the pack ID, the shipping date, and the status of the refill packs 200 associated with the user ID of the logged-in user in the management DB 313.

In this example, the user has connected a new unused refill pack 200 (pack ID=00005) to the image-forming apparatus 1, and the authentication has been executed by the management server 301. In addition, there are a plurality of refill packs 200 (pack IDs=000001 to 00004) that were shipped earlier than the new unused refill pack 200 (pack ID=00005). Of the old refill packs 200 (pack IDs=00001 to 00004), the status of three refill packs 200 (pack IDs=00001 to 00003) is “Used”. On the other hand, the status of the refill pack 200 (pack ID=00004) is “Unused”. As a result, the authentication of the new unused refill pack 200 (pack ID=00005) fails. In this manner, when the authentication of the new unused refill pack 200 (pack ID=00005) fails, the GUI 2500 may be displayed in the user terminal 401 or the image-forming apparatus 1 as the authentication result.

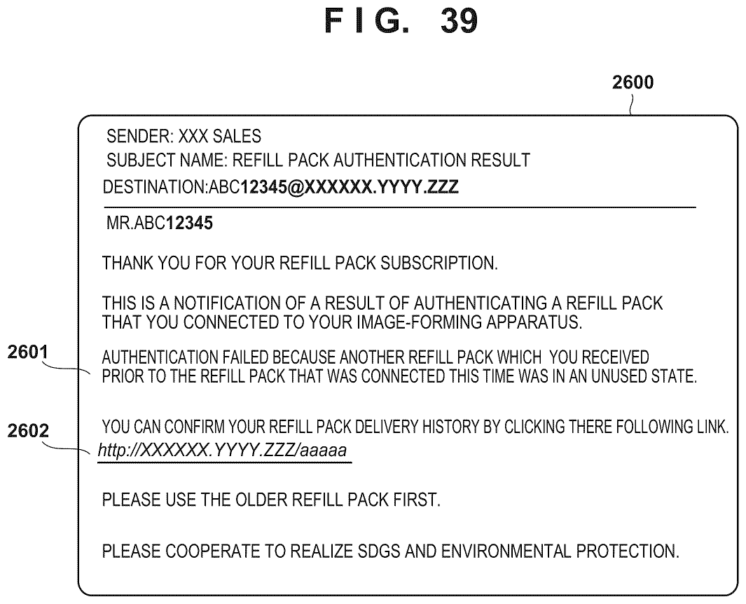

FIG. 39 illustrates an example of an email 2600 for notifying the user of the authentication result. It is assumed that the account table 320 described with reference to FIG. 10 holds a user ID, a username, and an email address. The authentication unit 370 executes authentication on the new refill pack 200 and notifies the user of the authentication result by the email 2600. The email 2600 includes an authentication result 2601 and a link 2602. The link 2602 may include, for example, a URL address of a web page describing the details of the authentication result. The web page may provide the GUI 2500 illustrated as an example in FIG. 38. In other words, the GUI 2500 can be displayed in the user terminal 401 by the user clicking the link 2602. By viewing the GUI 2500, the user will likely notice that another refill pack 200 that has been delivered in the past and is in an unused state is present. Accordingly, the user removes the new refill pack 200 (pack ID=00005) from the image-forming apparatus 1 and connects the other, older refill pack 200 (pack ID=00004) to the image-forming apparatus 1. This results in the other, older refill pack 200 to be successfully authenticated in the sequence described above. When authenticating the other, older refill pack 200 (pack ID=00004), the authentication unit 370 determines whether yet another refill pack 200 in an unused state is present based on the shipping date of the other, older refill pack 200 (pack ID=00004). In other words, the authentication unit 370 excludes the new refill pack 200 (pack ID=00005), and searches for and counts the refill packs 200 in an unused state. As a result, one refill pack 200 (pack ID=00004) is extracted or identified as a refill pack 200 in an unused state, and thus the authentication of the refill pack 200 (pack ID=00004) is successful.

### Other Embodiments

The foregoing embodiments can also be realized as processing executed by supplying a program implementing one or more of the above-described functions to a system or apparatus over a network or by a storage medium and then causing one or more processors of a computer of the system or apparatus to read out and execute the program. The embodiments can also be implemented by a circuit (e.g., an ASIC) for implementing one or more functions.

(Technical Spirit Derived from Embodiments)

### [Aspect A1]

The camera 413, the input device 414, and the user I/F 13 are an example of an obtaining unit, present in a user environment, that obtains a unique code assigned to a holding device that holds a consumable material consumed to form images. The opening and closing mechanism 51 is an example of an opening and closing mechanism which is capable of opening and closing a refill path of the consumable material from the holding device to the image-forming apparatus, and which is provided in at least one of the holding device and the image-forming apparatus. The management server 301 is an example of a server apparatus, present in a remote environment, that, based on the code of the holding device obtained by the obtaining unit, executes authentication of the holding device. The processing circuit 90 is an example of a control unit, present in the user environment, that, when the authentication of the holding device by the server apparatus succeeds, causes the opening and closing mechanism to open the refill path of the consumable material or enables the refill path to be opened by the opening and closing mechanism. The management server 301 may determine that the holding device is in an unused state and another holding device delivered to a user of the image-forming apparatus before the holding device is also in an unused state. In other words, both the holding device delivered earlier and the holding device delivered later may be in an unused state. In this case, the authentication of the holding device fails. In response to the authentication of the holding device by the server apparatus failing, the processing circuit 90 does not cause the opening and closing mechanism to open the refill path of the consumable material or does not permit the refill path to be opened by the opening and closing mechanism. This makes it possible to prevent the user from forgetting the existence of a refill pack 200 that was delivered earlier and using a pack that was delivered later. In other words, it is possible to encourage a user to consume a consumable material delivered earlier in preference to a consumable material delivered later.

### [Aspect A2]

The management server 301 receives the account information of the user (e.g., the user ID). The authentication performed by the management server 301 includes determining whether the code of the holding device (e.g., the pack ID) is associated with the account information. The authentication also includes determining whether a status of the holding device associated with the code indicates the unused state. The status indicates whether the holding device is in an unused state. The authentication also includes determining whether the other holding device associated with the account information indicates the unused state. This makes it possible to accurately determine the status of the refill pack 200 associated with the user.

### [Aspect A3]

The management DB 313 may function as a database that manages the account information of each of users, the codes of holding devices delivered to each of the users, and statuses of the holding devices in association with each other. The management server 301 will be able to accurately execute the authentication of the holding device by referring to the database.

### [Aspects A4 and A5]

The authentication performed by the management server 301 includes determining that the authentication of the holding device has failed when at least two codes of a holding device in an unused state are associated with the account information of the user in the database. In other words, the authentication can include counting a total number of a plurality of holding devices in an unused state that are associated with the account information of the user in the database, and determining that the authentication of the holding device has succeeded when the total number is less than a threshold. Note that since the codes are unique codes that differ for each holding device, the number of codes basically matches the number of holding devices. Having more than a predetermined number of refill packs 200 in an unused state is thought to lead to a higher impact on the environment. Furthermore, using older refill packs 200 first is also advantageous for the user. Accordingly, the threshold may also be determined from the perspective of environmental protection and the like.

### [Aspect A6]

The authentication performed by the server apparatus may include specifying the other holding device, among holding devices identified by the codes associated with the account information of the user in the database, based on unused periods of the holding devices. As described above, the management DB 313 manages a plurality of holding devices in association with the user. The management DB 313 can also manage the unused period of each holding device. Accordingly, by focusing on the unused period, an unused refill pack 200 that is in an unused state and impacts the environment may be identified.

### [Aspect A7]

In the management DB 313, a registration period (e.g., the shipping date), which is a period in which the code of each holding device delivered to the user is registered in the database, may be registered in association with the code of the holding device. The management server 301 may obtain the registration period for the other holding device from the database, and then obtain the unused period from the registration period. Furthermore, the management server 301 may determine whether the unused period of the other holding device is at least a predetermined period. If the unused period for the other holding device is at least the predetermined period, the authentication of the holding device fails. In this manner, by focusing on the unused period, an unused refill pack 200 that is in an unused state and impacts the environment may be identified.

### [Aspect A8]

When an event that triggers the delivery or sending of the holding device to the user occurs, the management server 301 may register the account information of the user and the registration period of the holding device in the database. Such an event may be, for example, the purchase of the holding device by the user, the arrival of a provision timing based on a contract with the user, or the detection of a decrease in the remaining amount of the consumable material in the image-forming apparatus registered as an apparatus of the user. In addition, such an event may be reaching a threshold of the number of times the image-forming apparatus registered as an apparatus of the user has been operated, or detecting the use of a holding device provided to the user in the past.

### [Aspects A9 to 11]

The printing management system may include an output unit (notifying unit) for notifying the user of an authentication result of the authentication. The output unit (e.g., the user I/F 13) may be included in the image-forming apparatus. Through the user I/F 13, the image-forming apparatus may receive the authentication result from the server apparatus and notify the user of the authentication result through the user interface of the image-forming apparatus. The output unit (e.g., the display device 415) may be included in the user terminal used by the user. The user terminal receives the authentication result from the server apparatus, and notifies the user of the authentication result through the user interface of the user terminal. If the authentication result indicates that the authentication has failed, the user will likely be able to recall that an older refill pack 200 in the unused state is present. As a result, the user will likely be able to recognize that they should use the older refill pack 200 in the unused state first.

### [Aspect A12]

Even after the user has been notified that another unused holding device is present in addition to a new unused holding device, the user may nevertheless wish to use the new unused holding device. In this case, the processing circuit 90 may cause the opening and closing mechanism 51 to open the refill path of the consumable material or permit the refill path to be opened by the opening and closing mechanism 51. This will make it possible to reflect the individual circumstances of the user. For example, the user may have lost the other holding device in the unused state and cannot find that holding device. In such a case, the usability will be improved by permitting the use of the new holding device in an unused state.

### [Aspects A13 to A15]

The output unit (e.g., the display device 415, the user I/F 13) may output a message inquiring with the user as to whether the user wishes to use the new holding device in an unused state. Additionally, the user wishing to use the holding device may be input through a user interface (e.g., the user I/F 13) of the image-forming apparatus. Likewise, the user wishing to use the new holding device in an unused state may be input through the user terminal 401 used by the user.

### [Aspect A16]

According to the foregoing embodiments, a printing control method for controlling refilling of an image-forming apparatus with a consumable material from a holding device that holds the consumable material, the consumable material being consumed to form images, is also provided.

### [Aspect A17]

According to the foregoing embodiments, the image-forming apparatuses 1 and 1c including the processing circuit 90 are provided. There are situations where the holding device authentication fails due to the holding device identified by the code being in an unused state and another holding device delivered to a user of the image-forming apparatus before the holding device also being in an unused state. In this case, the processing circuit 90 does not cause the opening and closing mechanism to open the refill path or permit the refill path to be opened by the opening and closing mechanism. On the other hand, there are situations where the holding device authentication succeeds due to the holding device being in an unused state and the other holding device not being in an unused state. In this case, the processing circuit 90 causes the opening and closing mechanism to open the refill path or permits the refill path to be opened by the opening and closing mechanism.

### [Aspect A18]

According to the foregoing embodiments, the management server 301 for managing refilling of an image-forming apparatus with a consumable material from a holding device that holds the consumable material, the consumable material being consumed to form images, is provided. The processing circuit 314 receives a unique code assigned to the holding device through the communication interface, from an apparatus present in the user environment. The processing circuit 314 executes authentication for the holding device based on the code received. There are situations where the holding device authentication fails due to the holding device identified by the code being in an unused state and another holding device delivered to a user of the image-forming apparatus before the holding device also being in an unused state. In this case, the processing circuit 314 does not cause the opening and closing mechanism 51 to open the refill path or permit the refill path to be opened by the opening and closing mechanism 51. There are situations where the holding device authentication succeeds due to the holding device being in an unused state and the other holding device not being in an unused state. In this case, the processing circuit 314 causes the opening and closing mechanism 51 to open the refill path or permits the refill path to be opened by the opening and closing mechanism 51.

### Seventh Embodiment

Japanese Patent Laid-Open No. 2017-049767 proposes that, when a user enters into a contract for an ink cartridge delivery service, an ink cartridge is automatically shipped in response to the remaining amount of ink falling below a threshold. Japanese Patent Laid-Open No. 2017-049767 also mentions flat-rate printing. The “flat-rate printing” refers to a contract structure in which the user can execute printing processing for up to 200 sheets per month, and ink cartridges are automatically shipped.

When a user enters into a contract for a flat-rate service (referred to as a “subscription”), a refill pack containing a consumable material is automatically delivered to the user. This is convenient for the user. Authentication processing is performed for the refill pack to manage whether the refill pack provided to the user under the subscription has been properly used by the user. Specifically, when the refill pack is successfully authenticated, the refilling of the image-forming apparatus with the consumable material from the refill pack is permitted (unlocked), and when the authentication fails, the refilling of the consumable material is prohibited (locked).

Here, if the consumable material cannot be refilled unless the authentication processing is carried out despite the subscription contract already having been canceled, the situation will be troublesome for the user who canceled the contract. Accordingly, requiring the user to constantly perform authentication processing for refill packs reduces the usability.

Accordingly, the present invention makes it possible to control the refilling of a consumable material from a refill pack in accordance with the contract status of a user.

Incidentally, the contract system (subscription system) is a service in which the user can use the consumable material at a flat rate for a certain period of time by entering into a contract with the company selling the consumable material, for example. The remaining amount of toner estimated by the remaining amount detection unit 61 of the image-forming apparatus 1 is sent to the management server 301 sequentially. The management server 301 predicts the time when the toner held in the preserving container 48 will be depleted based on a change in the remaining amount of toner. The management server 301 sends a subscription-specific refill pack 200 (called a “dedicated refill pack” hereinafter) to the user so that the refill pack 200 reaches the user before the time when the toner will be depleted. The management server 301 permits (unlocks) the refilling of the consumable material from the dedicated refill pack 200 by authenticating the dedicated refill pack 200 that has been or will be connected to the image-forming apparatus 1. If the authentication of the refill pack 200 fails, the management server 301 prohibits (locks) the refilling of the consumable material from the refill pack 200.

Unlike the subscription-specific refill pack 200, there are also refill packs 200 for non-subscribers that are available to users who have not entered into a subscription contract. Refill packs 200 for non-subscribers are also available through legitimate commercial channels. If the authentication processing is performed for a non-subscriber refill pack 200, the lock will not be released, and the user will not be able to use the non-subscriber refill pack 200. Accordingly, in the present embodiment, the management server 301 skips or disables the authentication processing for a non-subscriber refill pack 200. This enables the user to use legitimate non-subscriber refill packs 200.

Note that the user may switch the contract type held in the management server 301 in order for a subscriber to the subscription to use a legitimate non-subscriber refill pack 200. Through this, the subscriber to the subscription may cancel the contract, become a non-subscriber, and use a legitimate non-subscriber refill pack 200. In other words, in the present embodiment, switching the contract type (contract information) makes it possible to switch the operating mode (locking condition) of the opening and closing mechanism associated with the refill pack 200 in the image-forming apparatus 1.

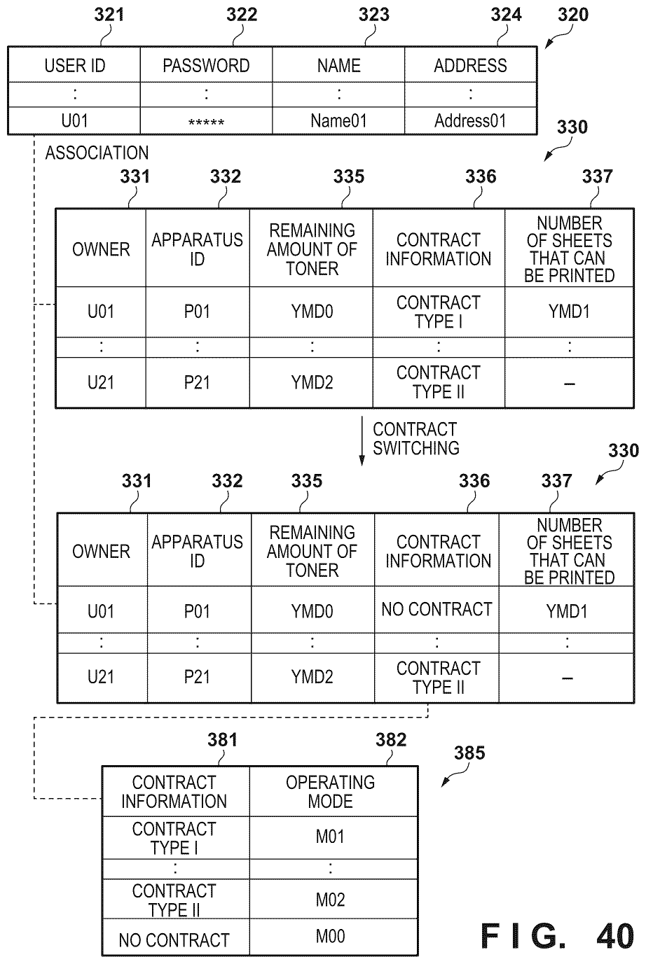

The account table 320 is a table that holds information pertaining to the accounts of users that use the refill pack 200 provided by the printing management system 300. As illustrated in FIG. 40, the account table 320 can include the following information items, for example:
User ID 321
Password 322
Name 323
Address 324

Here, User ID 321 is identification information for uniquely identifying each user account. Password 322 is used in user authentication when the user logs into the system. Name 323 refers to the username of each account. The username can be displayed on the screen after logging in, for example, used as a destination name during delivery of the refill pack 200, and the like. Address 324 can be used as a destination when delivering the refill pack 200.

The apparatus registration table 330 is a table that holds information pertaining to the image-forming apparatuses registered in the printing management system 300 as apparatuses of the respective users. As illustrated in FIG. 40, the apparatus registration table 330 can include the following information items, for example:
Owner 331
Apparatus ID 332
Remaining amount of toner 335
Contract information 336
Number of sheets that can be printed 337

Here, Owner 331 indicates the account of the user who owns or manages the image-forming apparatus as “User ID” registered in the account table 320. Apparatus ID 332 is identification information for uniquely identifying each image-forming apparatus. A pair constituted by Owner 331 and Apparatus ID 332 indicates an association between each user account and at least one image-forming apparatus registered as an apparatus for the user who owns that account. Two or more image-forming apparatuses may be associated with a single user account. Remaining amount of toner 335 indicates the latest value for the remaining amount of toner as detected by and reported from the image-forming apparatus. For example, Remaining amount of toner 335 may be expressed as a percentage. Contract information 336 refers to the type of contract that each user has entered into with the business operator that operates the printing management system 300, for example. Contract information 336 may include, for example, information indicating the maximum number of sheets that can be printed at a flat rate each month. For example, Contract type I indicates a contract under which up to 50 sheets can be printed per month. Contract information 336 may include information indicating whether authentication is required to unlock the opening and closing mechanism (an unlocking condition). Contract information 336 may further include information indicating an update interval for the maximum number of sheets that can be printed (e.g., one month). Number of sheets that can be printed 337 indicates the remaining number of images (recording media) that can be printed in the update interval (period). If the pre-refill authentication for the refill pack 200 is successful, the pre-printing authentication (described later) may be executed. “Pre-printing authentication” refers to determining whether the number of sheets that can be printed in each update interval specified by the contract does not exceed the actual number of sheets printed. For example, if the maximum number of sheets that can be printed per month for an image-forming apparatus 1 is 5000 sheets, the pre-printing authentication will succeed if the actual number of sheets printed by the user that month is less than 5000 sheets. In this manner, the subscription contract may be differentiated for each image forming apparatus, or may be differentiated for each user. A case where the subscription contract is differentiated for each image forming apparatus will be described hereinafter. Accordingly, Number of sheets that can be printed 337 is included in the apparatus registration table 330. If the subscription contract is differentiated for each user, Number of sheets that can be printed 337 is associated with User ID 321 and may therefore be included in the account table 320.

The print data table 340 is a table that holds a list of files that each user is attempting to print. The print data table 340 can include at least one of the following information items, for example:
“Owner”
“Filename”

Here, “Owner” indicates the account of the user who owns the file as User ID 321 registered in the account table 320. “Filename” indicates a file to be printed, which is temporarily saved in the memory 312. A plurality of “Filenames” may be associated with one “Owner.”

The data management unit 350 updates the management DB 313 in conjunction with other functions provided by the processing circuit 314. For example, in the present embodiment, the data management unit 350 also manages the updating of the values of Number of sheets that can be printed 337 and Remaining amount of toner 335 in the apparatus registration table 330, in conjunction with the authentication unit 370. Unless otherwise mentioned hereafter, the data management unit 350 is used when the processing circuit 314 updates the management DB 313.

The data management unit 350 may add the value of Number of sheets that can be printed 337 in each of predetermined periods based on the contract details indicated by Contract information 336 in the apparatus registration table 330. For example, it is assumed that the contract type indicated by Contract information 336 is a contract type under which up to 50 sheets can be printed every month and the unused amount for the current month is carried over to the next month. In this case, a predetermined number of sheets (e.g. 50 sheets) is added to the value of Number of sheets that can be printed 337 (a number of sheets carried over) on the contract renewal date of each month.

The data management unit 350 receives, from a registered image-forming apparatus 1, remaining amount information pertaining to the remaining amount of the consumable material in the preserving container 48 of the apparatus, through the communication I/F 311. The data management unit 350 then updates status information pertaining to the remaining amount of the consumable material, i.e., the value of Remaining amount of toner 335 in the apparatus registration table 330, based on the received remaining amount information.

The provision management unit 360 manages the provision of a subscriber refill pack 200 to the user of the printing management system 300. For example, when the value of Remaining amount of toner 335 in the apparatus registration table 330 drops below a predetermined value, the provision management unit 360 sends a subscriber refill pack 200 to the address registered in the account table 320. However, the provision timing is not limited thereto. For example, the provision management unit 360 may determine a sending timing based on a change in Remaining amount of toner 335 in the apparatus registration table 330.

In addition to user authentication (e.g., password authentication), the authentication unit 370 executes authentication for permitting refilling for the refill pack 200 from which the user is attempting to refill the toner (called “pre-refill authentication” hereinafter). The user authentication is authentication processing requested for a user who is attempting to log in to the system. Furthermore, the authentication unit 370 may execute authentication for permitting the user to print before an image is printed onto the recording medium (called “pre-printing authentication” hereinafter). The pre-printing authentication is processing for confirming that the total number of sheets printed by the user in the contract period is less than a maximum number of sheets in the contract period.

The camera 413 is a module capable of capturing images or video of a subject. In the present embodiment, the camera 413 is used for optically reading the code 201 unique to the refill pack 200. In other words, the code 201 is printed on the surface of the holding part 211 of the refill pack 200, or on the package of the refill pack 200, in a format that can be read visually by the user or optically by the user terminal 401. The optically-readable format may include a format such as a one-dimensional barcode or a two-dimensional QR code (registered trademark), for example. In the present example, the code 201 directly includes type information indicating whether the refill pack 200 is a subscriber refill pack or a non-subscriber refill pack, capacity information of the refill pack 200, and the like. However, the code 201 need not directly include the type information and capacity information, and may instead include indirect data, such as a serial number, for association with type information and capacity information centrally managed by the management server 301, for example. The code 201 may also be encrypted data that is assumed to be decrypted by the management server 301.

### (Example of Configuration of Image-Forming Apparatus)

FIG. 12 is a block diagram illustrating an example of the functional configuration of the image-forming apparatus 1 according to the present embodiment. Referring to FIG. 12, the image-forming apparatus 1 includes the communication I/F 11, the memory 12, the user I/F 13, the image-forming unit 40, the opening and closing mechanism 51, the locking mechanism 52, and the processing circuit 90.

### (Example of Pre-Refill Authentication)

FIG. 13 is a sequence chart illustrating an example of the overall flow of processing performed when refilling the consumable material. The sequence illustrated in FIG. 13 mainly involves the image-forming apparatus 1, the management server 301, and the user terminal 401. Prior to the start of the sequence, the user is in possession of a new, unused refill pack 200 which is a refill pack 200 for a subscriber or for a non-subscriber. In the following descriptions, an “S” at the beginning of the reference signs stands for “step”.

In S60, the user inputs the user ID and password in the login screen. In S61, the application unit 440 of the user terminal 401 sends the input user ID and password to the management server 301.

In S62, the authentication unit 370 of the management server 301 executes user authentication for the user ID and password received from the user terminal 401. The user authentication includes determining whether the user ID and password received from the user terminal 401 match a user ID and password held in the account table 320. It is assumed here that the user authentication is successful and the login to the printing management system 300 is established. The subsequent processing illustrated in FIG. 13 is executed while the login session continues.

In S65, the application unit 440 starts the code obtainment unit 430 in response to an operation made by the user. The code obtainment unit 430 obtains the unique code 201 assigned to the refill pack 200 by, for example, optically reading the code using the camera 413, or by accepting a user input.

In S66, the application unit 440 sends an unlock request, including the code 201 obtained by the code obtainment unit 430, to the management server 301. The authentication unit 370 of the management server 301 starts the pre-refill authentication in response to the unlock request being received.

S67 is a first stage of the pre-refill authentication. In S67, the authentication unit 370 checks the legitimacy of the code 201 included in the unlock request. The legitimacy check may include, for example, determining whether the encrypted unique code 201 can be decrypted. Alternatively, the check may include determining whether a predetermined type of data is present in the code 201. A “type code” is identification information that makes it possible to differentiate a subscriber refill pack 200 from a non-subscriber refill pack 200, for example. If the first stage of the authentication succeeds, the sequence moves to step S68. Here, it is assumed that the first stage of authentication has succeeded.

In S68, the authentication unit 370 instructs the application unit 440 to display a message prompting a predetermined operation to be performed in the apparatus to be refilled. The application unit 440 displays the message in the display device 415 in response to the instruction.

In S72, in response to the message, the user performs the predetermined operation through the user I/F 13 of the image-forming apparatus 1 that is the apparatus to be refilled. The predetermined operation is, for example, a user input instructing the apparatus to be authenticated.

In S73, the lock control unit 96 reads out the apparatus ID from the memory 12 and sends the apparatus information, including the read-out apparatus ID, to the management server 301. Upon receiving the apparatus information, the management server 301 starts the apparatus authentication, which is the second stage of the pre-refill authentication.

In S74, the authentication unit 370 determines whether the image-forming apparatus 1 to be refilled is properly associated with the user account of the logged-in user based on the apparatus ID included in the received apparatus information. For example, the authentication unit 370 determines the legitimacy of the received apparatus ID based on whether the apparatus ID is registered in the apparatus registration table 330. As illustrated in FIG. 40, in the apparatus registration table 330, the apparatus ID is associated with the user ID of the owner. Accordingly, the legitimacy of the apparatus ID can be checked by referring to the apparatus registration table 330. Here, the image-forming apparatus 1 is properly associated with the user account, and the second stage of the authentication is therefore also successful.

In S74a, the authentication unit 370 notifies the user terminal 401 of the authentication result, namely that the pre-refill authentication is successful. In S80, the authentication unit 370 sends an unlock command to the image-forming apparatus 1. The unlock command is a command that causes the locking mechanism 52 of the image-forming apparatus 1 to unlock the opening and closing mechanism 51.

In S81, in response to the unlock command from the management server 301 being received, the lock control unit 96 of the image-forming apparatus 1 causes the locking mechanism 52 to unlock the opening and closing mechanism 51. Note that the timing of the unlock may be after the refill pack 200 is connected to the image-forming apparatus 1.

In S82, the unlocked opening and closing mechanism 51 is operated by the user (or is automatically activated), the refill path 50 is opened, and the image-forming apparatus 1 is refilled with the consumable material from the refill pack 200.

In S83, the print control unit 95 detects the remaining amount of toner in the preserving container 48 and reports the remaining amount information, which indicates the remaining amount of toner, to the management server 301. The data management unit 350 of the management server 301 receives the remaining amount information.

In S84, the data management unit 350 updates the status of the image-forming apparatus 1 associated with the apparatus ID based on the remaining amount information. For example, the data management unit 350 specifies the record in the apparatus registration table 330 corresponding to the image-forming apparatus 1 based on the apparatus ID included in the remaining amount information. The data management unit 350 updates the value of “Remaining amount of toner”, which is one piece of status information in the specified record, based on the remaining amount information.

Meanwhile, there are situations where a predetermined unlocked period has passed following the reception of the unlock command or the unlocking of the opening and closing mechanism 51. In this case, the sequence moves to S85. In S85, the lock control unit 96 of the image-forming apparatus 1 may lock the opening and closing mechanism 51 again.

### (Switching Operating Modes)

The present embodiment will described processing for switching the operating mode of the image-forming apparatus according to the contract information (contract type). A first operating mode in the present embodiment is an operating mode in which the opening and closing mechanism is unlocked under the condition that the authentication by the management server 301 is successful. A second operating mode is an operating mode in which the opening and closing mechanism is unlocked when a predetermined operation is performed in the apparatus to be refilled. In other words, the second operating mode is not conditional on the success of the authentication by the management server 301.

A plurality of contract types may be present as contract types. A first contract type is a contract type that requires authentication processing to unlock the opening and closing mechanism. A second contract type is a contract type that does not require authentication processing to unlock the opening and closing mechanism. Note that the second contract type may be applied to non-subscribers. The first contract type is associated with the first operating mode. The second contract type is associated with the second operating mode.

As illustrated in FIG. 40, a relationship between the contract type and the operating mode may be held in an operating mode table 385. The operating mode table 385 may be held as part of the management DB 313. As illustrated in FIG. 40, in the operating mode table 385, Contract information 381 may include identification information indicating the contract type. Operating mode 382 may include identification information of the operating mode. As illustrated in FIG. 40, there may be three or more contract types.

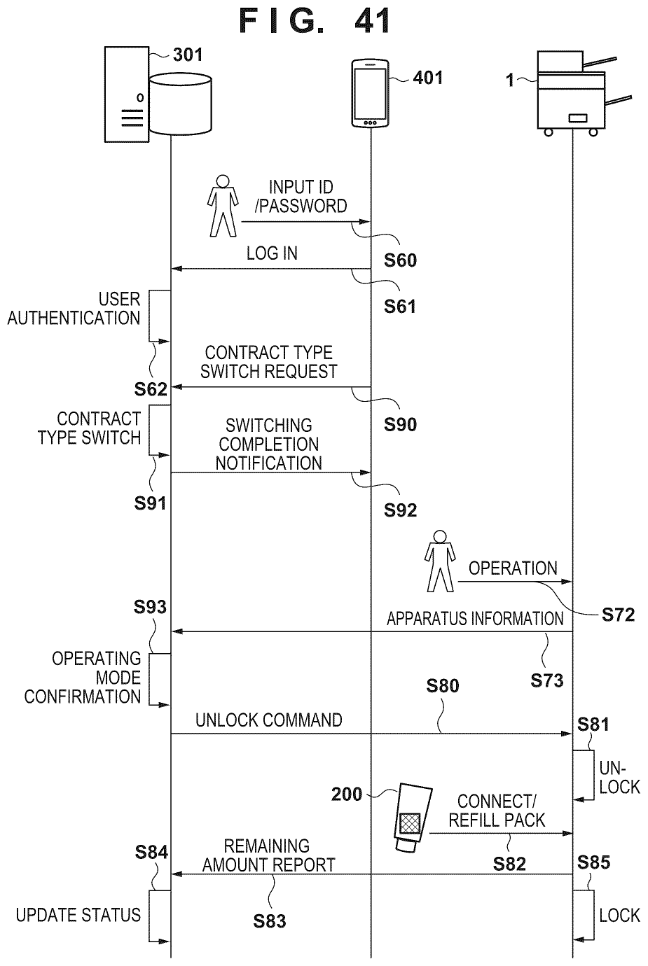

FIG. 41 illustrates processing for switching the operating mode of the opening and closing mechanism 51 (the locking mechanism 52). The sequence illustrated in FIG. 41 mainly involves the image-forming apparatus 1, the management server 301, and the user terminal 401. Here, it is assumed that at the start of the sequence, the contract type of the user's contract is the first contract type, and the operating mode of the opening and closing mechanism 51 (the locking mechanism 52) is set to the first operating mode. S60 to S62 have already been described and will therefore not be described further here.

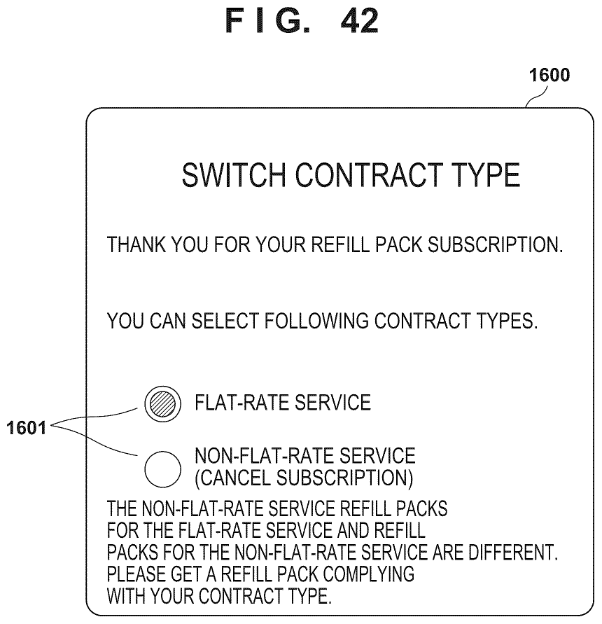

In S90, the user makes an instruction for a contract type switch request from the user terminal to the management server 301. As illustrated in FIG. 42, the application unit 440 of the user terminal 401 may display a contract type selection screen 1600 in the display device 415. The user reads a warning displayed in the selection screen 1600, and operates a software button 1601 in accordance with the warning. In this example, the first contract type (e.g., a flat-rate service) and the second contract type (e.g., a non-flat-rate service) are displayed in a selectable manner. As the warning suggests, the refill pack 200 for the flat-rate service is different from the refill pack 200 for the non-flat-rate service (for non-subscribers), and thus the user must select a contract type corresponding to the refill pack 200 they hold themselves. In this example, the user has obtained a refill pack 200 for a non-flat-rate service (for non-subscribers), but the flat-rate service is selected at that time. The user must therefore switch the contract type from the flat-rate service to the non-flat-rate service, and the operating mode of the opening and closing mechanism 51 (the locking mechanism 52) must be switched from the first operating mode to the second operating mode.

In S91, the data management unit 350 of the management server 301 switches the contract type in accordance with the switch request received from the user terminal 401. The data management unit 350 extracts, from the apparatus registration table 330, a record corresponding to the user ID or the apparatus ID associated with the switch request. The data management unit 350 changes Contract information 336 in the extracted record to the contract type according to the switch request. As illustrated in FIG. 40, the contract type I of Contract information 336 in the record in which “U01” is held as Owner 331 is switched to “non-contract (non-flat-rate service)”.

In S92, the management server 301 sends a switch complete notification to the user terminal 401, indicating that the contract type switch has been completed. S72 and S73 are executed thereafter.

In S93, the management server 301 confirms the operating mode based on the received apparatus ID. As illustrated in FIG. 40, the data management unit 350 obtains Contract information 336 associated with Apparatus ID 332 by referring to the apparatus registration table 330. Furthermore, the data management unit 350 obtains Operating mode 382 associated with Contract information 381 (Contract information 336) by referring to the operating mode table 385. As illustrated in FIG. 40, Contract information 336 associated with “P01,” which is Apparatus ID 332, has switched from the first operating mode to the second operating mode. Accordingly, Operating mode 382 associated with “P01”, which is Apparatus ID 332, is switched to the second operating mode (e.g., M00).

In S80, the management server 301 skips the authentication for the refill pack 200 and sends an unlock command to the image-forming apparatus 1. As a result, the user is permitted to refill the image-forming apparatus 1 with the consumable material from the non-subscriber refill pack 200.

Although the present embodiment describes an example in which the unique code 201 is read or input using the user terminal 401, this is merely one example. As illustrated in FIG. 35, the refill pack 200c includes the holding part 211, the nozzle 212, the pack shutter 214, and a memory tag 230. The memory tag 230 is disposed, for example, at the tip of the nozzle 212. On the other hand, a tag terminal 130 is disposed on a bottom surface of the cylindrical member 112 of the toner receiving unit 110 of the image-forming apparatus 1c. The tag terminal 130 makes electrical contact with an output terminal of the memory tag 230 when the refill pack 200c is connected to the toner receiving unit 110. The image-forming apparatus 1c can read out information stored in the memory tag 230 of the refill pack 200c through the electrical contact between these terminals.

As illustrated in FIG. 36, the image-forming apparatus 1c includes the communication I/F 11, the memory 12, the user I/F 13, the image-forming unit 40, the opening and closing mechanism 51, the locking mechanism 52, the processing circuit 90, and the tag terminal 130. From a functional perspective, the processing circuit 90 can function mainly as the print control unit 95 and a lock control unit 196.

Like the lock control unit 96 of the image-forming apparatus 1 according to the first embodiment, the lock control unit 196 controls the locking and unlocking of the opening and closing mechanism 51 by the locking mechanism 52. Only the differences between the lock control unit 96 and the lock control unit 196 will be described here.

Upon the connection of the refill pack 200c being detected (e.g., using a sensor (not shown)), the lock control unit 196 reads out the code unique to the refill pack 200c from the memory tag 230 of the refill pack 200c through the tag terminal 130. The lock control unit 196 also reads out the apparatus ID that uniquely identifies the image-forming apparatus 1c from the memory 12. The lock control unit 196 then sends an unlock request, including the code unique to the refill pack 200c and the apparatus ID of the image-forming apparatus 1c, to the management server 301 via the communication I/F 11. Prior to the sending of the unlock request or after the sending of the unlock request, the user inputs the user ID and password through the user I/F 13, and logs into the system when the user authentication is successful. The management server 301 executes the pre-refill authentication described above using the user ID of the logged-in user, as well as the code and the apparatus ID received from the image-forming apparatus 1c.

After sending the apparatus ID to the management server 301 for the pre-refill authentication, the lock control unit 196 receives the unlock command, which is a control signal based on the result of the pre-refill authentication, over a predetermined standby period. Then, if the unlock command is received before the standby period ends, the lock control unit 196 causes the locking mechanism 52 to unlock the opening and closing mechanism 51 in accordance with the unlock command. If the standby period ends without the command being received from the management server 301, the lock control unit 196 stops standing by for the command.

In the present embodiment, the unlock processing based on the contract type switch complete notification is triggered by a user operation in S72, but this is merely one example. The unlock may be executed at any time after the switch complete notification is received. In this case, the lock control units 96 and 196 may be configured to receive the switch complete notification from the management server 301 or may be configured to receive the switch complete notification through the user terminal 401.

The configurations of the management server 301, the user terminal 401, and the image-forming apparatuses 1 and 1c according to the present embodiment are merely examples. The above-described functions are not particularly limited to being provided in one of the management server 301, the user terminal 401, or the image-forming apparatus. For example, the function for checking the legitimacy of the code 201 may be provided in the image-forming apparatuses 1 and 1c. Additionally, some or all of the data in the management DB 313 may be stored in the memory 12 of the image-forming apparatus.

According to the seventh embodiment described in this section, the user instructs the management server 301 to switch the contract type. This makes it possible for the management server 301 to switch the operating mode. In other words, the conditions under which the image-forming apparatus 1 unlocks the opening and closing mechanism 51 are changed. In this manner, the operating mode and the unlocking condition are changed in conjunction with the change in the contract type. Accordingly, the refilling of the consumable material from the refill pack 200 can be controlled in accordance with the contract status of the user's contract.

In the above-described case, it is assumed that the refill pack 200 for the flat-rate service is different from the refill pack 200 for the non-flat-rate service (for non-subscribers). This will likely be useful in implementing a business model in which a subscriber to the flat-rate service uses a refill pack 200 for the flat-rate service, and a non-subscriber to the flat-rate service uses a refill pack 200 for a non-flat-rate service (for non-subscribers). A business model may be implemented in which the subscriber to the flat-rate service can use both the refill pack 200 for the flat-rate service and the refill pack 200 for the non-flat-rate service, while the non-subscriber to the flat-rate service only uses the refill pack 200 for the non-flat-rate service. In this case, the refill pack 200 for the non-flat-rate service to be distributed on the general market may also be provided with the same code as that for the refill pack 200 for the flat-rate service. This makes it possible for a subscriber to the flat-rate service to use both a refill pack 200 for the flat-rate service and a refill pack 200 for the non-flat-rate service (for non-subscribers) through the authentication processing.

### Eighth Embodiment

The seventh embodiment described an example in which the management server 301 instructs the image-forming apparatus 1 to switch the operating mode. However, in a network environment where the connection between the image-forming apparatus 1 and the management server 301 is limited by a firewall or the like, the management server 301 may not be able to instruct the image-forming apparatus 1 to switch the operating mode. Accordingly, an eighth embodiment will describe an example in which the user terminal 401 instructs the image-forming apparatus 1 to switch the operating mode. In the eighth embodiment, the descriptions in the seventh embodiment will be used to describe matters that are the same as in the seventh embodiment. The following descriptions will therefore focus on the differences between the eighth embodiment and the seventh embodiment.

### (Example of Configuration of Image-Forming Apparatus)

The configuration of the image-forming apparatus 1 is as described above. However, it is assumed that the memory 12 stores the type of the operating mode.

### (Flow of Processing)

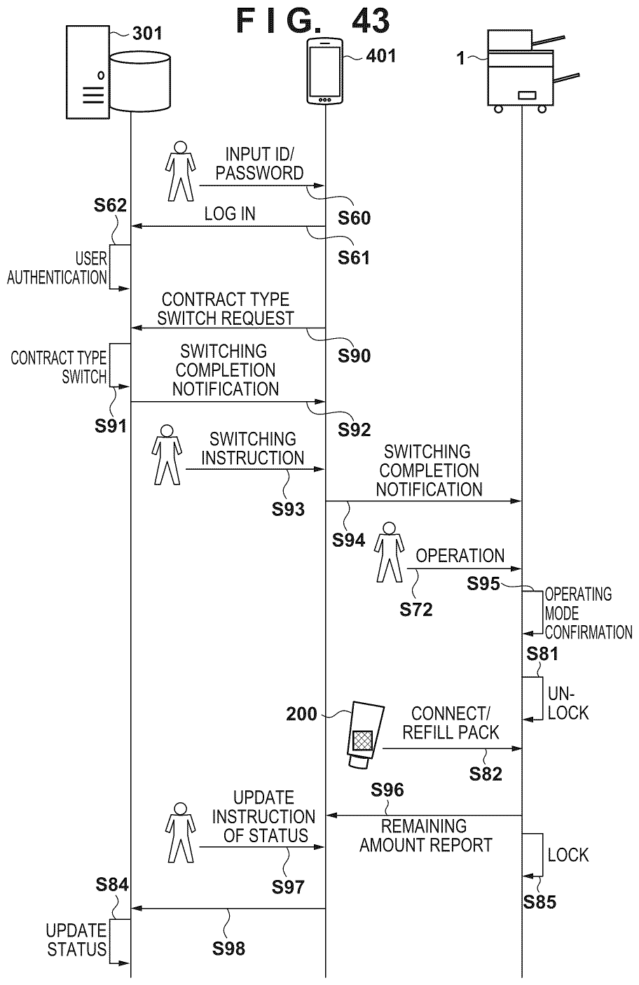

The flow of processing executed in the printing management system 300 according to the present embodiment will be described in this section with reference to FIG. 43.

### (Switching Operating Modes)

A difference between the present embodiment and the seventh embodiment is that the management server 301 cannot directly communicate with the image-forming apparatus 1 due to a firewall or the like. However, the management server 301 and the user terminal 401 can communicate.

FIG. 43 illustrates an operating mode switching sequence. S60 to S92 are executed as described earlier with reference to FIG. 41. Here, the management server 301 send neither the contract type switch complete notification, nor the unlock command in S76, to the image-forming apparatus 1. Accordingly, in S93, the user inputs an operating mode switch instruction for changing the contract type to the user terminal 401. The input screen for the operating mode switch instruction may be displayed in the display device 415 in response to the user terminal 401 receiving the switch complete notification from the management server 301, for example. This enables the user to recognize that the change in the contract type is complete and that it is necessary to switch the operating mode of the image-forming apparatus 1 in response to the change in the contract type.

In S94, the application unit 440 of the user terminal 401 sends a contract type switch complete notification to the image-forming apparatus 1. In response to the switch complete notification being received, the lock control unit 96 of the image-forming apparatus 1 saves the operating mode determined in accordance with the contract type in the memory 12. For example, if the contract type is the first contract type, identification information indicating the first operating mode is stored in the memory 12. If the contract type is the second contract type, identification information indicating the second operating mode is stored in the memory 12. In S72, the user performs a predetermined operation in the image-forming apparatus 1.

In step S95, the image-forming apparatus 1 confirms the operating mode saved in the memory 12 in response to the user operation. It is assumed here that the operating mode saved in the memory 12 is the second operating mode. Accordingly, in S81, the image-forming apparatus 1 unlocks the opening and closing mechanism 51. In S82, a non-subscriber (non-flat-rate service) refill pack 200 is connected to the image-forming apparatus 1, and the consumable material is refilled.

In S96, the image-forming apparatus 1 sends a consumable material remaining amount report to the user terminal 401. The method for generating the remaining amount report is as described with reference to S83.

In S97, the user inputs a status update instruction including the remaining amount of toner to the user terminal 401.

In S98, the application unit 440 of the user terminal 401 sends the status update instruction to the management server 301. The update instruction includes the remaining amount report obtained from the image-forming apparatus 1. In S84, the management server 301 updates Remaining amount of toner 335 in the apparatus registration table 330 in accordance with the update instruction received from the user terminal 401.

In the present embodiment, the contract type switch complete notification is sent from the user terminal 401 to the image-forming apparatus 1, but this is merely one example. For example, the user may understand specific data communicated from the management server 301, and input the data from the user interface of the image-forming apparatus 1. As a result, the image-forming apparatus 1 can recognize that the contract type has been switched, or that the operating mode should be switched.

According to the eighth embodiment, the user terminal 401 can notify the image-forming apparatus 1 of the switch in the contract type even in a network environment where the management server 301 and the image-forming apparatus 1 cannot communicate. This makes it possible for the image-forming apparatus 1 to switch the operating mode in accordance with the contract type. In this manner, the image-forming apparatus 1 may change the unlocking condition for the opening and closing mechanism 51.

### (Flowchart)

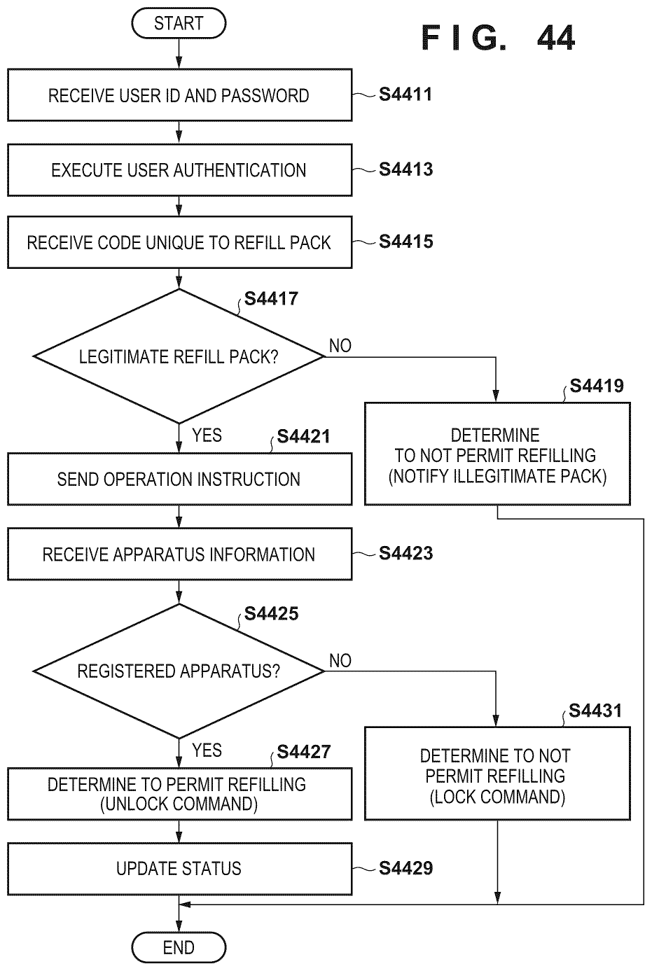

FIG. 44 is a flowchart illustrating an example of the flow of the authentication processing executed by the management server 301. The authentication processing in FIG. 44 corresponds to the processing executed by the authentication unit 370 of the management server 301 in S62 to S84 in FIG. 13. This authentication processing can be realized, for example, by the processing circuit 314 executing a computer program stored in advance in the memory 312 of the management server 301.

In S4411, the authentication unit 370 receives the user ID and password entered in the login screen.

In S4413, the authentication unit 370 executes user authentication based on the received user ID and password. It is assumed here that the user authentication is successful, and thus the flow of processing performed when the user authentication has failed will not be described.

In S4415, the authentication unit 370 receives the code 201 unique to the refill pack 200 obtained in the user environment E1.

In S4417, the authentication unit 370 determines whether the refill pack 200 is a legitimate refill pack 200 based on the received code 201. The legitimacy may be checked based on whether the encrypted code 201 can be decrypted, for example. The sequence moves to step S4421 if the code 201 is a code assigned to a legitimate refill pack 200. On the other hand, if the received code 201 is not a code for a legitimate refill pack 200, the sequence moves to step S4419.

In S4419, the authentication unit 370 determines not to permit the refilling of the consumable material from the refill pack 200. In this case, the authentication unit 370 sends, to the user terminal 401, an authentication result notification indicating that the use of the refill pack 200 is not permitted and the pre-refill authentication has failed. The authentication result notification may notify the user that the refill pack 200 is an illegitimate pack.

In S4421, the authentication unit 370 sends an operation instruction to the user. The user terminal 401 or the image-forming apparatus 1 receives and displays the operation instruction. This enables the user to visually understand what kind of operation should be performed.

In S4423, the authentication unit 370 receives the apparatus information including the apparatus ID from the image-forming apparatus 1 that is the apparatus to be refilled.

In S4425, the authentication unit 370 determines whether the apparatus to be refilled, identified by the received apparatus ID, is already registered as an apparatus of the logged-in user. For example, if an association between the received apparatus ID and the user ID of the logged-in user is registered in the apparatus registration table 330, the apparatus to be refilled is already registered as an apparatus of the logged-in user, and thus the sequence moves to S4427. On the other hand, if an association between the received apparatus ID and the user ID of the logged-in user is not registered in the apparatus registration table 330, the apparatus to be refilled is not registered as an apparatus of the logged-in user, and thus the sequence moves to S4431.

In S4431, the apparatus to be refilled is not registered as an apparatus of the logged-in user, and thus the authentication unit 370 determines not to permit the refilling of the apparatus to be refilled with the consumable material. In this case, the authentication unit 370 sends, to the user terminal 401, an authentication result notification indicating that the pre-refill authentication has failed due to the apparatus not being registered. The authentication unit 370 may also send an explicit lock command to the image-forming apparatus 1 identified by the apparatus ID. As a result, the image-forming apparatus 1 keeps the opening and closing mechanism 51 in the locked state.

In S4427, the authentication unit 370 determines that the apparatus to be refilled is already registered as an apparatus of the logged-in user, and thus determines to permit the refilling of the image-forming apparatus 1, which is the apparatus to be refilled, with the consumable material from the refill pack 200. In this case, the authentication unit 370 sends an unlock command for causing the locking mechanism 52 of the image-forming apparatus 1 to unlock the opening and closing mechanism 51. Furthermore, the authentication unit 370 sends, to the user terminal 401, an authentication result notification indicating the authentication is successful. Note that the authentication unit 370 may permit the refilling of the apparatus to be refilled with the consumable material only if the remaining amount information indicates that the remaining amount of toner in the apparatus to be refilled is less than a predetermined remaining amount threshold. This makes it less likely that the toner will overflow.

Note that if the subscriber is under contract for a flat-rate service, the opening and closing mechanism 51 may be unlocked when two conditions are satisfied, namely (i) the remaining amount of the consumable material is less than a threshold and (ii) the authentication processing is successful. If the subscriber cancels the flat-rate service, the opening and closing mechanism 51 may be automatically unlocked when the condition (i) is satisfied. In this manner, the condition (ii) is unnecessary if the subscriber cancels the flat-rate service.

In S4429, the authentication unit 370 updates the status (Remaining amount of toner 335) associated with the image-forming apparatus 1 based on the remaining amount report received from the image-forming apparatus 1.

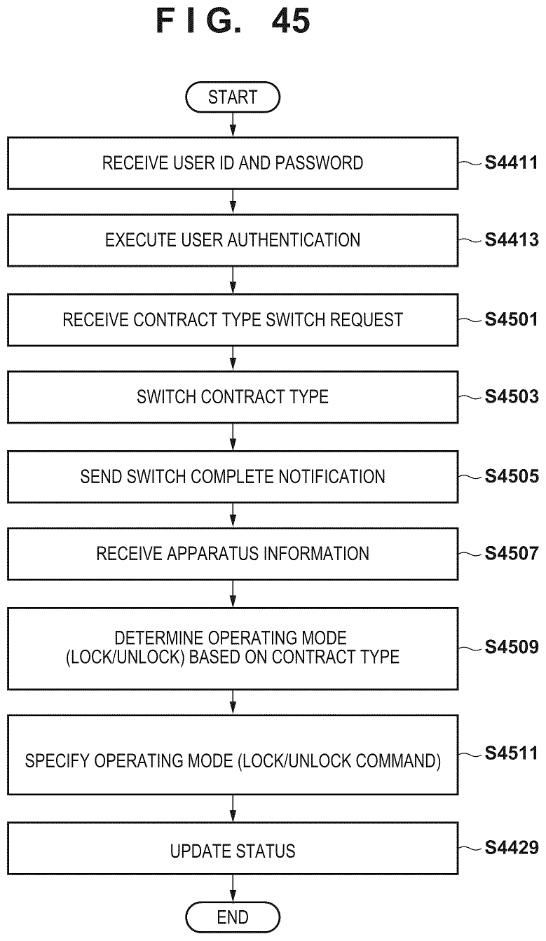

FIG. 45 is a flowchart illustrating an example of the flow of the authentication processing executed by the management server 301. The authentication processing in FIG. 45 corresponds to S62 to S84 in FIGS. 41 and 43. S4411 and S4413 are as described above with reference to FIG. 44.

In S4501, the authentication unit 370 receives the contract type switch request from the user terminal 401. The contract type switch request may be received from the image-forming apparatus 1.

In S4503, the authentication unit 370 switches the contract type (Contract information 336) associated with the logged-in user and apparatus ID in accordance with the switch request. For example, a record associated with the user ID of the logged-in user is specified in the apparatus registration table 330, and Contract information 336 in the record is changed in accordance with the switch request. In S4505, the authentication unit 370 sends a switch complete notification to the user terminal 401. Although S4507 to S4511 are omitted in the case illustrated in FIG. 43, S4507 to S4511 are executed in the case illustrated in FIG. 41.

In S4507, the authentication unit 370 receives the apparatus information from the image-forming apparatus 1. The apparatus ID is included in the apparatus information.

In S4509, the authentication unit 370 determines the operating mode based on the contract type held in Contract information 336 associated with the apparatus ID. For example, if the contract type is the first contract type, the operating mode is determined to be the first operating mode. If the contract type is the second contract type, the operating mode is determined to be the second operating mode.

In S4511, the authentication unit 370 instructs the operating mode for the image-forming apparatus 1. For example, the authentication unit 370 sends a lock command or sends an unlock command in accordance with the operating mode. For example, when a flat-rate service is switched to a non-flat-rate service (e.g., a pay-as-you-go service), an unlock command is sent. This makes it possible to refill from a refill pack 200 for a non-flat-rate service.

<Technical Spirit Derived from Embodiments>

### [Aspect B1]

The camera 413, the input device 414, and the user I/F 13 are an example of an obtaining unit, present in a user environment, that obtains a unique code assigned to a holding device that holds a consumable material consumed to form images. The opening and closing mechanism 51 is an example of an opening and closing mechanism which is capable of opening and closing a refill path of the consumable material from the holding device to the image-forming apparatus, and which is provided in at least one of the holding device or the image-forming apparatus. The management server 301 is an example of a server apparatus, present in a remote environment, that, based on the code of the holding device obtained by the obtaining unit, executes authentication of the holding device. The processing circuit 90 is an example of a control unit, present in the user environment, that, when the authentication of the holding device by the server apparatus succeeds, causes the opening and closing mechanism to open the refill path of the consumable material or enables the refill path to be opened by the opening and closing mechanism. The opening and closing mechanism 51 may have an unlocked state and a locked state. The “unlocked state” is a state in which the refill path of the consumable material is opened by the opening and closing mechanism 51 the refill path is permitted to be opened by the opening and closing mechanism. The “locked state” is a state in which the opening of the consumable material refill path by the opening and closing mechanism is restricted or prohibited. The management server 301 or the processing circuit 90 switches the unlocking condition in accordance with the contract status of the contract of the user of the image-forming apparatus with respect to the service for providing the consumable material. The unlocking condition is a condition for controlling the opening and closing mechanism to change from the locked state to the unlocked state. This makes it possible to control the refilling of a consumable material from a refill pack in accordance with the contract status of a user.

### [Aspect B2]

The management server 301 or the processing circuit 90 may control the opening and closing mechanism to enter the unlocked state in response to the authentication performed by the server apparatus succeeding, if the user has a contract for the service for providing the consumable material. The management server 301 or the processing circuit 90 may control the opening and closing mechanism to enter the unlocked state having skipped or disabled the authentication performed by the server apparatus succeeding, if the user does not have a contract for the service for providing the consumable material. In this manner, authentication performed by the server apparatus is not necessary when the user does not have a contract for the service for providing the consumable material or has canceled the contract. For example, the user can also use a refill pack 200 which is not subject to the service for providing the consumable material, without being required to perform authentication.

### [Aspect B3]

The management server 301 or the processing circuit 90 may control the opening and closing mechanism to enter the unlocked state in response to the authentication performed by the server apparatus succeeding, if a contract type of the user for the service for providing the consumable material is a first type. The management server 301 or the processing circuit 90 may control the opening and closing mechanism to enter the unlocked state regardless of the authentication performed by the server apparatus succeeding, if the contract type of the user for the service for providing the consumable material is a second type. This makes it possible to control the refilling of a consumable material from a refill pack in accordance with the contract type of a user.

### [Aspect B4]

The opening and closing mechanism 51 may have a first operating mode and a second operating mode. The first operating mode may be a mode in which the opening and closing mechanism is caused to open the refill path for the consumable material or the refill path is permitted to be opened by the opening and closing mechanism, when the authentication performed by the server apparatus succeeds. The second operating mode may be a mode in which the opening and closing mechanism is caused to open the refill path for the consumable material or the refill path is permitted to be opened by the opening and closing mechanism, without requiring the authentication by the server apparatus. The management server 301 or the processing circuit 90 may set an operating mode of the image-forming apparatus to the first operating mode if the user has a contract for a service for providing the consumable material. The management server 301 or the processing circuit 90 may set the operating mode of the image-forming apparatus to the second operating mode if the user does not have a contract for a service for providing the consumable material. As a result, the operating mode of the opening and closing mechanism 51 can be switched according to whether or not the user has entered into a contract.

### [Aspect B5]

The management DB 313 is an example of storage for storing a contract status for a user of the image-forming apparatus 1. The management server 301 may set an unlocking condition through the processing circuit 90 based on the contract status stored in the storage.

### [Aspect B6]

The apparatus registration table 330 is an example of first storage for storing a contract status for a user of the image-forming apparatus 1. The operating mode table 385 is an example of second storage for storing an operating mode in association with each of the plurality of contract statuses (e.g., contract types). The management server 301 may obtain, from the second storage, an operating mode corresponding to the contract status stored in the first storage, and apply the operating mode to the opening and closing mechanism 51 through the control unit.

### [Aspects B7 and B8]

The management server 301 may send or input a command for putting the opening and closing mechanism 51 into the unlocked state (e.g., an unlock command) or a notification (e.g., a switch complete notification) to the control unit through a terminal apparatus of the user (e.g., the user terminal 401). In other words, the user terminal 401 may send or input the switch complete notification to the image-forming apparatus 1. Inputting the notification or command to the image-forming apparatus 1 through the user terminal 401 may include the user operating the user I/F 13 of the image-forming apparatus 1 having viewed the notification or command through the user terminal 401. The management server 301 may send, to the terminal apparatus of the user, a notification indicating that a contract type of the user has switched from the first type to the second type (e.g., the switch complete notification). The terminal apparatus inputs, to the control unit, a notification indicating that the contract type of the user has switched from the first type to the second type. The control unit switches the unlocking condition of the opening and closing mechanism based on the notification.

### [Aspect B9]

The image-forming apparatus 1 may store identification information identifying the image-forming apparatus 1 (e.g., an apparatus ID) in advance, and send the identification information to the server apparatus upon detecting a predetermined input signal. As part of the authentication, the management server 301 may determine whether the image-forming apparatus 1 is associated with an account of the user based on the identification information received from the image-forming apparatus 1. In this manner, the authentication required for refilling the consumable material from the refill pack 200 may include apparatus authentication. The authentication required for refilling the consumable material from the refill pack 200 may include at least one of user authentication and authentication of the refill pack 200.

### [Aspects B10 and B11]

The predetermined input signal may be a signal input through the user interface (e.g., the user I/F 13) of the image-forming apparatus 1. The predetermined input signal may be a signal sent to the image-forming apparatus 1 from the terminal apparatus of the user through a communication interface (e.g., the communication I/F 411).

### [Aspect B12]

The management server 301 may update the contract status associated with the user in accordance with a request to switch the contract status, the request being received from the terminal apparatus of the user of the image-forming apparatus 1. Through this, the user can update the contract status at any time. In other words, a more flexible flat-rate service for the consumable material can be provided. In addition, the user can cancel the flat-rate service or switch to a non-flat-rate service with ease.

### [Aspects B13]

A user of the image-forming apparatus may be contracted for a flat-rate service of the consumable material and the holding device may be authenticated as being a holding device for the flat-rate service. In this case, the management server 301 or the processing circuit 90 may control the opening and closing mechanism to enter the unlocked state. On the other hand, the user of the image-forming apparatus may not be contracted for the flat-rate service. In this case, the management server 301 or the processing circuit 90 may control the opening and closing mechanism to enter the unlocked state by skipping or disabling the authentication as to whether the holding device is a holding device for a flat-rate service. This makes it possible to control the refilling of a consumable material from a refill pack in accordance with the contract status of a user.

### [Aspect B14]

The opening and closing mechanism 51 may have a first operating mode and a second operating mode. The first operating mode is a mode in which the opening and closing mechanism is caused to open the refill path for the consumable material or the refill path is permitted to be opened by the opening and closing mechanism, when the authentication performed by the server apparatus succeeds. The second operating mode is a mode in which the opening and closing mechanism is caused to open the refill path for the consumable material or the refill path is permitted to be opened by the opening and closing mechanism, without requiring the authentication by the server apparatus. This makes it possible to switch whether authentication is required to permit the refilling of the consumable material from a refill pack.

### [Aspect B15]

The present embodiment also provides a refilling control method for controlling refilling of an image-forming apparatus with a consumable material from a holding device that holds the consumable material, the consumable material being consumed to form images. The refilling control method includes switching, by a server apparatus provided in a remote environment or a control unit of the image-forming apparatus, an unlocking condition in accordance with a contract status of a user of the image-forming apparatus with respect to a service for providing the consumable material. This makes it possible to control the refilling of a consumable material from a refill pack in accordance with the contract status of a user.

### [Aspect B16]

According to the present embodiment, the image-forming apparatuses 1 and 1c are provided. The preserving container 48 is an example of a preserving container that preserves a consumable material refilled from a holding device that holds the consumable material. The image-forming unit 40 forms an image on recording media by consuming the consumable material preserved in the preserving container. The communication I/F 11 is an example of a communication interface that communicates with a server apparatus present in a remote environment. The processing circuit 90 switches the unlocking condition in accordance with the contract status of the contract of the user of the image-forming apparatus with respect to the service for providing the consumable material. The contract status is managed by the server apparatus. This makes it possible to control the refilling of a consumable material from a refill pack in accordance with the contract status of a user.

### [Aspect B17]

In the present embodiment, the management server 301 that switches the unlocking condition in accordance with the contract status of the contract of the user of the image-forming apparatus with respect to the service for providing the consumable material is provided. This makes it possible to control the refilling of a consumable material from a refill pack in accordance with the contract status of a user.

The present disclosure makes it possible to use a holding device which is different from a holding device supplied under a subscription contract.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus comprising:
a memory; and
at least one processor connected to the memory and configured to:
manage a remaining number of sheets on which image forming is permitted, in an image-forming apparatus that forms images on sheets by using a consumable material;
obtain first determination information for determining whether a holding device holding the consumable material is a first holding device or a second holding device; and
determine, in a case where refilling the image-forming apparatus with the consumable material from the holding device is performed, whether the holding device used for the refilling is the first holding device, based on the first determination information of the holding device, and determine a refill amount of the consumable material with which the image-forming apparatus has been refilled,
wherein in a case where the at least one processor determines that the holding device used for the refilling is the first holding device, the at least one processor does not change the remaining number of sheets, and in a case where the at least one processor determines that the holding device used for the refilling is the second holding device, the at least one processor increases the remaining number of sheets by a number corresponding to the refill amount.

2. The information processing apparatus according to claim 1, wherein:
before first image forming performed by the image-forming apparatus, the at least one processor obtains second determination information for determining a first number of sheets that is a number of sheets on which an image is formed in the first image forming; and
in a case where the first number of sheets is greater than the remaining number of sheets, the at least one processor does not permit the first image forming.

3. The information processing apparatus according to claim 2, wherein in a case where the first number of sheets is less than the remaining number of sheets, the at least one processor notifies the image forming apparatus that the first image forming will be executed.

4. The information processing apparatus according to claim 3, wherein in a case where the image-forming apparatus has been notified that the first image forming will be executed, the at least one processor updates the remaining number of sheets such that the remaining number of sheets is lower by a second number of sheets.

5. The information processing apparatus according to claim 4, wherein the second number of sheets is equal to the first number of sheets, or is equal to a number of sheets, obtained from the image-forming apparatus, on which an image has actually been formed in the first image forming.

6. The information processing apparatus according to claim 1, wherein:
the at least one processor manages a first remaining number of sheets and a second remaining number of sheets as the remaining number of sheets; and
in a case where the at least one processor determines that the holding device used for the refilling is the first holding device, the at least one processor changes neither the first remaining number of sheets nor the second remaining number of sheets, and in a case where the at least one processor determines that the holding device used for the refilling is the second holding device, the at least one processor increases the second remaining number of sheets by a number corresponding to the refill amount but does not change the first remaining number of sheets.

7. The information processing apparatus according to claim 6, wherein:
before first image forming performed by the image-forming apparatus, the at least one processor obtains second determination information for determining a first number of sheets that is a number of sheets on which an image is formed in the first image forming; and
in a case where the first number of sheets is greater than a sum of the first remaining number of sheets and the second remaining number of sheets, the at least one processor does not permit the first image forming.

8. The information processing apparatus according to claim 7, wherein in a case where the first number of sheets is not greater than the sum of the first remaining number of sheets and the second remaining number of sheets, the at least one processor notifies the image forming apparatus that the first image forming will be executed.

9. The information processing apparatus according to claim 8, wherein in a case where the image-forming apparatus has been notified that the first image forming will be executed, the at least one processor determines the second number of sheets, updates the first remaining number of sheets such that the first remaining number of sheets is lower by the second number of sheets but does not update the second remaining number of sheets, if the second number of sheets is not greater than the first remaining number of sheets, and, if the second number of sheets is greater than the first remaining number of sheets, updates the second remaining number of sheets such that the second remaining number of sheets is lower by a number equal to a difference between the second number of sheets and the first remaining number of sheets, and updates the first remaining number of sheets to 0.

10. The information processing apparatus according to claim 9, wherein the second number of sheets is equal to the first number of sheets, or is equal to a number of sheets, obtained from the image-forming apparatus, on which an image has actually been formed in the first image forming.

11. The information processing apparatus according to claim 9, wherein when refilling the image-forming apparatus with the consumable material from the holding device, the at least one processor records whether the holding device used for the refilling is the first holding device, a refill amount of the consumable material with which the image-forming apparatus is refilled, and an identifier of the holding device used for the refilling, in association with each other.

12. The information processing apparatus according to claim 11, wherein:
the first holding device is a holding device supplied in a service to which a user of the image-forming apparatus subscribes;
the at least one processor manages whether the first holding device has been used to refill the image-forming apparatus with the consumable material, for each of identifiers of first holding devices, each being the first holding device, supplied in the service; and
when refilling the image-forming apparatus with the consumable material from the holding device, if the holding device used in the refilling is the second holding device, the at least one processor records the identifier of the first holding device not yet used to refill the image-forming apparatus with the consumable material at that point in time in association with an identifier of a holding device used in the refilling.

13. The information processing apparatus according to claim 11, wherein if, when refilling the image-forming apparatus with the consumable material from the holding device, the holding device used for the refilling is the second holding device, the at least one processor also records a number of sheets corresponding to the refill amount of the consumable material with which the image-forming apparatus is refilled, in association with the identifier of the holding device used for the refilling.

14. The information processing apparatus according to claim 11, wherein when updating the second remaining number of sheets, information indicating a value of a difference between the second number of sheets and the first remaining number of sheets is recorded.

15. The information processing apparatus according to claim 2, wherein the at least one processor receives the second determination information from the image-forming apparatus or a user apparatus having image data used in the first image forming.

16. The information processing apparatus according to claim 2, wherein:
the second determination information is the image data used in the first image forming; and
the at least one processor determines the first number of sheets based on the image data.

17. The information processing apparatus according to claim 16, wherein when notifying the image-forming apparatus that the first image forming will be executed, the at least one processor sends the image data to the image-forming apparatus.

18. The information processing apparatus according to claim 1, wherein the at least one processor determines the refill amount based on a nominal value of an amount of the consumable material held in the holding device used for the refilling.

19. The information processing apparatus according to claim 18, wherein the at least one processor obtains the nominal value from the image-forming apparatus or a user apparatus used by a user of the image-forming apparatus.

20. The information processing apparatus according to claim 18, wherein the at least one processor obtains information specifying the holding device or a type of the holding device from the image-forming apparatus or a user apparatus used by a user of the image-forming apparatus, and determines the nominal value based on the information obtained.

21. The information processing apparatus according to claim 1, wherein:
the at least one processor obtains, from the image-forming apparatus, information indicating a remaining amount of the consumable material held in the image-forming apparatus; and
the at least one processor determines the refill amount based on an amount of change in the remaining amount of the consumable material held in the image-forming apparatus in a case where the image-forming apparatus is refilled with the consumable material from the holding device.

22. The information processing apparatus according to claim 1, wherein the at least one processor obtains the first determination information from the image-forming apparatus or a user apparatus used by a user of the image-forming apparatus.

23. The information processing apparatus according to claim 1, wherein:
the first holding device is a holding device supplied in a service to which a user of the image-forming apparatus subscribes; and
the second holding device is a holding device obtained by the user outside the service.

24. An information processing apparatus comprising:
a memory; and
at least one processor connected to the memory and configured to:
manage a remaining number of sheets on which image forming is permitted, in an image-forming apparatus that forms images on sheets by using a consumable material, and an update timing for updating the remaining number of sheets;
obtain first determination information for determining whether a holding device holding the consumable material is a first holding device or a second holding device; and
determine, when refilling the image-forming apparatus with the consumable material from the holding device, whether the holding device used for the refilling is the first holding device, based on the first determination information of the holding device, and determine a refill amount of the consumable material with which the image-forming apparatus has been refilled,
wherein in a case where the at least one processor determines that the holding device used for the refilling is the second holding device, the at least one processor sets a first condition and does not update the remaining number of sheets until the first condition is satisfied.

25. The information processing apparatus according to claim 24, wherein in a case where a request for the image-forming apparatus to perform first image forming is received between when the first condition is set and when the first condition is satisfied, the at least one processor notifies the image-forming apparatus that the first image forming will be executed.

26. The information processing apparatus according to claim 25, wherein in a case where the request for the first image forming is received before the first condition is set or after the first condition is satisfied, the at least one processor notifies the image-forming apparatus that the first image forming will be executed if a first number of sheets is not greater than the remaining number of sheets, the first number of sheets being a number of sheets on which an image is to be formed in the first image forming.

27. The information processing apparatus according to claim 26, wherein:
in a case where the image-forming apparatus is notified of execution of the first image forming received before the first condition is set or after the first condition is satisfied, the at least one processor updates the remaining number of sheets such that the remaining number of sheets is lower by a second number of sheets; and
the second number of sheets is equal to the first number of sheets, or is equal to a number of sheets, obtained from the image-forming apparatus, on which an image has actually been formed in the first image forming.

28. The information processing apparatus according to claim 24, wherein the at least one processor extends the update timing based on a period from when the first condition is set to when the first condition is satisfied.

29. The information processing apparatus according to claim 24, wherein:
the first condition is a condition satisfied in a case where a predetermined timing is reached; and
the at least one processor sets the predetermined timing based on the refill amount.

30. The information processing apparatus according to claim 24, wherein:
the at least one processor obtains, from the image-forming apparatus, information indicating a remaining amount of the consumable material held in the image-forming apparatus; and
the first condition is a condition satisfied in a case where a remaining amount of the consumable material held in the image-forming apparatus becomes a remaining amount of the consumable material that has been held in the image-forming apparatus before the refilling from the second holding device.

31. A non-transitory computer readable storage medium storing a computer program, when executed by at least one processor in an apparatus including the at least one processor, causing the apparatus to:
manage a remaining number of sheets on which image forming is permitted, in an image-forming apparatus that forms images on sheets by using a consumable material;
obtain first determination information for determining whether a holding device holding the consumable material is a first holding device or a second holding device; and
determine, in a case where refilling the image-forming apparatus with the consumable material from the holding device is performed, whether the holding device used for the refilling is the first holding device, based on the first determination information of the holding device, and determine a refill amount of the consumable material with which the image-forming apparatus has been refilled,
wherein in a case where the at least one processor determines that the holding device used for the refilling is the first holding device, the at least one processor does not change the remaining number of sheets, and in a case where the at least one processor determines that the holding device used for the refilling is the second holding device, the at least one processor increases the remaining number of sheets by a number corresponding to the refill amount.

32. A printing management system comprising:
an obtaining processor, present in a user environment, configured to obtain a unique code assigned to a holding device that holds a consumable material consumed to form images;
an opening and closing mechanism which is capable of opening and closing a refill path of the consumable material from the holding device to the image-forming apparatus, and which is provided in at least one of the holding device and the image-forming apparatus;
a server apparatus, present in a remote environment, that, based on the code of the holding device obtained by the obtaining processor, executes authentication of the holding device; and
a control unit, present in the user environment, that, in a case where the authentication of the holding device by the server apparatus succeeds, causes the opening and closing mechanism to open the refill path of the consumable material or enables the refill path to be opened by the opening and closing mechanism,
wherein in a case where the server apparatus determines that the holding device is in an unused state and that another holding device delivered to a user of the image-forming apparatus before the holding device is also in an unused state, the authentication of the holding device fails, and
in response to the authentication of the holding device by the server apparatus failing, the control unit does not cause the opening and closing mechanism to open the refill path of the consumable material or does not permit the refill path to be opened by the opening and closing mechanism.

33. The printing management system according to claim 32, wherein:
the server apparatus receives account information of the user; and
the authentication performed by the server apparatus includes:
determining whether the code of the holding device is associated with the account information;
determining whether a status of the holding device associated with the code indicates the unused state; and
determining whether the other holding device associated with the account information indicates the unused state.

34. The printing management system according to claim 33, further comprising:
a database that manages the account information of each of users, the codes of holding devices delivered to each of the users, and statuses of the holding devices in association with each other,
wherein the server apparatus executes the authentication of the holding device by referring to the database.

35. The printing management system according to claim 34, wherein:
the server apparatus receives the account information of the user; and
the authentication performed by the server apparatus includes determining that the authentication of the holding device has failed in a case where at least two codes of a holding device in an unused state are associated with the account information of the user in the database.

36. The printing management system according to claim 34, wherein:
the server apparatus receives the account information of the user; and
the authentication performed by the server apparatus includes counting a total number of a plurality of holding devices in an unused state that are associated with the account information of the user in the database, and determining that the authentication of the holding device has succeeded in a case where the total number is less than a threshold.

37. The printing management system according to claim 34, wherein:
the server apparatus receives the account information of the user; and
the authentication performed by the server apparatus includes specifying the other holding device, among holding devices identified by the codes associated with the account information of the user in the database, based on unused periods of the holding devices.

38. The printing management system according to claim 37, wherein:
in the database, a registration period, which is a period in which the code of each holding device delivered to the user is registered in the database, is registered in association with the code of the holding device; and
the server apparatus obtains the registration period of the other holding device from the database and determines if the unused period of the other holding device, obtained from the registration period, is at least a predetermined period, and if the unused period of the other holding device is at least the predetermined period, the authentication of the holding device fails.

39. The printing management system according to claim 38, wherein in a case where an event that triggers delivery of the holding device to the user occurs, the server apparatus registers the account information of the user and the registration period of the holding device in the database.

40. The printing management system according to claim 32, further comprising:
an output unit configured to notify the user of an authentication result of the authentication.

41. The printing management system according to claim 40, wherein the output unit is included in the image-forming apparatus, the image-forming apparatus receives the authentication result from the server apparatus, and the output unit notifies the user of the authentication result through a user interface of the image-forming apparatus.

42. The printing management system according to claim 41, wherein the output unit is included in a user terminal used by the user, the user terminal receives the authentication result from the server apparatus, and the output unit notifies the user of the authentication result through a user interface of the user terminal.

43. The printing management system according to claim 40, wherein even if, after the user has been notified that the other holding device in an unused state is present in addition to the holding device, the user still wishes to use the holding device, the control unit causes the opening and closing mechanism to open the refill path for the consumable material or enables the refill path to be opened by the opening and closing mechanism.

44. The printing management system according to claim 43, wherein the output unit is further configured to output a message inquiring with the user as to whether the user wishes to use the holding device.

45. The printing management system according to claim 43, wherein an indication that the user wishes to use the holding device is input through a user interface of the image-forming apparatus.

46. The printing management system according to claim 43, wherein an indication that the user wishes to use the holding device is input through a user terminal used by the user.

47. A printing control method for controlling refilling of an image-forming apparatus with a consumable material from a holding device that holds the consumable material, the consumable material being consumed to form images,
wherein an opening and closing mechanism which is capable of opening and closing a refill path of the consumable material from the holding device to the image-forming apparatus is provided in at least one of the holding device and the image-forming apparatus, and
the image-forming apparatus is present in a user environment,
the printing control method comprising:
obtaining, by an obtaining processor present in the user environment, a unique code assigned to the holding device;
sending the code of the holding device obtained by the obtaining processor from the obtaining processor to a server apparatus present in a remote environment;
receiving the code and executing authentication of the holding device based on the code received, in the server apparatus; and
causing, by a control unit present in the user environment, the opening and closing mechanism to open the refill path of the consumable material or enabling the refill path to be opened by the opening and closing mechanism, in response to the authentication of the holding device by the server apparatus succeeding,
wherein in a case where the holding device is in an unused state and another holding device delivered to a user of the image-forming apparatus before the holding device is also in an unused state, the authentication of the holding device fails, and
in response to the authentication of the holding device by the server apparatus failing, the control unit does not cause the opening and closing mechanism to open the refill path of the consumable material or does not permit the refill path to be opened by the opening and closing mechanism.

48. An image-forming apparatus installed in a user environment, the image-forming apparatus comprising:
a preserving container that preserves a consumable material refilled from a holding device that holds the consumable material;
an image-forming unit that forms an image on recording media by consuming the consumable material preserved in the preserving container;
a control unit that controls an opening and closing mechanism capable of opening and closing a refill path of the consumable material from the holding device to the preserving container; and
a communication interface that communicates with a server apparatus present in a remote environment,
wherein the control unit:
obtains a code unique to the holding device, and sends the code obtained to the server apparatus through the communication interface;
does not cause the opening and closing mechanism to open the refill path or does not permit the refill path to be opened by the opening and closing mechanism, in a case where authentication of the holding device by the server apparatus fails due to the holding device identified by the code being in an unused state and another holding device delivered to a user of the image-forming apparatus before the holding device also being in an unused state; and
causes the opening and closing mechanism to open the refill path or permits the refill path to be opened by the opening and closing mechanism, in a case where the authentication of the holding device succeeds due to the holding device being in an unused state and the other holding device not being in an unused state.

49. A server apparatus for managing refilling of an image-forming apparatus with a consumable material from a holding device that holds the consumable material, the consumable material being consumed to form images,
wherein at least one of the holding device and the image-forming apparatus includes an opening and closing mechanism which is capable of opening and closing a refill path of the consumable material,
the image-forming apparatus is present in a user environment, and the server apparatus is present in a remote environment,
the server apparatus comprises a communication interface and processing circuitry, and
the processing circuitry:
receives a unique code assigned to the holding device through the communication interface, from an apparatus present in the user environment;
executes authentication for the holding device based on the code received;
does not cause the opening and closing mechanism to open the refill path or does not permit the refill path to be opened by the opening and closing mechanism, in a case where authentication of the holding device fails due to the holding device identified by the code being in an unused state and an other holding device delivered to a user of the image-forming apparatus before the holding device also being in an unused state; and
causes the opening and closing mechanism to open the refill path or permits the refill path to be opened by the opening and closing mechanism, in a case where the authentication of the holding device succeeds due to the holding device being in an unused state and the other holding device not being in an unused state.

50. A refilling management system comprising:
an obtaining processor, present in a user environment, that obtains a code unique to a holding device that holds a consumable material consumed to form images;
an opening and closing mechanism which is capable of opening and closing a refill path of the consumable material from the holding device to the image-forming apparatus, and which is provided in at least one of the holding device and the image-forming apparatus;
a server apparatus, present in a remote environment, that, based on the code obtained by the obtaining processor, executes authentication for the holding device; and
a control unit, present in the user environment, that causes the opening and closing mechanism to open a refill path for the consumable material or permits the refill path to be opened by the opening and closing mechanism,
wherein the opening and closing mechanism has an unlocked state in which the refill path for the consumable material is open or the refill path is permitted to be opened, and a locked state in which the refill path for the consumable material is restricted from being opened, and
the server apparatus or the control unit switches an unlocking condition for controlling the opening and closing mechanism to switch from the locked state to the unlocked state in accordance with a contract status of a user of the image-forming apparatus with respect to a service for providing the consumable material.

51. The refilling management system according to claim 50, wherein the server apparatus or the control unit is further configured to:
control the opening and closing mechanism to enter the unlocked state in response to the authentication performed by the server apparatus succeeding, if the user has a contract for the service for providing the consumable material; and
control the opening and closing mechanism to enter the unlocked state having skipped or disabled the authentication performed by the server apparatus succeeding, if the user does not have a contract for the service for providing the consumable material.

52. The refilling management system according to claim 50, wherein the server apparatus or the control unit is further configured to:
control the opening and closing mechanism to enter the unlocked state in response to the authentication performed by the server apparatus succeeding, if a contract type of the user for the service for providing the consumable material is a first type; and
control the opening and closing mechanism to enter the unlocked state regardless of the authentication performed by the server apparatus succeeding, if the contract type of the user for the service for providing the consumable material is a second type.

53. The refilling management system according to claim 50, wherein:
the opening and closing mechanism has a first operating mode and a second operating mode;
the first operating mode is a mode in which the opening and closing mechanism is caused to open the refill path for the consumable material or the refill path is permitted to be opened by the opening and closing mechanism, in a case where the authentication performed by the server apparatus succeeds;
the second operating mode is a mode in which the opening and closing mechanism is caused to open the refill path for the consumable material or the refill path is permitted to be opened by the opening and closing mechanism, without requiring the authentication by the server apparatus; and
the server apparatus or the control unit is further configured to:
set an operating mode of the image-forming apparatus to the first operating mode if the user has a contract for a service for providing the consumable material; and
set the operating mode of the image-forming apparatus to the second operating mode if the user does not have a contract for a service for providing the consumable material.

54. The refilling management system according claim 50, wherein:
the server apparatus includes storage for storing the contract status for the user of the image-forming apparatus; and
the server apparatus sets the unlocking condition through the control unit based on the contract status stored in the storage.

55. The refilling management system according to claim 53, wherein the server apparatus includes:
a first storage for storing the contract status for the user of the image-forming apparatus; and
a second storage for storing an operating mode in association with each of a plurality of contract statuses,
wherein the server apparatus obtains, from the second storage, an operating mode corresponding to the contract status stored in the first storage, and applies the operating mode to the opening and closing mechanism through the control unit.

56. The refilling management system according to claim 50, wherein the server apparatus sends or inputs a command or a notification for putting the opening and closing mechanism into the unlocked state to the control unit through a terminal apparatus of the user.

57. The refilling management system according to claim 52, wherein:
the server apparatus sends, to a terminal apparatus of the user, a notification indicating that a contract type of the user has switched from the first type to the second type;
the terminal apparatus inputs, to the control unit, a notification indicating that the contract type of the user has switched from the first type to the second type; and
the control unit switches the unlocking condition of the opening and closing mechanism based on the notification.

58. The refilling management system according to claim 50, wherein:
the image-forming apparatus stores identification information identifying the image-forming apparatus in advance, and sends the identification information to the server apparatus upon detecting a predetermined input signal; and
as part of the authentication, the server apparatus determines whether the image-forming apparatus is associated with an account of the user based on the identification information received from the image-forming apparatus.

59. The refilling management system according to claim 58, wherein the predetermined input signal is a signal input through a user interface of the image-forming apparatus.

60. The refilling management system according to claim 58, wherein the predetermined input signal is a signal sent to the image-forming apparatus from a terminal apparatus of the user through a communication interface.

61. The refilling management system according to claim 50, wherein:
the server apparatus updates the contract status associated with the user in accordance with a request to switch the contract status, the request being received from a terminal apparatus of the user of the image-forming apparatus.

62. A refilling management system comprising:
an obtaining processor, present in a user environment, that obtains a code unique to a holding device that holds a consumable material consumed to form images;
an opening and closing mechanism which is capable of opening and closing a refill path of the consumable material from the holding device to the image-forming apparatus, and which is provided in at least one of the holding device and the image-forming apparatus;
a server apparatus, present in a remote environment, that, based on the code obtained by the obtaining processor, executes authentication for the holding device; and
a control unit, present in the user environment, that causes the opening and closing mechanism to open a refill path for the consumable material or permits the refill path to be opened by the opening and closing mechanism,
wherein the opening and closing mechanism has an unlocked state in which the refill path for the consumable material is open or the refill path is permitted to be opened, and a locked state in which the refill path for the consumable material is restricted from being opened, and
the server apparatus or the control unit:
controls the opening and closing mechanism to enter the unlocked state in a case where a user of the image-forming apparatus is contracted for a flat-rate service of the consumable material and the holding device is authenticated as being a holding device for the flat-rate service; and
controls the opening and closing mechanism to enter the unlocked state having skipped or disabled authentication as to whether the holding device is a holding device for the flat-rate service, if the user of the image-forming apparatus is not contracted for the flat-rate service.

63. A refilling management system comprising:
an obtaining processor, present in a user environment, that obtains a code unique to a holding device that holds a consumable material consumed to form images;
an opening and closing mechanism which is capable of opening and closing a refill path of the consumable material from the holding device to an image-forming apparatus, and which is provided in at least one of the holding device and the image-forming apparatus;
a server apparatus, present in a remote environment, that, based on the code obtained by the obtaining processor, executes authentication for the holding device; and
a control unit, present in the user environment, that causes the opening and closing mechanism to open a refill path for the consumable material or permits the refill path to be opened by the opening and closing mechanism,
wherein the opening and closing mechanism has a first operating mode and a second operating mode;
the first operating mode is a mode in which the opening and closing mechanism is caused to open the refill path for the consumable material or the refill path is permitted to be opened by the opening and closing mechanism, in a case where the authentication performed by the server apparatus succeeds; and
the second operating mode is a mode in which the opening and closing mechanism is caused to open the refill path for the consumable material or the refill path is permitted to be opened by the opening and closing mechanism, without requiring the authentication by the server apparatus.

64. A refilling control method for controlling refilling of an image-forming apparatus with a consumable material from a holding device that holds the consumable material, the consumable material being consumed to form images,
wherein an opening and closing mechanism which is capable of opening and closing a refill path of the consumable material from the holding device to the image-forming apparatus is provided in at least one of the holding device and the image-forming apparatus, and
the image-forming apparatus is present in a user environment,
the opening and closing mechanism has an unlocked state in which the refill path for the consumable material is open or the refill path is permitted to be opened, and a locked state in which the refill path for the consumable material is restricted from being opened, and
the refilling control method comprising:
switching, by a server apparatus provided in a remote environment or a control unit of the image-forming apparatus, an unlocking condition for controlling the opening and closing mechanism to enter the unlocked state in accordance with a contract status of a user of the image-forming apparatus with respect to a service for providing the consumable material.

65. An image-forming apparatus installed in a user environment, the image-forming apparatus comprising:
a preserving container that preserves a consumable material refilled from a holding device that holds the consumable material;
an image-forming unit that forms an image on recording media by consuming the consumable material preserved in the preserving container;
a control unit that controls an opening and closing mechanism capable of opening and closing a refill path of the consumable material from the holding device to the preserving container; and
a communication interface that communicates with a server apparatus present in a remote environment,
wherein the opening and closing mechanism has an unlocked state in which the refill path for the consumable material is open or the refill path is permitted to be opened, and a locked state in which the refill path for the consumable material is restricted from being opened, and
the control unit switches an unlocking condition for controlling the opening and closing mechanism to enter the unlocked state in accordance with a contract status of a user of the image-forming apparatus with respect to a service for providing the consumable material managed in the server apparatus.

66. A server apparatus for managing refilling of an image-forming apparatus with a consumable material from a holding device that holds the consumable material, the consumable material being consumed to form images,
wherein at least one of the holding device and the image-forming apparatus includes an opening and closing mechanism which is capable of opening and closing a refill path of the consumable material,
the image-forming apparatus is present in a user environment, and the server apparatus is present in a remote environment,
the server apparatus comprises a communication interface and processing circuitry,
the opening and closing mechanism has an unlocked state in which the refill path for the consumable material is open or the refill path is permitted to be opened, and a locked state in which the refill path for the consumable material is restricted from being opened, and
the processing circuitry switches an unlocking condition for controlling the opening and closing mechanism to enter the unlocked state in accordance with a contract status of a user of the image-forming apparatus with respect to a service for providing the consumable material.
